(19) United States
(12) Patent Application Publication
(10) Pub. No.: US 2025/0097349 A1
(43) Pub. Date: Mar. 20, 2025

(54) Simultaneous Voice and Data Content Driven Commercial Data Platform

(71) Applicants: Trysit Nitidharmatut, Bangkok (TH); Timothy Maslyn, Cupertino, CA (US); Vira Intanate, Samutprakam (TH)

(72) Inventors: Trysit Nitidharmatut, Bangkok (TH); Timothy Maslyn, Cupertino, CA (US); Vira Intanate, Samutprakarn (TH)

(21) Appl. No.: 18/964,030

(22) Filed: Nov. 29, 2024

Related U.S. Application Data
(63) Continuation-in-part of application No. 17/891,101, filed on Aug. 18, 2022, now Pat. No. 12,200,166.
Application No. 17/891,101 is a continuation-in-part of application No. 17/340,600, filed on Jun. 7, 2021, now Pat. No. 11,553,082.
Application No. 17/340,600 is a continuation of application No. 15/931,447, filed on May 13, 2020, now Pat. No. 11,032,423.
Application No. 15/931,447 is a continuation-in-part of application No. 16/730,882, filed on Dec. 30, 2019, now Pat. No. 10,904,382.
Application No. 16/730,882 is a continuation-in-part of application No. 16/176,113, filed on Oct. 31, 2018, now Pat. No. 10,764,428.
(60) Provisional application No. 62/611,690, filed on Dec. 29, 2017.

(51) Int. Cl. H04M 3/51; G06F 16/23; G06N 5/04; G06N 20/00; G06Q 30/0241; G06Q 30/0251; G06Q 30/0282; G06Q 30/0601; G06Q 50/00; H04M 3/42

(52) U.S. Cl. CPC H04M 3/5191; G06F 16/2379; G06N 5/04; G06N 20/00; G06Q 30/0267; G06Q 30/0269; G06Q 30/0277; G06Q 30/0282; G06Q 30/0631; G06Q 50/01; H04M 3/42102; H04M 3/5158; H04M 2203/558

(57) ABSTRACT

System and methods for simultaneous voice and data content driven commercial data platform are disclosed herein. One disclosed system comprises a plurality of peer nodes, a first interaction manager stored on the dialer device and programmed to transmit interaction data to a database during a call with a receiver device, and a second interaction manager stored on the receiver device and programmed to distribute interaction data to the database during the call. The plurality of peer nodes is programmed to obtain receiver content data from the database using the receiver identifier, distribute the receiver content data to the dialer device, obtain dialer content data from the database, distribute the dialer content data to the receiver device, and interaction data in the database. In specific embodiments, the receiver device is programmed to access data from an external platform. In specific embodiments, the system uses a chatbot with artificial intelligence.

### CROSS REFERENCE TO RELATED APPLICATIONS

This application is a continuation-in-part of U.S. patent application Ser. No. 17/891,101, filed on Aug. 18, 2022, which is a continuation-in-part of U.S. patent application Ser. No. 17/340,600, filed on Jun. 7, 2021, which is a continuation-in-part of U.S. patent application Ser. No. 15/931,447, filed on May 13, 2020, which is a continuation-in-part of U.S. patent application Ser. No. 16/730,882, filed on Dec. 30, 2019, which is a continuation-in-part of U.S. patent application Ser. No. 16/176,113, filed Oct. 31, 2018, which claims priority to U.S. Provisional Application No. 62/611,690, filed Dec. 29, 2017, all of which are incorporated by reference herein in their entirety for all purposes.

### BACKGROUND

Every year of the information age bears witness to the continued development of more ways to allow people to communicate and disseminate information. However, person-to-person voice communication over a telephone remains one of the most effective and preferred ways for people to communicate. Even when people use the Internet to search, they often follow up their search with a phone call. Indeed, market analysts have found that 48% of local mobile web searches end with a telephone call. Furthermore, inbound telephone calls are rated as the highest quality form of sales leads because people will only tend to call a business when they are almost ready to make a purchase for goods or service. Telephone calls therefore represent a high value potential sales channel for businesses and a high value information channel for individuals.

Despite the high value of the information generated by voice interactions for both customers and businesses, the useful data associated with a voice interaction is generally lost once a call is concluded. This is particularly true for individuals and small businesses who can't afford enterprise-grade call management systems. Furthermore, for all their benefits, voice interactions can fall short in certain tasks where visible communication, augmented by simultaneously sharing data content, could be more efficient such as displaying a person's name, a restaurant order, an image of a product offering, or a credit card number to someone who is using the information to complete a transaction.

### SUMMARY

This disclosure relates to a commercial, social, and professional data platform. The platform is based around voice communication but augments this voice communication with both the delivery and retention of valuable data regarding that voice communication. Methods and systems are disclosed that enable multiple parties to conduct real time commerce, personal or social interactions, and professional or work collaborations, in a content rich and voice enabled network environment using devices that obtain content/data from, and actively write content/data to, proprietary and public web-based and cloud-based computing environments. The methods and systems disclosed herein can have wide-ranging applications involving any voice communication between a user of the platform, such as the user of a dialer device, and someone, a bot, a server or a terminal, who/which may or may not be with a user of the platform. During the voice communication, the methods and systems disclosed herein can harvest data, at least from the dialer device, from the ongoing voice communication and augment the data stored in a database of the platform and serve up information to at least the dialer device from previously stored data in the database. For example, in one embodiment of the invention, a user of the platform could be on a traditional voice call with someone, and the voice call entails a commercial transaction (such as ordering a pizza). In another embodiment of the invention, the dialer device can include voice-controlled household assistant functionality and can be on a voice communication with a third-party chatbot server, and the voice communication entails commercial or social interactions. In yet another embodiment of the invention, a user of the platform can be on a voice communication with a group of individuals through a voice-assisted persistent chat room, and the voice communication entails work collaborations. The devices can be mobile phones with the capability to display content to their users. The same content/data is employed to enhance and personalize active and future interactions using the platform, thus providing an ecosystem for building strong, lasting, and mutually beneficial person-to-business, business-to-business, and person-to-person relationships that further encourage and promote ongoing commerce and interactions between these parties.

Currently, when a prospective customer (dialer) dials a business (receiver) the customer will normally see only the phone number of the dialed business displayed during the entire voice call. Likewise, the business would see the phone number of the incoming caller on their device. Neither the customer nor the business currently has the opportunity during the voice call to simultaneously send data content to each other that can enrich the call experience by visually displaying information about each other, current customer needs and/or business offerings, or any information about past interactions the customer and the business may have had with each other. Methods and systems are disclosed that would provide the ability of a dialer and receiver, during the voice call itself, to share and interact with valuable data content on their respective devices that would enrich the calling experience for both parties and facilitate any potential transaction. This would include, for example, being able to share data content in real-time, view past interaction data, and store ongoing interactions during the call to further enhance current and future interactions between the parties. These approaches would thus bridge the gap between the current voice call, that is almost entirely void of data content related to the purpose of the call, and the modern Internet age where data content is displayed that visually enriches our experiences. Also, by storing the interactions and data content exchanged during a call, this invention provides a “memory” to both the caller and the receiver of the relationship between the parties, and would be the next best thing to having a person-to-person interaction.

This disclosure includes a system that enables a commercial, social, or professional data platform. The system includes a dialer device, a receiver device, a dialer that is programmed to initiate a call between the dialer device and the receiver device using a receiver phone number, a server, and a database. The system also includes a first interaction manager stored on the dialer device and programmed to transmit a first set of interaction data to the database during the call. The system also includes a second interaction manager stored on the receiver device and programmed to transmit a second set of interaction data to the database during the call. The server is programmed to obtain receiver content data from the database using the receiver phone number and/or other unique identifier, transmit the receiver content data to the dialer device, obtain dialer content data from the database using the dialer phone number and/or other unique identifier, transmit the dialer content data to the receiver device, and store data from both the first set of interaction data and the second set of interaction data in the database in association with both the receiver phone number and/or other unique identifier and the dialer phone number and/or other unique identifier. The server is programmed to transmit the receiver content data and the dialer content data before the call, during the call, and/or after the call. In specific embodiments of the invention, the server is programmed to transmit the receiver content data and the dialer content data using voice communication as well as visual display of the content data. As used herein and in the appended claims the term “identifier” includes both a phone number or other unique identifier such as a static IP address, Media Access Control (MAC) address, International Mobile Equipment Identifier (IMEI), VoIP address (e.g., 5555@voip.domain.com), URL address, etc.

The simultaneous voice and data content driven commercial data platforms disclosed herein effectively enable a relationship manager for consumers using the simultaneous voice and data content driven commercial data platforms, thereby putting them on the same footing as large enterprises with complex relationship management software and data mining. However, using the simultaneous voice and data content driven commercial data platforms disclosed herein the consumers are able to manage their relationships with various vendors and keep track of their overall commercial endeavors on a massive scale with almost no effort required on their part besides the use of an effective communication channel with those vendors. Indeed, the simultaneous voice and data content driven commercial data platforms disclosed herein enable additional features above and beyond those offered by enterprise-grade customer relationship managers and should instead be referred to as commercial relationship managers owing to the fact that they allow for management of commercial data on both the consumer and the vendor side of a relationship. As such, the term CRM is used herein to refer to the ability of a platform to manage commercial relationships generally, and not just consumer relationships.

As mentioned previously, the simultaneous voice and data content driven commercial data platforms disclosed herein allow for the usage of CRMs on both the consumer and the vendor side of a relationship, and they do so by facilitating an effective communication channel between the consumer and the vendor. Rather than simply providing a flat, blank, call screen, some of the approaches disclosed herein add a visual layer of communication to a standard voice communication. In the approaches disclosed herein in which the consumer and/or vendor are communicating using smartphones with display screens, the commercial data platform allows for the display of information on the screen of the device during the call. The screen can be used to display information about the vendor's establishment and offerings generally, the specific good or service that is the object of the current call, the past relationships of the consumer and vendor, and any other information that can facilitate an effective interaction between the consumer and vendor for purposes of building trust and improving their business relationship.

Numerous specific examples of the above-mentioned features are provided in the detailed description below. However, to illustrate the two-fold benefit of the disclosed simultaneous voice and data content driven commercial data platforms consider the situation in which a consumer's options for a pizza order are displayed on the screen of a phone during a voice call. The display of the options enhances the consumer's selection process because the images of the pizza can be curated by the vendor to make them look appealing and to provide information that spoken words alone cannot. The inclusion of a visible channel of communication also prevents miscommunications regarding the content of the order because the order can be displayed visibly to the consumer and vendor at the same time. Numerous other benefits from a communication perspective are provided in terms of the presentation of information using the visible channel provided by the platform. In addition, the fact that this information was provided to the user via the simultaneous voice and data content driven commercial data platform allows the information to be stored for later use. The next time the consumer calls that vendor, their prior order will be available for presentation on the display for reordering in an ultra-convenient fashion. Any incentives or coupons earned based on continued patronage can also be tracked using the data. Furthermore, the history of interactions can be used by the vendor to provide the level of attention and valued respect that a repeat customer is due, or to suggest additional offerings that may be appealing to a given consumer. Therefore, just by allowing the consumer and vendor to use the platform to share images of a pizza, and the receipt of an order for that pizza, a large number of opportunities arise for enriching the commercial relationship of the consumer and vendor.

The benefits of the CRMs described above are not restricted to large enterprises. Using the simultaneous voice and data content driven commercial data platform disclosed herein, small business and individuals are able to obtain the same access to valuable commercial interaction data for commerce enrichment. The devices used by users of the platform can include basic personal computers with built-in phone dialers, smartphones, smart devices such as voice controlled household assistants with or without integrated screens, wearables with dialer connectivity, and any other device that can be used to both make a phone or voice call through VoIP messaging applications or otherwise, and present interaction data to a user. Indeed, in certain approaches, only one of the users needs access to the interaction data, and the other user can be connected only indirectly to the platform through the other user. In these examples, one user could be utilizing a basic telephone and interaction data could be sent from the other user's device to the platform. For example, one user could be operating a smartphone and inputting data to the platform using an application on their device while speaking to a user operating a basic telephone. Furthermore, although the system benefits from situations in which both users have devices that can provide voice and data to the platform, the system does not require both users to have access to the same type of devices.

The data mined, and further processed with artificial intelligence (AI) and machine learning, from usage of the simultaneous voice and data content driven commercial data platform can also be used by a large number of vendors to facilitate an entire business network and ecosystem based around the platform. For example, vendors offering complementary services can offer incentives and promotions to a user based on knowledge regarding that customer's consumption of complementary goods and services. The vendors could team up to share the cost of these incentives in exchange for an increase in customer consumption across all categories. The data could also be used to facilitate a liquid platform-centric currency offered to consumers using the commercial data platform either by the platform administrator or by vendors using the platform. The platform could track usage of the currency as it was used in user-to-user transactions on the platform. Aside from offering promotions, knowledge of a particular consumer's consumption patterns could be beneficial in terms of offering a high value potential client the attention and respect they are due even if a particular vendor had no prior interactions with that client and would not have otherwise known that they represented a high value potential business relationship. The data mined, and further processed with artificial intelligence and machine learning, could also be used by consumers to obtain recommendations for or from vendors of particular goods and services that have been consumed by other consumers using the platform with high volume or regularity. The data mined, and further processed with artificial intelligence and machine learning, could also be synthesized to provide users with information regarding the broader impact of their commercial decisions. For example, the data could be used to show how commercial transactions with a potential vendor impact a local economy vs. the broader economy, tend to lead towards income inequality across society as a whole, lead to a reduction in social good (e.g., environmental harm, support of unacceptable working conditions), result in political contributions to political groups with interests adverse to those of the purchaser, etc.

The commercial data platform of the present invention leverages interactions and accumulated lifetime values to provide user-customized experiences. By processing actual interaction data that reflects real assets exchange between end-users it is possible to obtain an accurate picture of the overall business relationship between individual end-users, the overall business practices of specific end-users, and the impact those specific end-users may have had on the local community of users and the global economy as a whole. The data in the platform could be used to generate ground truth derived content accessible from the Internet that reflects a faithful image of businesses and their relationship with customers based exclusively on real interactions. The content from the platform can become a powerful tool in assisting users with business decisions as an alternative to commonly used crowd-sourced review platforms where authenticity of the information is not always verified. The commercial data platform can therefore shield users from the hazards of inauthentic reviews, review gating, and actions that are generally in noncompliance with the guidelines of the Consumer Review Fairness Act through which untruthful and even deceitful content can be made available to users.

Content created based on data mined from the commercial data platform of the present invention, and further processed with artificial intelligence and machine learning can be used for businesses to keep customers aware of their status over the overall economy environment. Interaction data as harvested by the commercial data platform of the present invention can be placed in context to provide information about customer and vendor segmentation, frequency and quantity of transacted goods and services, value in absolute dollars, designated value class for the business or the customers, number of repeat customers a store or other business has, score for how well the spending habits of customers keep funds within the local economy, a rank for the relationship of a particular user, etc., all based on verified real time values and interactions. All that information mined from data in the platform can be used to create dynamic and customized web content, which will provide small businesses with an easy alternative to publish their content and to share their business and relationships values.

The data mined, and further processed with artificial intelligence and machine learning, from usage of the simultaneous voice and data content driven commercial data platform can also be used to rank or badge users of the platform in ways that incentivize actions that increase usage of the platform and that otherwise align with the general ethos of the platform and platform administrators. As one example, users that are more active on the commercial data platform can receive specific badges which are displayed in association with the user on the commercial data platform, or they can be ranked higher in response to search queries. By rewarding usage of the platform with more visibility on the platform a virtuous cycle is created to incentivize still further engagement. Additionally, and as mentioned above, the data produced by the commercial data platform can provide better ground truth information for such ranking and badging systems because, unlike customer review-based ranking and review systems, the data on which the ranking and badging is based is difficult to spoof. The actual exchange of monetary value to a specific user through the commercial platform and number of inbound calls to the specific user is a valuable metric that is difficult to fake. Furthermore, due to the fact that the commercial data platform works to facilitate commerce for individual users in their dual roles as producers and consumers, it is possible to track and reward users with badges or preferential ranks based on how likely they are to keep content and monetary value within either the platform as a whole, or within specific ecosystems thereof. In this manner, and as will be described below, the ranking and badging can be relationship-centric in the sense that a rank afforded to a first user may be specific to their relationship with a second user of the platform.

The system of specific embodiments of the invention can listen to an ongoing voice communication between the dialer device of a user of the platform and another terminal, understand the context and content of human language in the voice communication, and based on that understanding, surface, at least to the dialer device, useful information obtained from previously stored data in the system's database. In specific embodiments of the invention, the system comprises a server, a receiver device with a receiver identifier, a dialer device with a dialer identifier, a dialer programmed to initiate a voice call, over a voice channel, with the receiver device using the receiver identifier, a database, and a data channel connecting the dialer device, the receiver device, and the server, wherein the database stores interaction data in association with both the receiver identifier and the dialer identifier and wherein the system is programmed to obtain a voice sample from the voice call, process the voice sample to obtain a search cue, and using the search cue, obtain one or more interaction data from the database, obtain a response data from the one or more interaction data, and surface the response data to one of the dialer device and the receiver device. In specific embodiments of the invention, the system can surface the response data using voice communication. In specific embodiments of the invention, the system can surface the response data using a format such that the response data is displayable on the dialer device or the receiver device. In specific embodiments of the invention, the system can surface response data before a voice call, during a voice call, or after a voice call.

The listening functionality of the system of specific embodiments of the invention can provide significant benefit to the participants on the voice communication involving commercial, social, and/or professional interactions. For example, if Jill, the user of the dialer device, initiates a call to a receiver device of a pizza restaurant and at some point during the voice communication, she says, “I want to order the same side that I ordered the last time,” but cannot recall the name of the side item. In such a scenario, the speaker on the receiver device, e.g., an employee of the pizza restaurant, may not have that information handy. However, the system of specific embodiments of the invention can understand the statement and the intent of the statement, and in response, obtain a response data, from the database, that includes the side item(s) she ordered the last time and surface the response data to the dialer device and/or the receiver device for displaying the response data to one or both participants. As another example, if she asks, “What sides do you have?”, the system of specific embodiments of the invention can understand the question and in response, obtain a response data, from the database, that includes a list of the sides the pizza restaurant currently offers, and surface the response data to the dialer device for displaying the response data to Jill. In this way, the user of the dialer device can verify any response provided by the pizza restaurant against the response data surfaced by the system.

The listening functionality of the system of specific embodiments of the invention can provide significant benefit for voice communications in other, non-commercial contexts involving personal, or social, interactions or professional interactions. For example, suppose Jill initiates a personal call to a receiver device of a longtime friend, Melody, and at some point during the call, Jill says, “Do you remember in what year we went to Barcelona?”, but neither Jill nor Melody recalls the precise year(s), the system of specific embodiments of the invention can understand the question and in response, obtain a response data, from the database, that includes the precise year in which the two visited Barcelona and surface the response data to the dialer device and/or the receiver device for displaying the response data to Jill and/or Melody. As another example, suppose, Jill is a sales agent, who works from home, places a voice call to Mark, her supervisor, who is the user of the receiver device, and Mark says, “Let's discuss your sales data from last month,” a response data can be the total number of products Jill sold last month or the dollar amount of the sales Jill made last month. If Jill and Mark are discussing Jill's performance data, and Jill says, “For the past five years, I have been consistently ranked among the top ten sales agents,” a response data could be Jill's professional ranking and/or badging information stored in the database from prior interactions involving Jill and others from her work.

The above-described listening functionality requires the system of specific embodiments of the invention to process unstructured human language and understand the meaning and intent of a speaker's speech so that it may obtain an appropriate response data for surfacing to the dialer device and/or the receiver device. This can be done, as described in detail below, using natural language processing (NLP) software programs. NLP is a subfield of conversational artificial intelligence and can analyze natural or human language data.

Recent technological advents are ushering in a new era of digital connectivity and how humans interact with machines and with other humans through machines. For example, voicebots and in-home voice assistants that can recognize and understand the context, content, and intent of human voice expression are replacing traditional text-based means for human to interact with machines. At their core is one or more software powered by artificial intelligence. Google's LaMDA, a conversation technology based on artificial intelligence, supports chatbot operations; LaMDA can recognize conversational context and intent of a human query and engage in free-flowing conversations. Persistent chat room tools and platforms have emerged to allow participants to interact with voice, in addition, or as opposed, to with text. Metaverse, also known as 3D Internet, is on the verge of enabling a persistent and living virtual world for humans to engage, through avatars of themselves, in cross-platform gaming, e-commerce (with NFTs, blockchains, and cryptos), social events, and work collaborations. Metaverse even allows a person, through his or her avatar, to interact, using voice, with co-workers, attend a group meeting, and work from home. In each of these technological areas, a massive amount of data is exchanged daily over voice-based as well as text-based communications.

In the platform of specific embodiments of the invention, a participant to a terminal using any of these technologies, namely, a voicebot, voice-enabled persistent chatroom, in-home voice assistant, or Metaverse, can be a user of the platform who participates using the dialer or another application of a dialer device, and can open an information portal to the platform such that the platform can aggregate data from the participant's interaction with others, be it a machine, an avatar, or a human on the other end. In specific embodiments of the invention, the receiver device can be a chatbot device or a voice assistant device with which the user of a dialer device is on a voice communication, and the platform can harvest data from the user's interactions with the chatbot or voice assistant device and augment the platform's database with that data. In this way, the platform of the specific embodiments can aggregate interaction data from its users' voice communication with various chatbots and voice assistant devices to build a single unifying store of information.

In specific embodiments of the invention, the system comprises a server, a chatbot receiver device with a receiver identifier, a dialer device with a dialer identifier, a dialer programmed to initiate a voice call, over a voice channel, with the chatbot receiver device using the receiver identifier, a database, and a data channel connecting the dialer device and the server, wherein the server is programmed to store in the database interaction data in association with one of the receiver identifier and the dialer identifier, wherein the voice channel is a voice connection over a packet-switched network, and wherein the system is programmed to obtain a voice sample from the voice call, process the voice sample to obtain a response data from the voice sample, and store, in the database, the response data in association with one of the receiver identifier and the dialer identifier.

More specific examples of these benefits, how the data can be mined towards creating a single unifying store of information, and how the mined data can be utilized are provided in the detailed description below.

The decentralization of data control through technologies like blockchain and peer-to-peer systems offers increased individual sovereignty for users. Individual sovereignty in the digital age refers to the empowerment of users to take full control of their personal data, free from the control of big tech companies that often monetize and centralize information without transparent user consent. By reclaiming ownership of their data (e.g., via a peer-to-peer network), users can determine how, when, and with whom their information is shared, rather than relying on large corporations that profit from surveillance-based business models. This shift toward user autonomy promotes greater privacy, security, and freedom, enabling individuals to participate in the digital economy on their terms, ensuring that their digital footprint is not exploited or commodified without their explicit approval. Increased individual sovereignty fosters a more open, fair, and self-sovereign digital ecosystem. In specific embodiments, AI may assist in increasing individual sovereignty.

In specific embodiments of the invention, each user of a platform is provided with an AI chatbot (e.g., assistant) that has access to the user data that has been generated and gathered while using the platform. Users may link or connect other social media, communication, or information management platforms to this platform, and the interaction data from those platforms may also be harvested to improve the AI chatbot. The AI chatbot may be able to help users to organize and use their data in ways that only the big tech companies have been able to do, increasing individual sovereignty of users. For example, each user may have their own AI to mine their relationship data from the platform (and, optionally, from additional external systems they interact with), which may amount to large quantities of data. Usually, large quantities of data are not much use to individual users as the data may be too complicated for smaller entities to utilize and harvest information from. Usually, large quantities of data are only useful for large entities (e.g., Google) to harvest, manipulate, and monetize with their abundant resources (e.g., software engineers). However, the AI chatbot described herein may efficiently deal with the data and accordingly allow bypassing of costly resources to provide the user with a common language-based interface to harvest, manipulate, and monetize their own data.

In specific embodiments of the invention, users of a distributed algorithm in a peer-to-peer network may be rewarded for certain activities. For example, these activities may include helping run the distributed algorithm, spending money in a way that benefits the users of the platform and their local economies and getting positive feedback from other users. The rewards may include platform-centric currency and receiving a positive bias in verifying the portions of the algorithm performed on the user's device. In specific embodiments, users may also exercise individual sovereignty by erasing their data off the platform.

### BRIEF DESCRIPTION OF FIGURES

FIG. 1 illustrates a commercial data platform system for a call between a dialer device and a receiver device to facilitate a simultaneous transfer of voice and data content in accordance with specific embodiments of the present invention.

FIG. 2 provides data tables that can be instantiated by a database for a data model of a commercial data platform in accordance with specific embodiments of the present invention. The tables shown are non-limiting and for illustrative purposes.

FIG. 3 illustrates a dialer device with a dialer display and a receiver device with a receiver display, displaying information before and during dialing, and after the devices have received content from a server in accordance with specific embodiments of the present invention.

FIG. 4 illustrates the devices of FIG. 3 displaying information, during a voice call and after receiving new content from the server, in accordance with specific embodiments of the present invention.

FIG. 5 illustrates the devices of FIG. 3 displaying information, during the end of a voice call and after receiving new content from the server, in accordance with specific embodiments of the present invention.

FIG. 6 provides a flowchart and block diagram for a method for use of the system of FIG. 1 in accordance with specific embodiments of the present invention.

FIG. 7 illustrates the device of FIG. 3 displaying information that has been collected, aggregated, and synthesized by a commercial data platform to provide a user with visibility into the impact of their commercial decisions in accordance with specific embodiments of the present invention.

FIG. 8 illustrates a scenario in which a server is in communicative connection with a database and an external agent to collect interaction data or derivatives thereof from the database and surface it to the external agent in accordance with specific embodiments of the present invention.

FIG. 9 illustrates the use of customized pages by the commercial data platform and external agents in accordance with specific embodiments of the present invention.

FIG. 10 illustrates an example of a network topology in accordance with specific embodiments of the present invention.

FIG. 11 illustrates two examples of user pages that include rankings and badges in accordance with specific embodiments of the present invention.

FIG. 12 illustrates one embodiment of the invention wherein the system is programmed to surface a response data to a dialer device or a receiver device based on the context and content of a voice sample obtained from a voice call between the dialer device and the receiver device.

FIG. 13 illustrates a flowchart for a method for surfacing a response data to a dialer device or a receiver device based on the context and content of a voice sample obtained from a voice call between the dialer device and the receiver device in accordance with specific embodiments of the invention disclosed herein.

FIG. 14 illustrates an example of a system of a plurality of peer nodes running a distributed algorithm in accordance with specific embodiments of the invention disclosed herein.

FIG. 15 illustrates an example of a peer node receiving rewards based on a sentiment analysis in accordance with specific embodiments of the invention disclosed herein.

FIG. 16 illustrates an example of a system using a chatbot to output a message based on response data and external data from external platform in accordance with specific embodiments of the invention disclosed herein.

FIG. 17 illustrates an example of a system including a chatbot with artificial intelligence in accordance with specific embodiments of the invention disclosed herein.

FIG. 18 illustrates an example of two devices displaying information, during a chat or voice call, including messages from a chatbot with artificial intelligence in accordance with specific embodiments of the invention disclosed herein.

FIG. 19 illustrates an example of a method related to a simultaneous voice and data content driven commercial data platform using a plurality of peer nodes in accordance with specific embodiments of the invention disclosed herein.

### DETAILED DESCRIPTION

The following is a detailed description of systems and methods for facilitating simultaneous voice and data content driven commercial data platforms, followed by a description of the various functionalities that are enabled by such simultaneous voice and data content driven commercial data platforms. These examples are non-limiting and are provided for illustrative purposes. For example, numerous examples in this description are limited to cases where both parties to a conversation are utilizing smartphones or other mobile devices, but the platforms described herein function regardless of what kinds of devices are being used to access them. Furthermore, numerous examples in this description are limited to cases where two parties are using the platform in combination with a data channel as well as a voice channel. However, the approaches disclosed herein provide certain beneficial functions regardless of whether only one party is connected to the platform via a data channel or the voice channel. For example, one party could only have access to a voice channel and indirectly provide data to the platform via the other user's device. In specific embodiments, one party, a user of the platform, may initiate, using a dialer device, a voice communication with, for example, a chatbot server or a voice-assisted persistent room over a voice channel, the chatbot server or voice-assisted persistent room being a receiver device; a data channel may exist between the platform's server and the dialer device, but not between the server and the chatbot receiver or the voice-assisted persistent room; and the platform can receive the chatbot or the voice-assisted persistent room communication to the dialer device over the data channel between the server and the dialer device. As another example, one party might not be connected via a voice channel and might only be accessible via the data channel. Specifically, a vendor may set up an IVR system to handle all incoming traffic calls by routing the device to the data channel without ever establishing a voice channel.

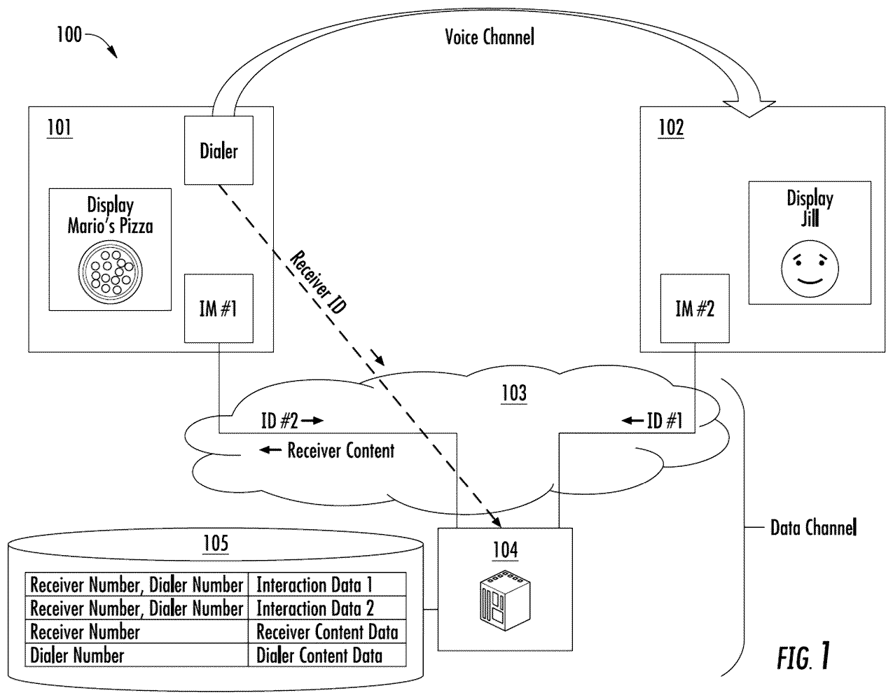

FIG. 1 illustrates a system 100 that can be used to facilitate a simultaneous voice and data content driven commercial data platform. The system 100 is based around a dialer device 101 and a receiver device 102. In certain approaches, the dialer device 101 and receiver device 102 will be connected via both a voice channel and a data channel. The voice channel can be a standard voice call connected between the two devices and facilitated by a circuit-switched network. However, any voice connection between the two devices can be utilized such as an IP phone connection facilitated by a packet-switched network 103. The packet-switched network 103 can utilize VoIP or other protocols. The data channel can be a packet-switched network 103 and can include a server 104 and a database 105 administrated by the platform. The network could include the Internet. The dialer and receiver devices can be any devices capable of supporting a voice call. Although the simultaneous voice and data content driven commercial data platform can function with users that are using separate devices for accessing the voice and data channels, in the system illustrated by FIG. 1, both users are using devices that can access both. For example, the devices may be smartphones that are able to support a voice based telephone call while also accessing the platform via a data connection such as via the Internet. The data channel could be accessed by an interface presented on a touch screen of the smartphones that are displayed during the call. The data channel interface could be shown alongside a dialer application and be provided by a separate application, or the dialer application could include an integrated window for the data channel interface. The data channel interface could be a screen overwrite, or screen overlay, inside, as part of, or on the dialer application screen normally unused and unchanging during the call duration, for the data channel interface. The devices could also be personal computers, wearables, standard telephones, or platform specific terminals. The users in the illustrated situation are a consumer by the name of Jill Smith and a vendor by the name of Mario's Pizza. However, the platform can also be used to facilitate peer-to-peer and business-to-business communication. As will be apparent from many of the examples provided below, users can also utilize the commercial data platform as both consumers and producers such as by both spending and receiving money and buying and selling goods and services.

The dialer device includes a dialer that is programmed to initiate a call between the dialer and the receiver device using a receiver phone number and/or other unique identifier. The dialer device can receive commands from a user using a traditional keyboard, auditory inputs such as voice via a microphone, touch inputs via a touch screen, gestures detected by an optical or non-visible light sensor, and any other means for providing user input. The dialer can be an application on a smartphone or a computer. The application could be the built-in dialer of a computing device, such as a smartphone, as developed by the developer of the operating system on the computing device. Alternatively, the application could be developed by the platform and include multiple functionalities in addition to serving as a phone dialer for establishing a phone call such as providing access to the data channel described herein, providing access to a persistent chat functionality, or providing access to a social media functionality. Alternatively, the application could be integrated with a third-party application such as persistent chat tool or a social networking application configured to allow the formulation of a voice channel between two parties using a receiver phone number and/or other unique identifier associated with one of those parties. The dialer can receive the receiver phone number and/or other unique identifier via a voice command, the selection of a hyperlink, the manual entry of a phone number and/or other unique identifier, scanning a QR code, or any other method for providing numbers to an application. The dialer can also be an application on a traditional electronic telephone that has been augmented for use with the platform. The dialer application can set up a voice call via a traditional circuit-switched network or via a packet-switched network such as via voice over Internet Protocol (VoIP). In any of these situations, and regardless of how the dialer initiates the call between the dialer and the receiver device, the receiver phone number and/or other unique identifier will be intercepted for use by the platform. Various approaches for intercepting the receiver phone number and/or other unique identifier are described in more detail below.

The commercial data platform also includes a server and a database. As illustrated, in FIG. 1, the server and the database can be connected to the dialer device and the receiver device through a network. The network can be a packet-switched network. The network can be the Internet. A data channel between the receiver device and dialer device can be supported by software on the receiver device and dialer device, the network, the server, and the database. The data channel can be supported by a first interaction manager (IM) stored on the dialer device and a second interaction manager (IM) stored on the receiver device. The interaction manager on the dialer device can be programmed to transmit a first set of interaction data (ID) to the database during the call. The interaction manager on the receiver device can be programmed to transmit a second set of interaction data (ID) to the database during the call. In specific embodiments of the invention, the data channel can include the first interaction manager, the second interaction manager, and the server. The interaction data collected during the call can be sent to the server using the data channel for storage in the database.

In approaches in which the devices include applications developed and provided by the platform, the interaction managers could be included in those applications. In the specific case of a smartphone with an application provided by the platform, the interaction managers could be part of the same application as the dialer on the dialer device.

The server and database can be part of a cloud-based platform. The server can be any system of software and suitable computer hardware that is capable of responding to requests across a network to provide a network service. Although the server is illustrated as a single unit of physical hardware, the server may comprise multiple physical hardware units. The physical hardware units can include personal computers, workstation, and dedicated enterprise server blades. The physical hardware units can be in a single physical location such as an office or data center, but they may also be located at separate data centers or offices. The server can be a virtualized server. Individual network services can be provided by individual servers or multiple servers, as well as individual units of physical hardware or multiple units of physical hardware. As the term server is used to describe a system that provides multiple network services in certain portions of this disclosure, it is implied that the multiple network services are not necessarily being supplied by a single unit of physical hardware. The database can be a proprietary database and have a data model that is in accordance with the detailed description below. This data model is exemplary, and more complex data models can be used with hundreds of tables with different keys to access the data. The database can be a relational or non-relational (e.g., NoSQL) database or any other database technology supporting high-speed real-time inserts, updates, and reads.

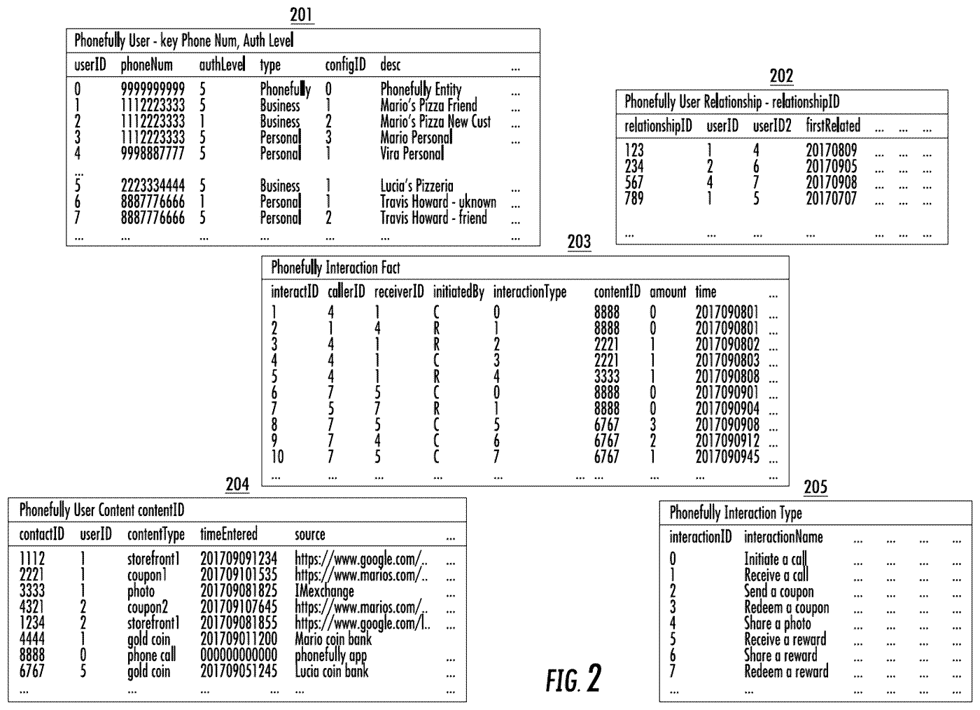

The data model of the commercial data platform can include multiple data tables instantiated by the database. The tables can include a user identity table, a user relationship table, a content table, an interaction type table, and an interaction fact table. FIG. 2 provides an example data model for a commercial data platform that includes tables 201, 202, 203, 204, and 205. As seen, the tables can be interrelated to provide a complete record of all interactions occurring using the commercial data platform which can later be accessed and mined, and further processed with artificial intelligence, machine learning and deep learning, to provide both consumers and vendors with rich data to enhance their later interactions. As illustrated, interaction data between a receiver and a dialer can be stored in association with both a dialer and receiver phone number or other unique identifier. Furthermore, it should be noted that the devices in the commercial data platform will have access to third party databases such as social media databases either directly or via the database of the commercial data platform as the IM on either device will be able to request the platform to obtain information from alternative databases which would then be stored in the platform's content table. Alternatively or in combination, the platform could be configured to request content from third party databases and dynamically generate responses when the requested content from an IM is not located in the database.

The database of the commercial data platform can include receiver content, dialer content, and interaction data. This data can be accessed in numerous ways to facilitate rich interactions between a dialer and receiver that are using the platform. This data can be surfaced to the receiver device and/or the dialer device before, during, and after a voice call. In specific embodiments of the invention, this data can be surfaced using voice communication as well as any data format that facilitates visual display of the data such as texts or pictures. As illustrated in FIG. 1, once a receiver phone number or other unique identifier is sent from the dialer to the server, the server can use the receiver phone number or other unique identifier to obtain receiver content data from the database and deliver it back to the dialer device. The receiver content data can include a profile from the receiver. For example, the profile could be a company storefront with static or animated images and videos with sound advertising the vendor's offerings. The storefront could include a company name and a profile image. Alternatively, the receiver content data could include links to a set of interaction data in the database to allow the dialer to begin interacting with the receiver using the platform before the call is set up between the two devices. The receiver number can be provided to the server in any number of ways as will be described in more detail below. Once the call is established, dialer content data could be delivered to the receiver device. The dialer content data could likewise be a profile for the dialer. The profile could be a dialer profile with a username and a profile image. Both the dialer content data and the receiver content data could be pulled directly from the database of the platform or it could be dynamically generated by the platform via access to other information sources using the internet such as through a third-party API using either the receiver or dialer phone numbers and/or other unique identifiers. For example, if a receiver did not yet have a profile, the phone number of the receiver could be used in an internet search to obtain a name of the business, a location, and a few images of the business to produce a profile for display on the dialer device. The server can be programmed to detect an absence of profile data in order to trigger this dynamic generation of a profile.

The profile data displayed to a counterparty during an interaction using the platform can be configurable and can be specific to that counterparty's identity. For example, a user can be given the option to select images and other information to present as part of their identity. The profile can be a storefront for the user. The capability to generate this profile can involve selecting options and entering information for a template or it can involve a more flexible tool for designing the content such as a drag and drop WYSIWYG interface. The user can also configure multiple profiles for display using the system and can set different rules for who those multiple profiles are displayed to, in the form of profile sections. The user could set a specific profile for commercial use and another profile for personal use. The user could set a specific profile for callers they have a history with and another profile for callers they do not have a history with. In order to determine which profile content should be delivered, the platform could utilize both the dialer's phone number and/or other unique identifier, and the receiver's phone number and/or other unique identifier. The level of customization could drop all the way down to the level of individual callers and their specific relationship and/or authentication/authorization levels. Customization at this level could be provided in an automatic fashion by the platform while allowing the users to customize the automatic storefronts even more. For example, the storefront provided by Mario's pizza to Jill Smith could be automatically set by the platform to display the last order Jill placed with Mario and the number of times that Jill has placed an order with Mario generally, but Jill could be given the option to display a customized picture to Mario when she gives him a call such as a picture she took the last time she visited his restaurant. As another example, the platform could keep track of a confidence level for each number a person could reach out to. The confidence level could continue to rise based on how much interaction had taken place using the platform between that user and the number, and whether or not those interactions were positive or not. Users could then set different profiles up to be displayed based on those confidence levels where, for example, personal information was held back from being displayed if a confidence level was too low. As another example, the displayed information shown on the profiles could also include an assigned valuation of the relationship with the counterparty to the call. The assigned valuation could be generated dynamically by the platform based on the accumulated data stored therein from prior interactions between the parties to the call. More specifically, and returning to the call between Jill and Mario, the data in the platform could be used to generate and display a grade of “A+” to Mario to remind him that Jill is a repeat customer that should be treated with extra care and attention.

The profile data described above could also be processed so that it is available as a web page to be surfaced to an external agent outside of the platform. Users' profiles stored in the database could be adapted to a web readable format so that they are accessible from a web browser or a social media platform. In this way, small business such as Mario's Pizza can be advertised on the web and new customers can find it and become aware of the platform if they are still not a part of it. The server could behave as a Content Management System (CMS) for the profile data in order to make that data available to the Internet. Additionally, the server can provide profile data to third party applications using an API so that third party applications can interconnect their users with the data in the platform, obtain new customers based on the profiles in the platform, and bring new users to the platform.

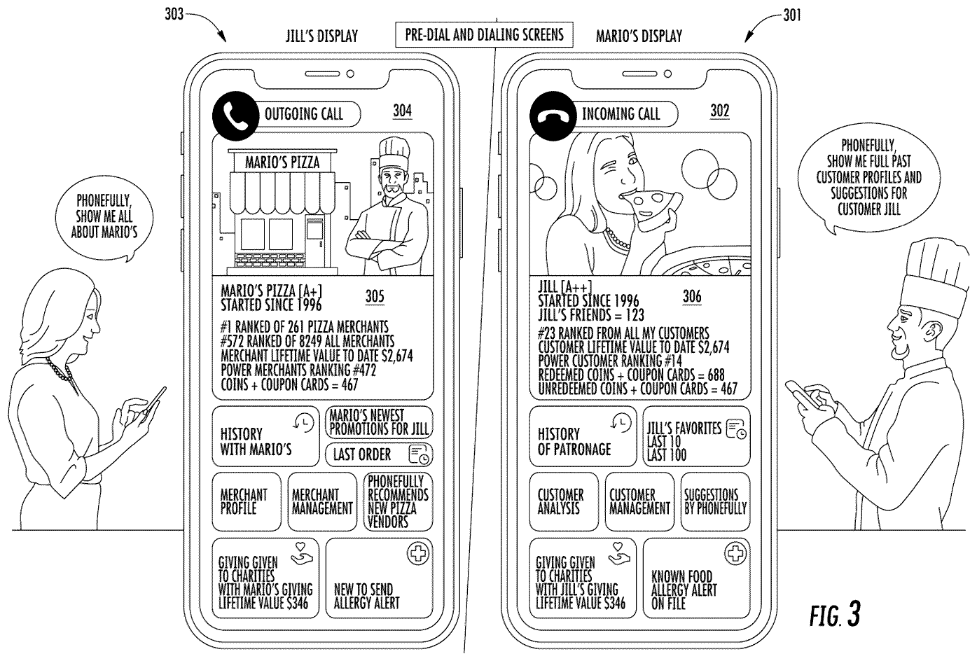

FIG. 3 illustrates a specific example of a dialer device 303 with a dialer display 304 and a receiver device 301 with a receiver display 302 displaying information before and during dialing, and after the server 104 has delivered receiver content and dialer content to the respective devices as shown in FIG. 1. As seen, the profiles delivered to each of the devices are specific to both the receiver and the dialer. In this situation, the profiles delivered to each of the users, for example Mario's profile 305 and Jill's profile 306, have also been curated by either the platform or the individual users to reflect the relationship that has already been established between the users. This illustration also provides an example of how the commercial data platform can generate data for display using prior interaction data. In each of the displays 302 and 304, the counterparty has been assigned a ranking in terms of how often prior interactions have occurred to generate a label of “A+” which reminds the user of the value they should place on their relationship with the counterparty.

The manner in which interaction data is obtained for usage by the platform can also be described with reference to FIG. 1. Interaction data can be provided to and from the dialer and receiver devices to the server of the commercial data platform using interaction manager software stored on the device. The interaction manager will request information from the database and receive information from the database. It may also receive information from external databases that are accessed by the server. The interaction manager can receive data that is pushed from the database without a request being sent. As such, the software that facilitates interactions between the two devices along the data channel of the platform can be spread out amongst the server, the dialer device, and the receiver device. The first and second interaction managers can be programmed to transmit a first and second set of interaction data to the database during a call between the dialer device and the receiver device. The interaction data can be transmitted to the database through a data channel established between the interaction managers and the server, and the server could be responsible for receiving the interaction data from the interaction managers and store it in the database. The interaction data can be stored in the database for later use. The interaction data can be any data relating to the interaction between the dialer and the receiver during the call. For example, the second set of interaction data can involve a menu pushed from the receiver to the dialer through the data channel, and the first set of interaction data could include a selection of an item on that menu by the dialer. In these situations, the interaction data is being stored in the database and is also being passed through the platform from one device to the other to facilitate the current interaction between the devices such that the server and database are serving as part of the data channel between the two devices. For example, the interaction data sent from a vendor-receiver to a consumer-dialer could be a sales offer, while the interaction data sent back from the consumer-dialer to the vendor-receiver could be a purchase order generated in response to that offer. Any commercial interaction could be facilitated through this data channel via the transmission of various types of data. In keeping with the prior example, the interaction could continue with additional interaction data in the form of a receipt sent from vendor-receiver to the consumer-dialer. The data would be both channeled through the platform and stored by the platform for later use. The interaction data can also include information that is not provided from one device to the other such as payment information provided by the dialer device to the platform for forwarding to a payment processor. Even though the payment information is not provided to the receiver device it can still be referred to as interaction data herein because it relates to the interaction between the dialer and the receiver and it is ultimately provided to one of the devices.

The interaction data provided during the call can be a subset of the interaction data pushed by each of the devices to the server. The interaction data that is sent between the devices can facilitate a high-level of interaction between the receiver and the dialer. In certain approaches, the data channel of the commercial data platform will serve as a virtual table top to allow for the dialer and receiver to collaborate, and the interaction data sent during the call will be represented on this table top. The interaction data exchanged between the dialer and receiver is saved in a database and is, in turn, made available to enrich the current voice call as well as any future calls. Over time, a rich history of all past interactions is obtained and is readily available to both parties to further enrich the long-term relationship between the parties. The history of past interactions stored in the database can likewise be available for use externally to the platform. The server could be configured to provide interaction data to an external agent that is not necessarily involved in the communication between the dialer and the receiver. For example, the server may provide interaction data associated with a plurality of customers and a plurality of businesses to a recommendation search engine so that users are presented with real statistics of how many customers repeat their orders at a certain restaurant when compared with a similar one in the neighborhood, which is definitely an accurate indication of the acceptance of the restaurant in the area. This kind of ground truth and authentic data harvested by the system can provide superior recommendations that are based on reviews and “likes” that could be inauthentic or outright fake. In this way, users will be able to evaluate on their own the quality or reputation of the restaurant based on real interaction data rather than based on third user's reviews that have turned out to be misleading in many occasions.

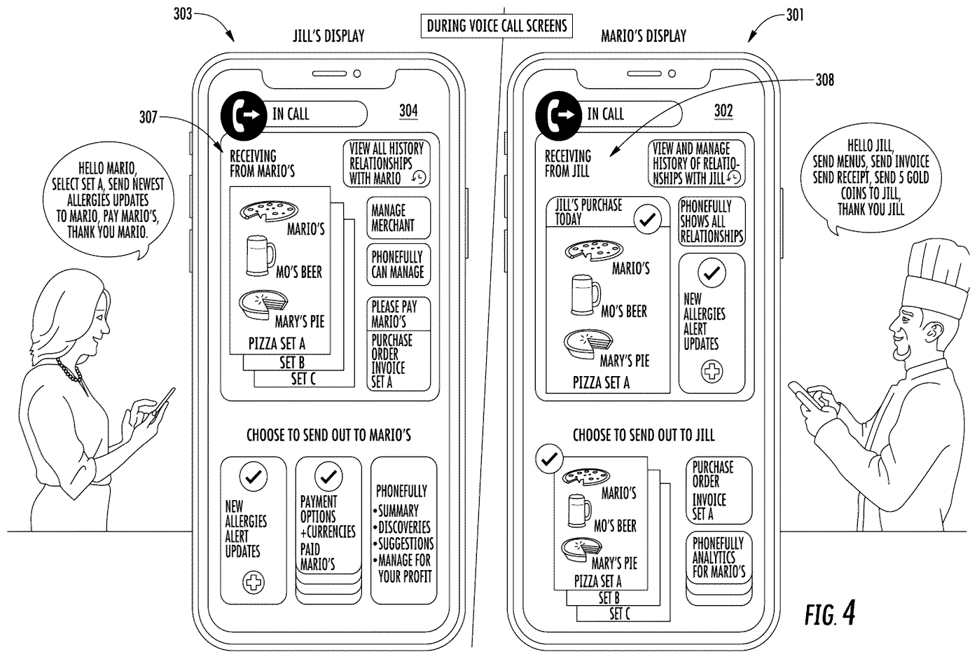

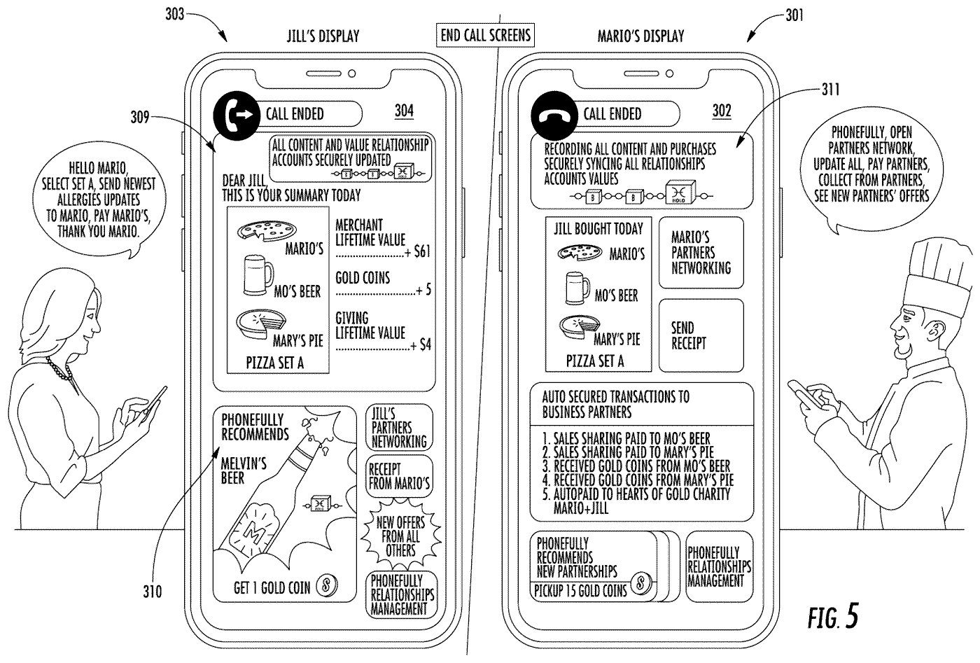

In the example of Jill and Mario, Mario could use the table to present coupons or deals to Jill in real time as Mario took Jill's order. Mario would also be able to pull information from the database concerning Jill such as the upcoming anniversary of a special event that she previously reserved a table for in order to offer her the opportunity to celebrate at Mario's again this year. Jill could also request additional information such as a picture of the inside of the restaurant's new exclusive private room for large parties, which Mario could provide in real time during their call. The data channel could also be used for Mario to provide Jill with a coupon for her next order at the conclusion of their call where an image of the coupon was provided to Jill's phone in the form of interaction data and stored in the database for later use by Jill the next time she called Mario. The data channel could also be used to provide platform wide incentives such as a specialized currency that can be used across all vendors that participate in the platform. As shown in FIG. 4, during a voice call and after receiving new content from the server 104, the display 304 on Jill's phone can show receiver device receiving information 307 which shows, for example, that Mario had prepared a food order to be received by Jill according to her preferences. The display 302 on Mario's phone can show dialer device receiving information 308 which shows, in the same example, that Jill confirmed her food purchase. As shown in FIG. 5, during the end of a voice call and after receiving new content from the server 104, the devices can show additional messages. Nonlimiting examples of such additional messages can be summary messages 309, recommendation messages 310, and data synchronization messages 311.

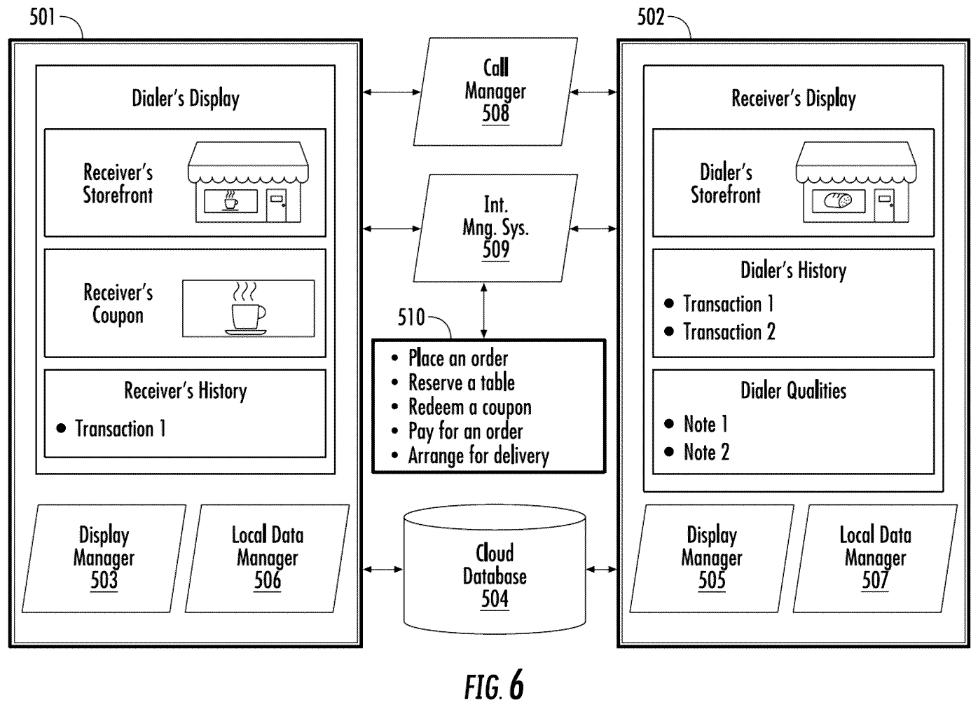

As described in a system diagram provided by FIG. 6, the dialer device 501 with a dialer and the receiver device 502 could include additional software elements to help facilitate the functioning of the commercial data platform. For example, each device could include a display manager and a database. In one example shown in FIG. 6, the dialer device 501 can have a display manager 503 and be connected to a cloud database 504, and the receiver device 502 can have display manager 505 and be connected to the same cloud database 504. The display managers 503 and 505 could continuously receive content from all data sources in the platform and display content based on the configuration of the device owner's account with the platform. The display managers 503 and 505 could receive the content before, during, or after a voice call. Display managers 503 and 505 perform local display management functions for the devices on which they are installed. A cloud database 504 can include the qualities and function of a local database, a platform database, and other database configurations that can be used with the commercial data platform. The display managers 503 and 505 could work in combination with the interaction manager to request data from the cloud database 504, and filter data delivered from the server before that data was presented on the device. For example, the interaction manager could indicate that a user was being provided with a set of gold coins, and the display manager 503 could select a particular image from the cloud database 504 that the user had selected to represent those coins. The display managers 503 and 505 could be programmed to generate display content for displays on the devices 501 and 502 using the interaction data from the cloud database 504. For example, the interaction data could include a sale offer generated by a receiver for delivery to the dialer device 501 through the database and server while the display content constituted an image used to make the sale offer visually appealing. The image could be stored in the cloud database 504 in association with the receiver's phone number and/or unique identifier. The display managers 503 and 505 could generally format content provided by the interaction manager for the displays on the respective devices 501 and 502. As such, the development effort associated with cross platform implementation could be lessened as the display managers 503 and 505 could be more heavily altered while the interaction manager stayed relatively stable with different implementations. The cloud database 504 could be managed by a local database manager locally installed on the system devices. For example, the dialer device 501 could have a local database manager 506 and the receiver device 502 could have a local database manager 507. Alternatively, system devices can have a local database element installed thereon, enabling local data storage on each device. Devices with a local database can operate independently or in concert with a cloud database 504 as part of a database network and can be managed by the local database managers of the respective devices, such as local database managers 506 and 507. The dialer device 501 local database manager 506 could be programmed to obtain data from interaction data regarding past interactions between a specific dialer and receiver whenever the dialer initiates a new call between the dialer device 501 and the receiver device 502. Past interactions stored in a database could include a transaction history of, or notes about, the communicating party, as shown on the example device displays illustrated in FIG. 6. The cloud database 504 could also be used to limit the amount of traffic on the network between the server and the dialer device 501 by storing data that was frequently accessed by the display manager 503 on a particular device. For example, if Jill was a regular customer of Mario's, then Mario's logo could be stored on Jill's device for retrieval every time her phone loaded Mario's profile. The local database manager could assure that certain dialer, receiver, or interaction content data persisted on the device between interactions for this purpose.

The user interface presented to the user could take on numerous forms. The user interface can display controls and information for the data and voice channels separately or simultaneously. The data channel interface could be shown alongside a dialer application and be provided by a separate application, or the dialer application could include an integrated window for the data channel interface. The data channel interface could be a screen overwrite, or screen overlay, inside, as part of, or on the dialer application screen normally unused and unchanging during the call duration, for the data channel interface. The dialer application screen could be the call screen of a built-in dialer application on the dialer device 501 and could display standard controls such as an end call button or a mute button. In the specific example of the data channel being administrated by a separate platform application that works in combination with a separate dialer, the platform application could present sufficient controls for handling both the data channel and the voice channel. For example, after intercepting the call, the voice channel would remain open, and the platform application would completely overlay the screen and display a user interface with the data channel where the interactive data content will appear without the need to switch to an outside additional application. Controls such as “mute” and “speaker phone” would now be available within the same user interface, and there would be no need to return to the original dialer application interface. If at any time during the call, the user would like to return to the original dialer application interface that initiated the call, the user could hit an icon on the user interface and return to the original dialer screen.

The devices used in combination with the platform could also include a real-time interaction manager and call manager 508. The call manager 508 could support continuation of a voice call, and the voice call itself, allowing the users to access the dialer and phone controls as needed. The call manager 508 could also support the voice channel independently of the data channel. The real-time interaction manager could continuously manage the interactions between a caller and receiver to make sure that all their interactions are logged in the cloud database 504. The real-time interaction manager could write and read data to and from the cloud database 504 and third-party external databases. The two components together could support the simultaneous use of multiple devices for the voice and data channel. The interaction manager could also manage and store all interaction threads 510 and activities during an ongoing communication over the data channel. The real-time interaction manager could include software stored on either device, including the interaction managers mentioned above, as well as software on the server of the platform. The interaction managers could manage at least two interaction threads 510 between the dialer device and the receiver device and would likely manage many more depending upon the level of interactivity provided over the data channel. Alternatively and with respect to the embodiments described above, the functions of the interaction manager and the real-time interaction manager can be implemented in the commercial data platform system by an interaction management system 509. The interaction management system 509 can be operated remotely using a cloud-based system and can be in communicative connection with both the dialer device 501 and the receiver device 502 to perform the interaction manager functions for both devices.

The software modules and components on the devices involved with the data channel that are described above, such as the display managers 503 and 505 and interaction manager, could be administrated by a single application or multiple applications. In addition, the dialer and call manager 508 that are involved with the voice channel could be administrated by a single application or multiple applications. Furthermore, the components associated with either channel could be administrated by a single application or multiple applications. In one approach, a single application provided by the platform administrator and stored on a device, such as a dialer's smartphone, could include an integrated dialer such that the application both initiated a phone call, alerted the platform to open the data channel, and administrated both channels during the call. The dialer, as a module of that application, could be programmed to receive the receiver phone number and/or other unique identifier prior to initiating the call and transmit the receiver phone number and/or other unique identifier to the server for purposes of obtaining receiver content for display to the dialer, and setting up the data channel. In another approach, two separate applications could be involved with dialing and communicating with the platform. The dialer could be a built-in dialer application on a smartphone operating system. The dialer could alternatively be a module in another third-party application installed on a smartphone or other computing device's operating system such as an integrated dialer in a social networking application. In a smartphone implementation, the separate application used to intercept the receiver phone number and/or unique identifier on behalf of the platform could be another application on the smartphone operating system with read phone state permission. The separate application could then receive a broadcast indicating that the dialer was initiating a call, obtain the receiver phone number from the broadcast, and transmit the receiver phone number and/or other unique identifier to the server. In either case, the application that is used to pass the receiver phone number and/or other unique identifier to the platform could be provided by the platform administrator through a network content distribution system such as an application store.

The applications could be installed and maintained on the user's devices. In one scenario, a potential user downloads the platform application to their mobile device and installs the application. At the same time the user could configure their mobile device to receive upgrades to the application over time. The user could then configure their platform application such as by setting their profile, customizing a storefront, configuring which profiles are shown to which users, and other options. The user can invite other users to join the platform by sending invitations out from within the application interface. The user can provide a command to send an invitation to specific people such as via the entry of their phone numbers in the application. The platform would then send out text messages to those users with a link to download the application.

Another way to invite users to join the platform is to simply call them. A user does not need to have the platform application installed to receive a call from a user who is. The receiver can receive a call in the same way that they always do, and can then be invited to join the platform while on the call. However, the application on the dialer device could receive a response from the platform that the receiver was not yet in the system. A user interface element could then be presented on the display of the dialer device, possibly alongside a temporary profile for the receiver that was generated dynamically, informing the dialer that they can invite the receiver. Upon selection of this user interface element, the platform could send a text message to the receiver device with a link to download the platform application. The dialer could be incentivized to invite the receiver through the use of incentives such as currency with the platform, coupons, or other incentives. The platform could customize the incentive and display it alongside the user interface element based on an identity of the receiver or dialer. To assure adoption, the dialer could be provided with an auditory queue over the phone to indicate that the receiver had indeed either received the text message, or installed the application on their device. The auditory queue could be provided over the voice channel to assure that both the dialer and receiver could hear when the receiver took steps to join the platform.

The commercial data platform can, as mentioned above, be made extensible via access to additional source of data such as third-party databases. Furthermore, the commercial data platform can be made extensible through the use of APIs used to interact with entirely separate platforms. In one particular example, the platform database can be used as a source of truth for an external incentives platform. The real-time interaction manager of the commercial data platform can be used to synchronize certain portions of the commercial data platforms database with an external database through the use of APIs. One type of synchronizing API can be distributed ledger technology. Distributed ledgers can comprise data sets that are stored and synchronized over multiple storage locations. Distributed ledgers and, equivalently, the data of which a distributed ledger is comprised, can be stored on a network of devices called a distributed ledger network. One example of distributed ledger data can be a set of ledger tables for an incentives platform where vendors and customers are able to exchange coins or cards for goods and services. Another example of distributed ledger data can be a first set of interaction data and a second set of interaction data that form a commercial transaction and are stored in association with the two parties to the transaction. For example, the first and second sets of interaction data can comprise a purchase order and an invoice. Interactions taking place on the commercial data platform can involve these external incentives platforms in the sense that data can be taken from those external platforms or pushed to those external platforms. In this situation, a customer is rewarded with an incentive from a seller for referring another customer to the seller. All of the many interactions associated with that set of transactions are facilitated and recorded by the commercial data platform and are used to update the external incentives platform. Therefore, through the use of APIs and the real-time interaction manager any number of external services can be added as services to the commercial data platform essentially mining the data from all of the interactions that occur on that platform into a single frictionless system that ensures full commercial trackability and traceability as to which vendor, merchant and referring customer added value to the chain of interactions to be compensated with agreed rewards payable for example in gold coins and accruable incentives.

One class of external databases that can be accessed by the commercial data platform are those associated with advertisers. The commercial data platform can interact with these external databases using the interaction data harvested by the platform in order to provide useful advertisements and offers to the participants of the platform. Since the interaction data will include information regarding the purchases, purchase decision processes and substitutes available during those decisions, as well as other areas of interest of the platform participants, a rich picture of the platform participant as a purchaser can be developed. This data can be kept isolated by the commercial data platform and used to request or authorize the entry of advertisements from external databases without allowing the advertisers access to the stored data to ensure user privacy. Given the rich amount of data available to profile a purchaser, and the fact that the purchaser is likely already engaged in commerce when using the system, the advertisers can pay strictly for sales originating from advertisements drawn into the platform. Alternatively, the external database can be accessed using ad criteria that has been supplied from the platform using attributes such as, for example, the type of business being called and or attributes about the dialer and/or receiver, and/or any other attributes that may be useful to serve an appropriate ad.

In a specific embodiment of the invention, a server in the system is programmed to obtain interaction data using a dialer identifier and a receiver identifier after a dialer has initiated a call with a receiver. The server is also programmed to analyze the set of interaction data and obtain external content from an external database based on the analyzing of the interaction data. A display manager stored on the dialer device can then generate, during the call, display content for a display of the dialer device using at least a portion of the external content. The external content can be advertising content and the analyzing of the interaction data can comprise determining a degree of interest in the advertising content based on the interaction data. Certain embodiments in accordance with this disclosure exhibit certain benefits in that the call screen of a standard call using a smartphone includes unused real estate that can now be put to use by providing interesting offers to a user. Furthermore, the interaction data associated with both the dialer and receiver is usefully harvested for determining a degree of interest in advertising material because the particulars of the commercial situation that lead to the creation of that interaction data is highly likely to apply to the current call as well. For example, if the interaction data shows that a user is likely to purchase a specific soda when ordering a given type of food, advertisements for a promotion for a close substitute to that specific soda are likely to have a greater impact if delivered during the call because the purchaser is already considering their desire for that product. In this way, prior interaction data serves to create, not just a good profile of a purchaser's interests in general, but a highly tuned profile of that purchaser's interests in a situation that they currently find themselves in.

The Simultaneous Voice and Data Content Driven Commercial Data Platform will track, to the greatest level of detail possible, the comprehensive set of all interactions that occur between the numerous entities transacting business, including interactions between networks of entities and themselves or other entities, in a reliable, secure, and above all trusted manner. Supporting these transactions, and any incentives and rewards system, will require support for any number of currencies including traditional country specific currencies, a platform proprietary currency, and any accepted externally recognized cryptocurrencies. The Commercial Data Platform will facilitate these currencies' inter-convertibility, for example through a series of sequential debit and credit transactions using different currencies, and act as a currency exchange. Currencies usable with the Commercial Data Platform can include stored bank account funds backed by various national entities in the global banking system, cryptocurrency funds, and credit card funds. The ledger of transactions representing all transactions, regardless of currency, must be tamper-proof and, therefore, the Commercial Data Platform will make full use of the repertoire of any current or future mechanisms, systems, processes, and technologies to construct and insure ongoing trusted, secure, scalable, and protected Commercial data platform integrity comprising of, but not limited to, the use of technologies such as a Distributed Ledger Technology (DLT) like Blockchain and Holochain.

Through the use of the commercial data platform and techniques described above, a multitude of opportunities for enhanced consumer-to-consumer (C2C), business-to-consumer (B2C), and business-to-business (B2B) commercial relationships are created. The flow of data between parties both enriches the current interactions from which that data is being mined and future interactions between the parties as they build stronger ties and commercial relationships. To further this goal, the data can be mined and further processed with big data analytics, artificial intelligence, natural language processing (NLP,) machine learning, deep learning and deep artificial neural networks. These benefits are described below in multiple scenarios to illustrate some of the rich content and interactivity that the commercial data platform provides. The scenarios can, at a top level, be broken down between two sets of scenarios. In one set of scenarios, the dialer interacts with the receiver using both the voice and data channels described above. In the other set of scenarios, the dialer interacts with the receiver using only the data channels. The scenarios are specific examples of the use of a system in accordance with this disclosure and are not meant to limit the scope of the appended claims. Phonefully is provided as an example of a simultaneous voice and data content driven commercial data platform, the Phonefully proprietary data store (PPDS) is provided as an example of the database of the simultaneous voice and data content driven commercial data platform, the Phonefully App is provided as an example of a platform application, the caller is provided as an example of a customer-dialer, and Mario is provided as an example of a vendor-receiver.

The data produced by the Simultaneous Voice and Data Content Driven Commercial Data Platforms disclosed herein and stored in the ledger of the platform will contain an intricate and detailed web of information concerning all of the commercial interactions of the various market actors within, or on the periphery of, the commercial data platform. In embodiments of the invention mentioned above in which a currency is made for usage outside the commercial data platform, but whose usage data is either traced in a distributed ledger or otherwise made available to the commercial data platform, any usage of the currency will likewise add to the level of information provided by this web. This data will be ripe for mining and synthesizing, such as with artificial intelligence, to provide all market actors with information regarding the broader impact of their commercial decisions on the overall market that lies within the web of information. The data will include not only what a customer purchased or a seller sold, but what other options the transaction participants considered when making their decisions, what incentives were sufficient to drive a purchasing decision, or even what amount of time a party took to reach a decision on spending. The data can also be combined with data accessed from external sources, as described above, including external economic market content. All this data can be synthesized, such as with artificial intelligence, into a more complete picture of the forces of supply and demand at work in the relevant market.

Adam Smith once said that the economy functions according to an “invisible hand” which guides the selfish acts of individual market actors towards the production of social benefit. However, the invisible hand and reliance on the selfish acts of individual market actors to provide social good was an unavoidable aspect of Adam Smith's vision—not a laudable feature. Today, there is no reason to keep the hand invisible when you have access to vast troves of data, analyzed and synthesized using big data techniques and artificial intelligence, that reveal the flow of commerce between all actors in an economy and their preferences, nor is there any reason to rely solely on the selfish acts of individual market actors when there is ample evidence that people do wish to make the world as a whole better with their choices even if they derive no material benefit from doing so. Both these improvements to the traditional operation of a market economy can be made through the use of the systems disclosed herein. As the CRMs we have described include massive amounts of data regarding all of the commercial transaction conducted by an individual, and also provide a liquid channel for feeding back a synthesized version of that data to individual market actors, those market actors can see the impact of their commercial decisions and be empowered to make choices that improve the economy and world as a whole.

In specific embodiments of the invention disclosed herein, the CRM is used as a system for the improvement of social good through intelligent informed interactive C2C, C2B, B2C, and B2B commerce. Various implementations of the CRM can provide these benefits in various ways including storing and analyzing the mass of interaction data using Blockchain technology to package the data in such a way that the chain of relationships and interactions is readily accessible and cryptographically encoded in each block of data utilized by the system, packaging and presenting the information to users in a manner that gamifies and incentivizes social betterment, as will be described immediately below, and providing the system with an embodied representative of the CRM itself in the form of an avatar that can encourage users to take actions that contribute to social welfare as opposed to their own direct personal benefit. With specific regard to Blockchain, and as described above, the CRM would benefit from employing and harnessing Blockchain to track, report on, and proactively present how a user's transactions and relationships choices through histories of relationships, exchanges, interactions, and transactions have affected the system as a whole, and the outside world, as opposed to just providing an account statement for the user and the parties the user has interacted with directly.

In addition to the benefits noted above of synthesizing all the individual exchanges and transactions of content and payments within the CRM and displaying that synthesized information to a user, a layer of gamification can be added to the system to encourage individual market actors to maximize the level of social good they are generating with their commercial decisions. Various scoring systems and metrics can be provided to allow an individual market actor to understand the potential impact of various choices available to them. Incentives can also be provided such as in the form of sweepstakes wins or the actual issuance of commercial data platform currency in exchange for points scored. The scores and metrics can have different objectives such as favoring contributions to a local economy vs. the broader economy, decreasing income inequality, decreasing environmental harm, etc. Users can also be provided with the ability to determine which metrics they want tracked or displayed when faced with a given commercial decision. The scores and metrics can be presented to the user with respect to various commercial decisions. For example, the scores and metrics can provide a score for dealing with a specific counterparty, making a particular purchasing or selling decision relative to another, or choosing to invest money instead of spending it. The information can therefore be utilized to determine, for example, if a market participant should transact with merchant A (a local coffee shop) instead of merchant B (a global chain of coffee shops) because of the impact transacting with merchant A will have on the local economy relative to transacting with merchant B. Furthermore, the information can be used to help determine what should be purchased from merchant A, and whether a purchase in any given case produces more harm than simply abstaining.

In specific embodiments, the CRM can take on a roll similar to a gamemaster within the game system provided by the CRM and interact directly with the players. The gamemaster can be instantiated by an avatar within the system and interact directly with the various users in the system to provide them with information or encourage them to take actions that provide beneficial externalities as compared to making decisions based solely on price and benefits that are derived directly by the user. The avatar can provide the scores and metrics mentioned in the previous paragraph through voice or visual communication with the user as provided by an interaction manager or a display manager on the user's device. The scores and metrics can be presented to a user to assist them with making a decision as well as in reviewing the cumulative effects of their prior usage of the system.

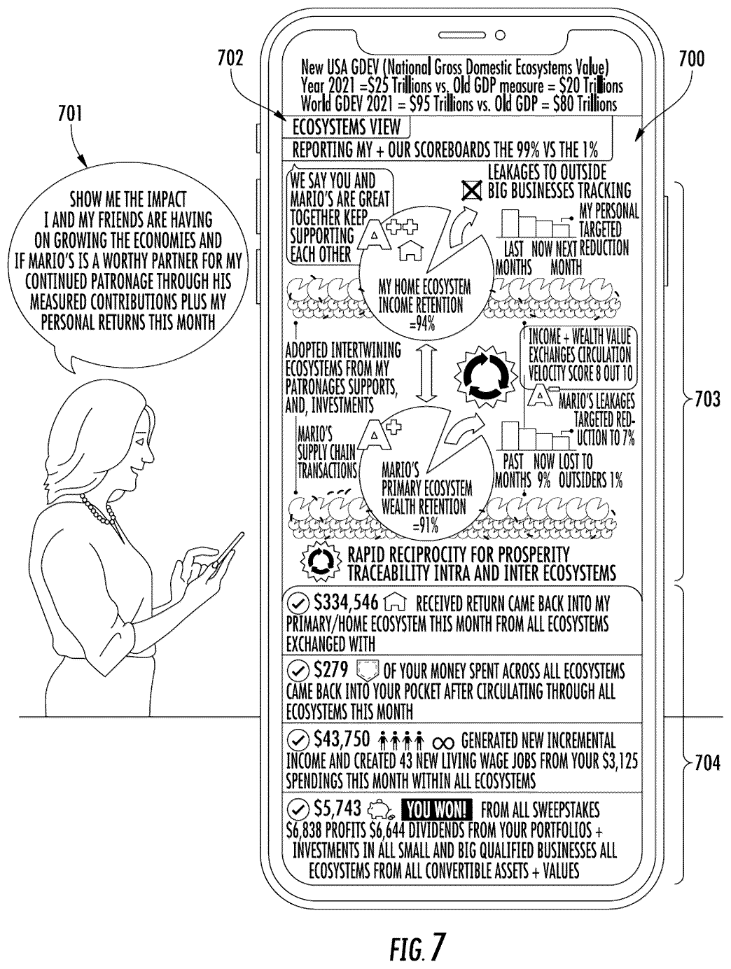

FIG. 7 illustrates the device of FIG. 3 displaying information that has been collected, aggregated, and synthesized by a commercial data platform to provide a user with visibility into the impact of their commercial decisions in accordance with specific embodiments of the present invention. In this case, display 700 has been set to display a specific metric in response to a voice command 701. In response to receiving this command, the CRM can analyze collected interaction data along with external content such as external market content and synthesize a score value for the desired metric. In the illustrated case, analyzing the interaction data can include determining a submarket ecosystem. The metric requested by the user in this case is an ecosystem impact metric which has produced ecosystems view 702. Ecosystems view 702 includes a metric presentation section 703. The metric presentation section 703 can include various metrics such as a submarket ecosystem performance indicator generated using external economic market content and interaction data stored by the CRM. Notably, the voice command 701 also includes a decision space in which to analyze the metric, because the user is interested in seeing the impact of selecting Mario as a commercial counterparty. As illustrated, Mario is a good counterparty to select for the ecosystem metric as Mario, and the people Mario enters into transactions with, etc. tend to utilize their money in a way that benefits the users home ecosystem. Display 700 also includes a notification section 704 which provides specific additional notifications regarding the currently displayed metric, progress regarding the gamified aspects of the CRM generally, and may also include, as illustrated, notifications regarding other metrics in a bid to entice the user to consider those also. As illustrated, the user is presented with a notification regarding the number of living wage jobs created by the commercial decisions made using the CRM, which might become a metric the user begins to track and consider when making future decisions.

In a specific embodiment of the invention, profile and interaction data as harvested by the commercial data platform, or derivatives thereof, can be made available externally.

The commercial data platform of the present invention, described in detail with reference to FIG. 1, allows for the storage of valuable interaction data in association with the multiple users of the platform. As explained before, the history of previous interactions can be used by the platform to provide a personalized experience for users who are connected through a voice call and are able to receive rich content that has been customized based on data of their previous interactions through the platform. However, significant information derived from the interaction data stored in the database could be made available to users or entities outside of the platform that may benefit from such information.

Considering an increasing number of users of the platform and the commensurate number of interactions between them, a large amount of interaction data will be stored in the database. Such interaction data will be useful not only for enriching the communication between two users communicating through the platform but also for characterizing businesses and customers based on their overall behavior as described by the interaction data associated with them. For example, the history of all interactions of the different customers at Mario's Pizza may indicate that a commonly repeated order among the customers is Mario Special Pepperoni Pizza, and that customers who order vegies pizza change to a different topping for their next order 99% of the time. This information may help a new customer at Mario's Pizza to decide what to order, by indicating that Special Pepperoni Pizza is preferred among the customers.

Nowadays, users obtain such kind of information mainly from crowd-sourced review platforms. Information from users' reviews can be practical and useful as long as it can be shown to be honest and genuine. However, polemical scenarios have turned out from the use of reviews-based platforms that have shown to be unfair and non-reliable. It is difficult to confirm the authenticity of a review provider. In the Mario's Pizza example before, Mario could ask his family and friends to support him by writing a nice review or giving five stars to his veggie's pizza, which they will probably do even if they believe such pizza topping is not good. Users reading such positives reviews may incorrectly conclude that veggie's pizza is a good choice. This situation is not likely to happen if users base their choices on actual interaction data that shows what the favorite pizza really is, based on the actual repeat orders as recorded by the platform. In the same way, if Jill's interactions with 15 different restaurants show that she is an A++ customer for all of them, it may alert a new restaurant where Jill is ordering for the first time that she is a potential valuable customer that should be treated with the level of respect owed to such a customer.

Based on the above examples, the intrinsic value of the interaction data stored over time by the commercial data platform of the present invention is clearly evidenced, and the ability to make the interaction data or derivatives thereof available outside of the platform becomes a desirable commercial asset. Interaction data or derivatives thereof can be surfaced to external agents, such as for example, a web browser, an external application proprietarily programmed to interoperate with the server, a third-party external application, an intelligent searching agent, a recommendation engine, or any other external agent that may benefit from such data.

When an independent user (not using the commercial data platform of the present invention) is in need of information about a certain business and uses a web browser or other external agent, such as the ones mentioned before, to obtain the required information, the external agents can communicate with a server of the commercial data platform of the present invention to obtain interaction data associated with the business the user is interested in or derivatives thereof. Such data could be surfaced to the end user as a result of their search in a customized manner and depending on a plurality of parameters, as will be explained below.

The data collected and surfaced can be interaction data or derivatives thereof, or profile data as sored by the platform. As explained before, interaction data can be any data relating to the interaction between dialers and receivers during a call. Derivatives of the interaction data, in turn, can be any data derived from such interaction data. For example, in a case where the receiver device is associated with a business profile on the server, the interaction data or derivatives thereof can include a number of incidences of repeat business conducted with the business profile using the system, a local economy impact score associated with the business profile, a rank of a business relationship associated with the business profile, etc. The interaction data or derivative thereof can be surfaced to rank business profiles relative to other business profiles on the server.

Derivatives of the interaction data can be collected directly from the database or generated dynamically by the server. Derivatives of the interaction data include any piece of data, factor, parameter, rating, statistic or general information that may be derived from “raw” interaction data as originally stored during voice calls. For example, the interaction data may consist of individual transactions performed by different customer at a certain business, and a derivative thereof can be a characterization or grade for the business as a whole based on the number of transactions or amount of money that users spend on them. As another example, interaction data may consist of the amount of money spent by a certain customer throughout a plurality of businesses, and a derivative thereof can be a grade for the customer based on the amount of money spent, for example, an A++ grade which is derived from a large amount of money spent. Another example of a derivative is the local economy benefit score, overall users' preferences, customer and business segmentation information, among others.

In specific embodiments of the invention, a server in the system, such as server 104 of FIG. 1, is programmed to collect a collection of interaction data or derivatives thereof from a database, such as database 105 of FIG. 1, and surface the collection of interaction data or derivatives thereof to an external agent.

The server can collect data from the database by using a data collection logic. A data collector application or any software for managing databases could be provided as part of the server for that purpose. The server can include a Database Management System (DBMS) or any software for managing databases for selecting the demanded data from the database. A query language, such as Structured Query Language (SQL), can be used to query the database.

As explained with reference to FIG. 1, data in database 105 can be stored in association with receiver and dialers identifiers. In this way, retrieval of the desired data can be performed by providing an identifier of the dialer or receiver for which information is required. The server can be programed to collect content data individually associated with a dialer or receiver identifier, such as a stored profile or storefront. The server can also be programed to collect interaction data associated with both a receiver and a dialer identifier. The server can also be programed to collect interaction data using either the receiver or the dialer identifier.

In specific embodiments of the invention in which the server is programmed to collect interaction data based on both the receiver and the dialer identifier, as explained with reference to FIG. 1, the resulting collection of interaction data will be exclusively related to the interaction between the particular receiver associated with the receiver identifier and the particular dialer associated with the dialer identifier. However, in specific embodiments in which the server is programmed to collect interaction data based only on one identifier, either the receiver or the dialer identifier, the server will most likely collect interaction data for more than one interaction and related to more than one interacting parties, because the database stores interaction data for a plurality of users that may be interrelated, such as a plurality of customers of a same restaurant. For example, if the server is collecting interaction data based only on a receiver identifier, the server can obtain from the database a plurality of interaction data sets associated with that receiver identifier and a plurality of different dialer identifiers. Referring back to the example of Jill and Mario, if the server uses both dialer (Jill) and receiver (Mario) identifiers for collecting interaction data, the resulting collection will be the interaction history between Jill and Mario. However, if the server uses exclusively Mario's identifier to search the database, all information indexed to Mario's identifier can be collected, and the resulting collected interaction data can include interaction data between Mario and all of his customers, including but not limited to previous interactions with Jill.

In the specific embodiments in which the server collects interaction data based on a single identifier, such as a receiver identifier, the server can be programmed to search the database and collect data associated with the particular identifier. For example, the server can be programmed to collect interaction data based on a receiver identifier by searching the database and aggregating all data indexed to the receiver identifier to a data structure for further processing.

Once the server has collected the data from the database, the collection of interaction data or derivatives thereof can be surfaced to an external agent in numerous ways. The collected data can be directly provided to the external agent. For example, the collected data can be provided in a data structure generated by the server through an external data channel between the server and the external agent. As another example, the collected data can be provided in a web readable format so that it can be directly displayed in a web-based platform by the external agent.

The collected data can be used by the server to generate a receiver page, such as a customized web page, to be surfaced to the external agent. Although the example of a receiver page is used herein as an example, the page can be for any user of the system and users can, at different times, be both receivers and dialers.

The receiver page can be generated by the server using a Content Management System (CMS). The CMS can be an application running directly on the server or accessed externally. The CMS can allow the generation and formatting of content (e.g., web content in the form of HTML and Javascript) based on the information that the server provides. In this way, a receiver page can be created and surfaced so that the content can be seen from external agent platforms (e.g., web browsers or proprietary applications). The CMS can populate the receiver page using the collection of interaction data or derivatives thereof from the database and produce a populated receiver page. The CMS can also populate the receiver page using receiver profile selections, so that only information that the receiver selects or authorizes is surfaced to the external agents. In specific embodiments of the invention, the receiver can create a layout of the page to be populated using the CMS, and the server will provide the collection of interaction data or derivatives thereof to the CMS as the content to be used to populate the receiver page. The populated receiver page can be surfaced to the external agents directly from the CMS.

The receiver page can be generated by the server, that can be programmed to dynamically generate HTML, JavaScript, PHP, or CSS code for dynamic generation of a web page from a structure in a database.

In specific embodiments of the invention, the external agent can use an API to request and obtain data directly from the server. In these embodiments, the external agent will have more flexibility for customizing the data and show the data embedded in their platforms or websites. By using an API, the external agents will be able to request and then display data from the server directly.

In specific embodiments of the invention, the server can be accessible over the Internet. For example, a static public IP address can be assigned to the server so that users can access it. In these embodiments, content generated by the server, such as receiver pages, will be available to the public and external agents such as search engines can find it. The server will then operate as a host for the receiver pages that can be accessed using the receiver identifier. The host server can be a different server than the server that stores and processes the interaction data for the users of the commercial data platform, to ensure the safety of the data processed by the commercial data platform. In embodiments in which the server dynamically generates web content, such web content can be submitted to search engines to be retrieved by the search engine's algorithm and displayed among the Search Engine Results Page (SERP) in response to a related user query.

In specific embodiments of the invention, the server can receive a receiver identifier from the external agent. A receiver, as used herewith, refers to the entity for which information is going to be sent to the external agent, such as a particular business. The server can receive from the external agent the exact receiver identifier to be used to collect information from the database, such as the receiver phone number, or a list of receiver identifiers that the external agent is interested in. In specific embodiments of the invention, the server does not receive a receiver identifier from the external agent, and directly surfaces content to the external agent at the server discretion. For example, the server can be programed to surface all profile content in the database in a web readable format so that users of the external agents can access it.

In specific embodiment of the invention, the server allows for a user-customizable externalization of the information. The server can receive receiver profile selections and limit the collection and surfacing to the external agents based on the receiver profile selections. The receiver profile selections are customizations that the receiver can provide for their profile. The receiver can decide what part of the interaction data stored in the database can be surfaced to external agents and how it is going to be surfaced. For example, the receiver may have an agreement on data privacy with customers, and only part of the interaction data stored in the database during the calls is allowed to be surfaced externally to the platform. In that case, the receiver can provide profile selections to the server and the server can collect and surface interaction data included in those selections, and the profile selections may act as a filter for the complete collection of interaction data associated with the receiver. In specific embodiments of the invention, the receiver profile selections can be static templates with standard information about the receiver, that will be dynamically enriched with the interaction data collected by the server.

In specific embodiments of the invention, the server can be programmed to receive an identifier of an external user interacting with the external agent. For example, the server can receive the phone number of the user. As another example, the server can receive an external user identifier such as an IP address, external username, or OAuth credential, that has been stored by the server and associated with an identifier of a user of the system. If the server determines that the external user identifier is associated with a profile in the commercial data platform, such as a dialer profile, the receiver page can be populated based on the user profile. Although the example of a dialer profile is used herein as an example, the profile can be for any user of the system and users can, at different times, be both receivers and dialers. The receiver page can be populated based on both the receiver profile selections and the external user profile. In this way, a customized page can be delivered to the external user that takes into consideration the preferences from both the external user and the receiver, or the preferences of the receiver with respect to that external user.

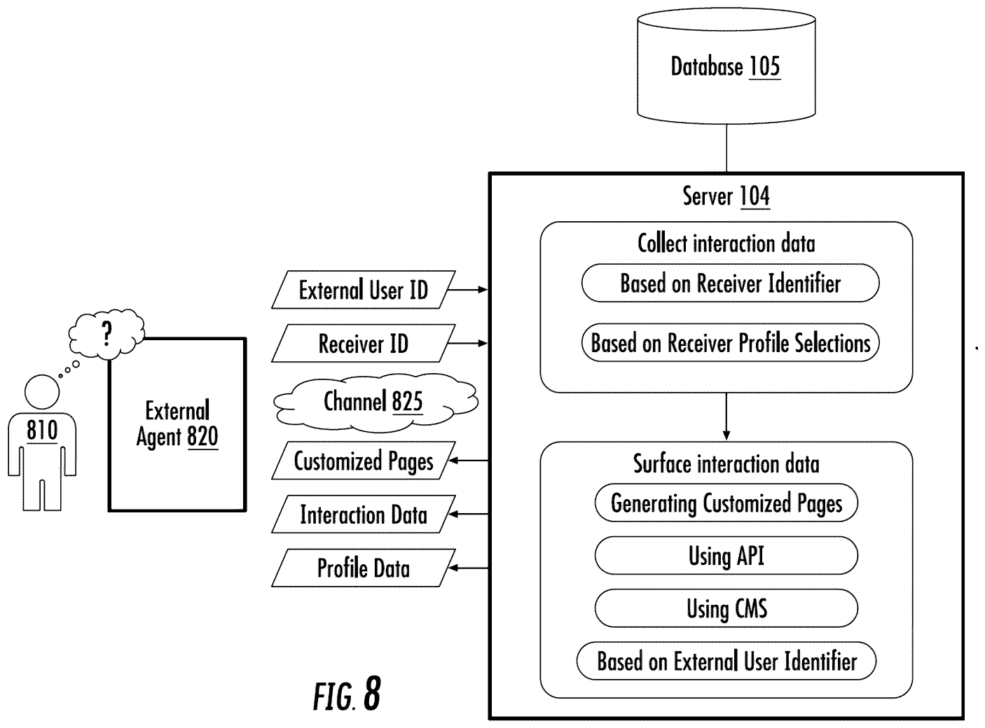

FIG. 8 illustrates a scenario including a server, such as server 104 of FIG. 1 that can access a database, such as database 105 of FIG. 1, and can communicate with an external agent 820 through channel 825. Profiles and interaction data associated with multiple dialers and receiver's identifier are stored in the database 105 as a result of the process described with reference to FIG. 1. In this scenario, server 104 can be programed to collect interaction data or derivatives thereof from the database 105 and surface it to the external agent 820 in the manners explained before.

The external agent 820 can be interconnected with server 104 through communication channel 825. Communication channel 825 can be a wired or wireless communication channel. Communication channel 825 can be a regular data channel between the server 104 and the external agent 820. Communication channel 825 can be an API that allows the external agent to access content from the server.

In the example of FIG. 8, an external user 810 is interacting with the external agent 820. For example, user 810 may be using a web browser to find good restaurants in the neighborhood. The external agent 820 can provide the server 104 with a receiver identifier, for example, a phone number of a restaurant that the user 810 has shown interest in. The external agent 820 can also provide the server 104 with the external user identifier, for example, a phone number of the user 810 interacting with the external agent 820.

Server 104 proceeds to collect interaction data or derivatives thereof from database 105 in association with the receiver identifier. Server 104 can determine if the receiver associated with the receiver identifier has provided receiver profile selections, and if so, limit the collection of interaction data to the receiver profile selections.

After the interaction data or derivatives thereof have been collected from the database, server 104 proceeds to surface the collection to the external agent. In order to surface the collection of data, the server places the collected data in a format suitable for the external agent to process it. For example, the server 104 can generate customized receiver pages to be sent to the external agent, that can be in a web readable format. The server can use a CMS to prepare content for visualization for the external agent. The server can use an API to provide data to the external agent that can be embedded in the external agent application.

If the server 104 determines that the external user identifier received from the external agent 820 is associated with a profile stored in the database, which means that the external user 810 is also a user of the commercial data platform of the preset invention, or is otherwise associated with the platform, the data to be surfaced to the external agent 820 can be further customized based on the information on the profile.

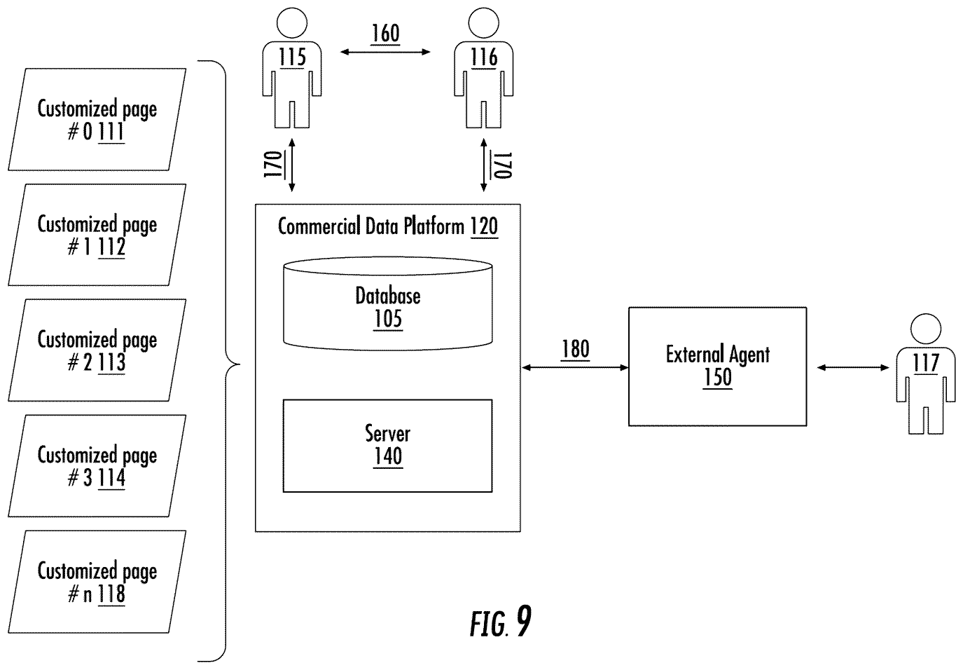

FIG. 9 illustrates an example of the overall operation logic of specific embodiments of the platform and use of customized pages. Customized pages 111, 112, 113, 114 and 118 refer to customized business and individual profiles number 0 to n that can include standard or unique storefronts, photos, videos, promotions, offers, information, data of the relationship value, scores, and any other information developed for the specific profiles, converted into customized pages including home pages, landing pages, splash pages, etc. The commercial data platform 120 can provide a plurality of customized pages depending on a plurality of factors. For example, customized page 111 can be a customized page for all new prospective customers, customized page 112 can be a customized page for customers grade A++, customized page 113 can be a customized page for customers grade B, customized page 114 can be a customized page for customers grade C, and customized page 118 can be a customized page for customers grade m. The customized pages are used internally by the platform and can also be published to the Internet so that they can be found by other platforms, search engines and social networks.

The commercial data platform 120 of the present invention allows for the processing of data from the database 105 through the use of AI, Big Data and Blockchain lookup and outputs the customized pages that can be preconfigured and interactive. The platform can match phone call parties and output the respective customized page to each party, who can view the pages in their screens, for example, via the interaction managers and display managers. The processing can be carried out by server 140 of the commercial data platform 120.

At the same time, external agents 150 can match up their customer values with access to the platform relationship value, or by using the metadata embedded in the published pages. The external agents 150 can return search results with ranking based on data from the platform, such as relationship value. Search engine results can be output via knowledge graphs, knowledge cards, organic link pages, via voice response or in social media search returns, using a relationship value ranking factor and criteria being incorporated into their search algorithms to serve up best matched rankings.

In the example of FIG. 9, user 115 can be a customer grade A++ of the platform accessing data stored in the database 105 during a voice call with another platform user 116 over a voice channel 160, or directly through a data channel 170 without establishing any voice call. The platform will provide user 115 with customized page 111, that is a customized page for customers grade A++. The customized page can be further configured considering the specific user 115 profile and other dynamic information in the platform, for example, the interaction history between user 115 and user 116.

On the other side, user 117 can be a platform user or a non-platform user using an external agent, such as a search engine or social media application. User 117 can be able to find customized pages that have been made available to the external agents by the platform and benefit from the information provided. The external agent will be able to communicate with the platform over channel 180 that can be a dedicated data channel. If user 117 turns out to be a platform user, the customized page can be further configured with profile information of user 117 already stored by the platform, even though user 117 is not accessing the data directly through the platform. Regardless of whether the user is a platform user or not, the external agents will be able to obtain data from the platform and combine it with their own data, so that the final user receives customized content. In this way, the mined data from the database and related information can be made available via the pages generated by the platform to users, whether they are directly using the platform or accessing the data through an external agent communicatively connected to the platform.

The rankings and grades described above herein can be awarded or otherwise updated in various ways to create a virtuous cycle for both increasing uptake of users for the platform, increasing engagement by existing users of the commercial data platform, and incentivizing usages of the commercial data platform that benefit the users themselves and the broader economy. As in certain embodiments of the present invention users are both consumers and producers of content in the form of both social interaction data and commercial interaction data, a network topology of the commercial data platform will be able to illustrate the circulating beneficial flow of social content and streams of commerce through the commercial data platform. This data can then be mined and utilized to reward users with increased visibility and/or prestige. These users can be rewarded for taking actions which increase the velocity of content moving through the commercial data platform. This creates a virtuous cycle in that users that increase the velocity of content through the platform are rewarded with additional visibility which compounds their impact. Additionally, this type of ranking provides highly useful data to users of the commercial data platform because it is difficult to spoof. While an unscrupulous party may provide themselves with a bogus rating on a standard customer survey website, ranking people based on their impact on the overall velocity of interaction data both directly with counterparties and through distal nodes in the network topology is difficult to spoof. The resulting system therefore benefits consumers on the commercial data platform by providing them with accurate information for guiding their consumption decisions, benefits producers that are behaving in accordance with the overall ethos of the administrators of the commercial data platform, and benefits the commercial data platform by increasing utilization of the platform itself and by assuring that the ethos of the commercial data platform and benefits to the wider social fabric and economy are enhanced.

Algorithms such as PageRank, that ranked a webpage based on the number of links to that page, provide a ranking depending on facts that are directly related to the object being ranked, such as the number of links, number of “likes”, number of “views”, etc. That kind of ranking can be easier to spoof in that it depends on a measurable quality that can be increased by users that are not verified users. Specific embodiments of the present invention, however, provide a ranking strategy that considers not only direct and real interactions between two parties, but also the overall flow of the content shared during that interaction throughout the network. For example, a business can be ranked not only because it has a large number of clients who spend a certain amount of money on the business, but also because the business itself otherwise injects money in a network that can benefit its clients as well.

In specific embodiments of the invention, a server, such as server 104 of FIG. 1, can be programmed to update a ranking associated with the users of the platform. For example, the ranking can be associated with the receivers (or receiver identifiers) and the dialers (or dialer identifiers) described before in this disclosure. The ranking can be associated with a profile of the users, such as the receiver profiles and the dialers profiles described before in this disclosure. The ranking can be associated with specific aspects of the user's profiles, such as the profile selections described before in this disclosure. In specific embodiments of the invention, the ranking can be based on grades that the platform affords to each user based on their behavior and interactions within the platform. An example of such ranking and grades was presented, for example, in profiles 305 and 306 illustrated in FIG. 3. The rankings can be updated in various ways and based on a plurality of factors.

In specific embodiments of the invention, the rankings can be updated based on a content quality metric. The content quality metric can be associated with the interaction data stored by the system. The interaction data can be any data relating to the interactions between users (such as dialers and receivers), as explained before in this disclosure. The content quality metric can be indicative of the quality of such interaction data, or at least of an aspect of it. The content quality metric can be related to different aspects of the interactions between dialers and receivers. For example, the content quality metric can be determined based on the amount of money, or any specific currency used by the commercial data platform, that is exchanged during an interaction, and/or over time in a given dialer/receiver relationship. The content quality metric can be also determined based on the data exchanged among the interactions. For example, the quality, uniqueness and reliability of the data can be considered. The content quality metric can be determined by examining the source of the data being shared in a given interaction.

In specific embodiments of the invention, rankings can be provided and badges awarded in a way that guides a relationship economy. In addition to increasing the flow of value within a community and preventing the accumulation of wealth in silos that do not contribute to the overall health of the economy as described above, the platform can incentivize content producers and vendors of goods and services using the platform to differentiate based on creativity and added experiential production instead of price. In these embodiments, the content quality metric can be generated based on an evaluation of the distinctiveness of the content created and shared using the platform, or the distinctiveness of the good or service provided using the platform. In the case of digital content, a relative difference of the digital encoding of the content compared to the stored interaction content can be generated using an adversarial neural network that is continuously trained to generate content that is different than the content stored in the commercial data platform and a neural network that is trained to rate the content generated by the adversarial neural network as distinct and the content stored in commercial data platform as not distinct. In the context of physical goods and services, an evaluation of the distinctiveness of the goods and services can be conducted by a natural language processing system operating on reviews or feedback provided in exchange for the goods and services or from marketing materials (e.g., menus or services lists) shared, posted, or otherwise accessible to the commercial data platform (e.g., the sale of a pizza which is listed as “Pepperoni Pizza” on a first menu is associated with a lower content quality metric than the content quality metric associated with the sale of a pizza which is listed as “Mario's Pepperoni Surprise Pizza” on another menu). By rewarding vendors, and users generally, for sharing original content, selling unique products, and providing unique experiences, the economy that is within the ambit of the commercial data platform will be democratized and benefit small business and the diffusion of resources while at the same time moving the focus of competition away from only driving the reduction of price to also driving an increased array of human experiences and relationships.

In specific embodiments of the invention, a database of the system, for example database 105 of FIG. 1 or other database, stores the content quality metric. The content quality metric can be stored in association with the interaction data stored by the system and/or with the individual user identifiers or profiles. As used in this disclosure, the content quality metric can be “stored” in the database either explicitly or implicitly. In other words, the content quality metric can be explicitly stored as a value in a data structure that the system can have access to, or implicitly in that the content quality metric can be derived from data stored in the database and the relationship therebetween.

The content quality metric can be dynamically updated by the system. Multiple factors can be considered in determining the content quality metric. For the purposes of this disclosure, any factor that can be used to evaluate the quality of the interactions can be used to determine the content quality metric. The quality of an interaction can also be system-specific as what is valuable for a system may not be valuable for another (e.g., payment platforms can consider amount of currency as their measure of content quality while social media platforms can consider the type, amount or quality of data being shared). The system can analyze the interaction data being stored and increase or decrease the content quality metric based on such interaction data. For example, the amount of a currency exchanged during an interaction can be analyzed and the content quality metric updated accordingly. Similarly, the amount and/or quality of the data exchanged can be analyzed and the content quality metric updated accordingly. The content quality metric can also be updated based on other factors such as a social kindness factor. For example, machine analysis could be used to measure customer satisfaction in a given call (e.g., tone of voice systems used to detect unhappy customers in a call center). The content quality metric can also be updated based on a recurrency and/or loyalty factor, in that the number of repeat customers, repeat orders, repeat interactions, etc. can be used to determine the quality of a given relationship or overall behavior of individual users (customers/business and/or dialers/receivers). The content quality metric can also be updated based on frequency of interactions. For example, users who are active within the platform can be afforded a higher content quality metric than a user who do not use the platform often.

The content quality metric can be velocity-rewarded in that it can decrease over time such that a velocity of the interaction data impacts the ranking associated with the users of the platform. For example, the content quality metric can decrease over time and increase based on the recurrent use of the platform to share content, for example money or data. As an example, if the content being shared is currency, the content quality metric can increase depending on the amount of currency spent by a given user, but also depending on the frequency that the given user spends or receives currency through the platform. If the user spends a large amount on a one-time interaction, the content quality metric can increase considerably based on the large amount spent. However, if the user does not continue to interact via the platform, the content quality metric can decrease over time regardless of the value spent on the one-time interaction. The content quality metric can also be influenced by the speed of further sharing of the content. For example, if a user spends a single unit of currency issued by the commercial data platform (e.g., a gold coin), the content quality metric of that interaction can be set to a specific level (e.g., 100). However, if the recipient of that coin then quickly spends currency issued by the commercial data platform (e.g., the “same” gold coin), then the content quality metric associated with the original transfer of content can be increased (e.g., 100 to 110 if the recipient spends the currency within one day and 100 to 150 if the recipient spends the currency within one hour). The benefit of the continued rapid sharing of the content can continue to ripple back to the original sharing event. In specific embodiments, the level of benefit may be reduced with the distance through the topology from the original users. However, if the content is fully replicable (e.g., a custom generated emoji as opposed to a unit of currency), the level of benefit may carry back to the original sharing event regardless of the specific branch that the content travels our from that original event. In such a case, the content quality metric may increase exponentially for a piece of content that virally spreads through the platform even if the original author only shared it with one recipient.

In specific embodiments of the invention, the content quality metric can be recharged when the content previously exchanged is shared. For example, if the currency spent by the one-time interaction mentioned before continues to circulate within the platform among other users, then the content quality metric associated to that first one-time interaction can be restored to a base value, based on its impact in the overall ecosystem. In this way, when there is a stored content quality metric associated to the interaction data of a given interaction between a dialer identifier and a receiver identifier that decreased over time (due to inactivity, for example), the stored content quality metric can be restored to a base value when the interaction data is stored in association with a subsequent receiver identifier and the previous receiver identifier.

In this way, and as explained before, the ranking afforded by the commercial data platform is not based only on measurable assets shared in each individual interaction, but how those assets continue to enrich the platform and benefit more users of it. This can provide businesses with incentives in that a business can be more likely to share earned resources through the platform so that its ranking increases. This can also provide business with incentives in that a customer can be more likely to spend their resources on a business well ranked so that they ultimately benefit from it too.

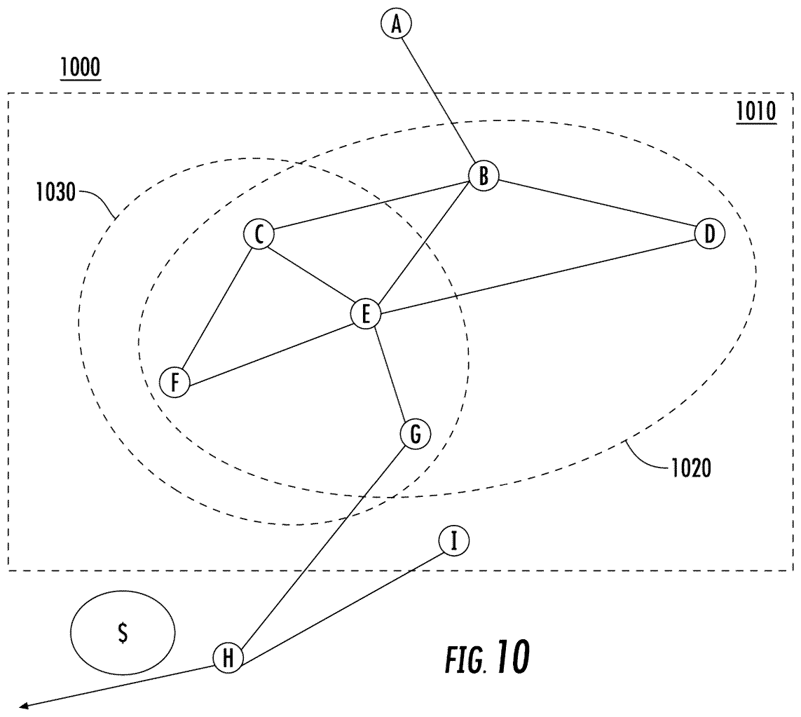

In specific embodiments of the invention, the rankings can be updated based on a network topology. The network topology can be a topology of the network formed by the users of the platform and the interactions between them. FIG. 10 illustrates an example of a network topology 1000 in accordance with specific embodiments of the present invention. The users of the commercial data platform (or their respective user identifier) can be associated with nodes in the network topology and be connected by edges in the network topology. In the example of FIG. 10, the network topology includes nodes A, B, C, D, E, F, G, and H, which can be associated with eight different users of the system, either dialers or receivers. The users can be represented in the topology by their respective user identifier (such as dialer identifier and/or receiver identifier) in that A, B, C, D, E F, G, and H can be for example phone numbers or other ID for users associated to the specific node in the topology. The interactions between users can be associated with the edges in the network topology. In this way, an interaction between user A and user B can be associated with the edge AB. The network topology illustrated in FIG. 10 is for explicative purposes only. The specific network topology and number of nodes and edges will depend on the actual implementation of the system, and the number and distribution of users therein.

In specific embodiments of the invention, a database of the system, for example database 105 of FIG. 1 or other database, stores the network topology. As used in this disclosure, the network topology can be “stored” in the database either explicitly or implicitly. In other words, the network topology can be explicitly stored in a data structure that the system can have access to, or implicitly in that the network topology can be derived from data stored in the database and the relationship therebetween.

The network topology can be dynamically generated based on the data stored in the database. For example, the network topology can be stored in a data structure that the system can process to identify the nodes and connections between nodes of the network. The network topology can be stored in the form of a diagram or map that the system can read. The network topology can be stored in a topology database or set of relational databases that keep track of the current state of the network and connections between nodes. The network topology could be built and updated progressively as new users join the platform, and/or new interactions occur.

A server, such as server 104 of FIG. 1, could operate in combination with the database to either access the network topology already stored therein or to access data to dynamically generate the network topology. For example, the server could query the database for data related to a specific user (such as a dialer) as explained before in this disclosure. The database could provide an association of users (such as receivers) with which the dialer has had interactions, so that the server can dynamically build the topology for the specific node associated to the dialer identifier. The process could go as far in the topology as needed, in that indirect interactions between users can also be mapped by further querying the database for data related to the association of receivers provided for the given dialer.

In specific embodiments of the invention, the rankings can be updated based on an edge strength metric. The edge strength metric can be indicative of the strength of the edge in that it can be specific to the amount of interaction in a node-to-node or user-to-user relationship. The edges in the topology can be based on prior interactions between the nodes of the topology and increase in strength as the users exchange more content. In specific embodiments of the invention, the edge strength metric can be, or can be derived from, the confidence levels described before in this disclosure. As described, the confidence level could rise based on how much interaction had taken place using the platform between users, and whether those interactions were positive or not. In this way, the edge strength metric can be a confidence level for two users, such as a dialer identifier stored in association with a receiver identifier. In specific embodiments of the invention, all the edges in the topology can be associated with a confidence level of at least one and increase over time as more interaction takes place.

In specific embodiments of the invention, a database of the system, for example database 105 of FIG. 1 or other database, stores the edge strength metric. The edge strength metric can be stored in association with the nodes of the network topology as stored by the system. As used in this disclosure, the edge strength metric can be “stored” in the database either explicitly or implicitly. In other words, the edge strength metric can be explicitly stored as a value in a data structure that the system can have access to, or implicitly in that the edge strength metric can be derived from data stored in the database and the relationship therebetween.

The edge strength metric can be determined and updated by the system based on various factors. As explained, the edge strength metric can be based on the amount of prior interaction data associated with the nodes defining the edge (nodes defining an edge can be associated with a dialer identifier and a receiver identifier, two users, a customer and business, two customers, two business, etc.). The edge strength metric can also be determined based on trust, recurrency, and other factors.

In specific embodiments of the invention, the edge strength metric can also be based on a geographical location, such as a geographical location associated with the nodes. In this way, physical proximity between the users can be considered to afford an edge strength metric. This can contribute to a measure of the local impact of the interactions within the platform as a strong link between two users on the same geographical location may indicate that a customer is supporting a local business contributing to the development of the local economy.

The rankings associated to the users of the platform can therefore be dynamic rankings updated based on different metrics and factors, such as the content quality metric, the network topology and the edge strength metric described before. In this way, the rankings can be updated considering actual interactions and verified relationships between users, and the actual content shared during those interactions and its flow throughout the network. Specific embodiments of the invention consider not only the interactions themselves between the users to update the rankings, but also the content exchanged, how that content flows through the platform and/or outside the platform, and the relationship between the users, either direct or indirect, as defined by the network topology.

In specific embodiments of the invention, the ranking associated to a given user can be updated based on a proximity of that user to other users according to the network topology. In this way, the ranking can be updated considering how many links or edges apart nodes are in the topology. The degree of proximity can be determined based on how far apart two nodes are in the topology and the number of nodes between them. Two nodes in the topology can be connected directly, which represents a direct interaction between the nodes, represented by a single edge in the topology. Two nodes in the topology can be connected indirectly, which represents an indirect interaction between the nodes, represented by two or more edges in the topology, and including one or more intermediary nodes. Nodes can be connected indirectly when content exchanged in a first interaction between to nodes passes on to a third node in a subsequent interaction. This can increase the ranking of both the source node in that its content is flowing further through the network, and the intermediate node in that it is not only consuming but also sharing content for the network and therefore contributing to the overall flow of interactions in the network.

In specific embodiments of the invention, the ranking and badges associated with a user of the platform can be based on his/her professional activities. As mentioned, the platform of specific embodiments of the invention can be used in professional settings such as work from home and other work collaborations. In such embodiments, the platform can be used to aggregate professional information about the users of the platform from a work collaboration involving a voice call. Professional information can include a user's professional ranking and badging, which can be based on, for example, how well that person works with others, how responsive he/she is, how much time he/she has spent working in a specific field, how many achievement awards he/she has received, etc. In specific embodiments of the invention, during a voice collaboration, the platform can understand the voice content of the collaboration and based on that understanding, surface to the dialer device and/or one or more receiver devices the ranking and badges associated with, for example, the dial device user for displaying.

With reference to the example of FIG. 10, user E is directly connected to B, C, D, F and G and indirectly connected to users A and H, via users B and G, respectively. In this example, node E can be a customer (or dialer), and nodes B, C, D, F and G can all be businesses or other “receivers” with which customer E has a direct relationship with, such as restaurants, hotels, gas stations, a friend that is also user of the platform, etc. The reference as dialers and receivers is not fixed and can be interchanged depending on who starts an interaction, a same node can be both dialer and receiver at different times. In this example, node E can be a customer at a hotel B and restaurant C and spend money thereon. Hotel B, in turn, could have a partnership with restaurant C, in that per each night at hotel B customers area forded a cash back to spend at C. Customer B therefore can be more interested in staying at hotel B than any other hotel that does not give them any return of their investment.

The ranking associated to a given user (dialer/receiver) can be updated based on the proximity of the counterparty user (receiver/dialer) to a group of users directly linked to the given user. For example, user E is directly connected to user D. User D is in turn directly connected to user B, which is part of the group of users directly connected to user E. In this case, interactions between user E and D can increase the ranking of user E more than interactions between users E and G, because user G is not connected to any other user that is part of a group where user E has a direct connection with. User D, in turn, is closer (in this example directly connected) to a group of users to which user E is also connected to in the topology. This can mean that the flow of content (for example money) from the ED interactions circulates within a given ecosystem in the platform that can have an effect on user B and back on user E. This can be particularly relevant for analyzing how customers and business spend their resources and how it affects their local economy or individual interests. A ranking based on such proximity concerns can be beneficial to give users an overview of where, how and with whom to invest their resources depending on how they which that investment to unfold.

The ranking associated to a given user (dialer/receiver) can be updated based on the proximity of the counterparty user (receiver/dialer) to a group of users that share a characteristic with the given user. For example, the characteristic can be a geographical location, a type of user, a type of business, a degree of proximity, a common interest, a common node in the topology, etc. For example, a user (or user identifier) can be in a group of users (or user identifiers) in the topology. The group of users (or user identifiers) can be grouped based on the shared characteristic described above, such as a geographical location. The updating of the ranking associated with the user (or user identifier) can be based on a proximity of the counterparty user (or user identifier) to the group of users (or user identifiers) in the topology.

The groups of nodes can be created dynamically based on interactions. For example, edges of the topology can be the records of interactions between nodes, and a group can be centered on a node and include everyone that has a proximity of a certain degree (for example, less than 4 edges apart from that node). In this way, groups can be created dynamically as more interaction occurs within the network. Since the groups do not necessarily relate to a physical proximity of the nodes, the groups can be virtual communities that are dynamically formed or updated even when the “center” node has not had any new direct interaction within the network. The content quality metrics and network topology can impact rankings based on the strength and connection of specific the edges, but also based on the location of nodes within different groups.

With reference back to the example in FIG. 10, nodes C, E, F, and G are grouped in a group 1030. In specific embodiments of the invention, as the rank can be based on both content quality and network topology, sharing content (e.g., money) with someone that keeps the content in the local ecosystem can improve your rank more. The nodes included in group 1030 can share a common characteristic such as geographical location. The geographical location can be based on a user's address or “home” location established in their profiles, or on a current location such as by the use of a GPS system, so that the users can enjoy the benefits of the system either in their “home” ecosystem or in any local ecosystem where they are currently located. In this example, interactions between user E and G can increase the ranking of user E more than interactions between users E and D, because user G is part of the same group 1030 while user D is not. In the same way, interactions between user E and B can increase the ranking of user E more than interactions between users E and D, because user B is otherwise directly connected to the same group 1030 via node C, while user D is otherwise one node apart from group 1030.

The simplified example of FIG. 10 illustrates nodes within the same group that are connected to each other, however, this is not a limitation of the invention as users that have not had any previous interactions (and therefore would have no edge between them in the topology) can still share a common characteristic such as the same geographical location. Furthermore, the examples given herein as to what can increase or decrease a ranking are illustrative of how the combination of a network topology with the different metrics disclosed herein can be used to update the rankings. However, those examples are non-limiting and what can increase the ranking in one example (e.g., same geographical location to boost local economy) can decrease it in others (e.g., if it is desired to incentivize users to interact with users from a different location). The constraints of each particular system can be different and therefore the weights of what increases/decreases a ranking can vary. In some embodiments, the fact that two nodes belong to the same group can increase the ranking of the nodes considerably. In other embodiments, the quantity of interactions between nodes can increase your ranking more regardless of the group that the nodes belong to. In other embodiments, the quality of interactions between nodes can increase your ranking more regardless of the group that the nodes belong to and the quantity of interactions. These and more options are possible and customizable by programing the server to update the ranking accordingly.

The users (or user identifiers) can also be grouped by sharing a degree of proximity to a given user (or user identifier) in the topology. The updating of the ranking associated with the given user (or user identifier) can be based on a proximity of the counterparty user identifier to the group of identifiers in the topology. For example, FIG. 10 illustrates a group 1020 that includes nodes directly connected to node E, this is, nodes with a first degree of proximity to node E. Nodes A and H, for example, are nodes with a second degree of proximity to node E, in that they are indirectly connected via an intermediate node. Node I is a node with a third degree of proximity to node E, in that it is indirectly connected via two intermediate nodes.

In specific embodiments of the invention, the network topology includes one or more nodes for external users (or user identifiers), that are not users of the platform yet. In the example of FIG. 10, users within box 1010 can be users of the platform, while users A and H can be external users. As illustrated, the external users, such as A and H, can be connected to users of the platform and interact with them, as indicated by edges HG, HI and AB. In this way, external users can be either consumers or producers of content for the platform and can likewise have an impact on the overall flux of content through the different nodes and groups in the network topology.

The external user can be connected to the users of the platform by an edge with an associated edge strength metric in the same way as was described above for other nodes in the topology. In this way, the updating of the ranking can be based on the edge strength metric associated with the edge to the external user (or user identifier). For example, the amount of interaction between a user of the platform, such as user G, with an external user, such as user H, can be considered in determining a raking for user G. In specific embodiments of the invention, a ranking of a user that changes content with an external user can be higher if the external user otherwise exchanges content with the platform. For example, a ranking for user G can be higher because external user H interacts with user I, which is also a user of the platform. This can be beneficial in that content, such as currency that is spent outside of the platform is likely to return to the original ecosystem. This can also be beneficial in that user H can be a potential user of the platform as it learns the incentives of its direct interaction with more than one user therein.

In specific embodiments of the invention, the interaction data records payment of currency. The currency can be any currency, including digital currency such as virtual currency and cryptocurrency. In specific embodiments of the invention, the currency is issued by a server of the commercial data platform of the present invention, such as server 104 of FIG. 1 or other server. The currency can be issued in the name of the administrator of the commercial data platform, merchants that register to issue currency via the platform, or by individual users. The server can store one or more currency balances for the users (or user identifiers), including any external user of the platform. The currency can be offered as rewards for users of the systems during the course of their interactions as an incentive to utilize the commercial data platform, issued in exchange for funds transferred to the administrator of the platform, or rewarded by merchants on the commercial data platform as a way to build stronger ties with specific customers. In this way, a ranking can be updated based on an edge strength metric with the external users and with the amount of currency (or other content) as recorded by the system. Alternatively, the server can be programmed to update a distributed ledger for the currency when processing transactions of the currency. The distributed ledger could use any form of DLT including Blockchain and Holochain. The distributed ledger can include a cryptographic hash of the external user (or external user identifier) and can track the amount of currency held by users of the commercial data platform as well as that of external users. The transfer of funds between users can be controlled using the distributed ledger and a set of private keys held by the parties to the transaction. This distributed ledger could be mined to provide information for the network topology mentioned above regardless of whether the participants to the transactions for the currency were registered members of the commercial data platform. While finer grained information could be obtained if the users were registered members, a distributed ledger could expand the topology out to mine information about the broader economy. As such, the currency (or currencies) can be used to pull more data into the commercial data platform thereby extending the visibility and reach of the search algorithms and other agents that utilize the data harvested by the platform to include transactions beyond the horizon set by the registered users of the commercial data platform.

In specific embodiments of the invention the rankings can be generated using the metrics for a search algorithm (i.e., the users will be provided with a ranking or various rankings that will be used to sort the users in response to various search queries). The search algorithm can utilize the information from the content quality metrics and the network topology to provide search results for various queries such as, “which vendor of good Y benefits my local economy the most” or “which vendor of good X has the most repeat customers for service Y.” As the network topology monitors the strength of connections between specific users of the platform various proprietary and/or open-source search algorithms will have access to the underlying fundamental economic data that can provide accurate rankings for a myriad of such targeted search queries. Depending upon the level of transparency the additional contingencies for these search queries can be built into the ranking system and unseen to the user (e.g., a proprietary search algorithm for “pizza near me” favors pizza places that benefit the local economy), or they can be provided as options for the users of the system (e.g., a search wizard for “pizza near me” allows a user to check boxes for other factors they are interested in such as only showing results for pizza vendors that benefit the local economy above some preset degree).

The rankings associated with the users of the platform can be used in different ways. For example, the rankings can be used to rank the users (or user identifiers) for an internal searching agent. In this way, the ranking can be used to provide a rank that is internal to the commercial data platform and that can be used for example by proprietary applications to surface content to the users. The rankings can also be surfaced to external searching agents. The surfacing to the external searching agent can be performed as described before in this disclosure for the surfacing of interaction data and derivatives thereof. The surfacing can be performed using an external data channel and without using any voice channel.

By surfacing the rankings to searching agents, users of the searching agent can be provided with information about the users of the platform that includes the rankings associated with them. For example, if a user is using a searching agent to search for a business that is part of the platform, the business will be ranked based on the factors described above (such as content quality metrics, network topology, edge strength metric, etc.) In this way, the business can be ranked based on their own use of the platform not only as businesses but also as consumers. The rankings can then provide information that can help the user make a decision that considers not only the direct counterparty in a given interaction but also their connection with other nodes in the network topology and the complete flow of content between them.

The external agent can be the external agent described before in this disclosure and include, for example, a web browser, an external application proprietarily programmed to interoperate with the server, a third-party external application, an intelligent searching agent, a recommendation engine, etc. A server of the system, such as server 104 of FIG. 1 or other server, can be programmed to generate a user's page using a content management system (CMS), as explained before in this disclosure. The CMS can populate the user page to produce a populated user page using the ranking associated with the user (or user identifier). The CMS can populate the user page with the ranking in the form of a badge on the user page.

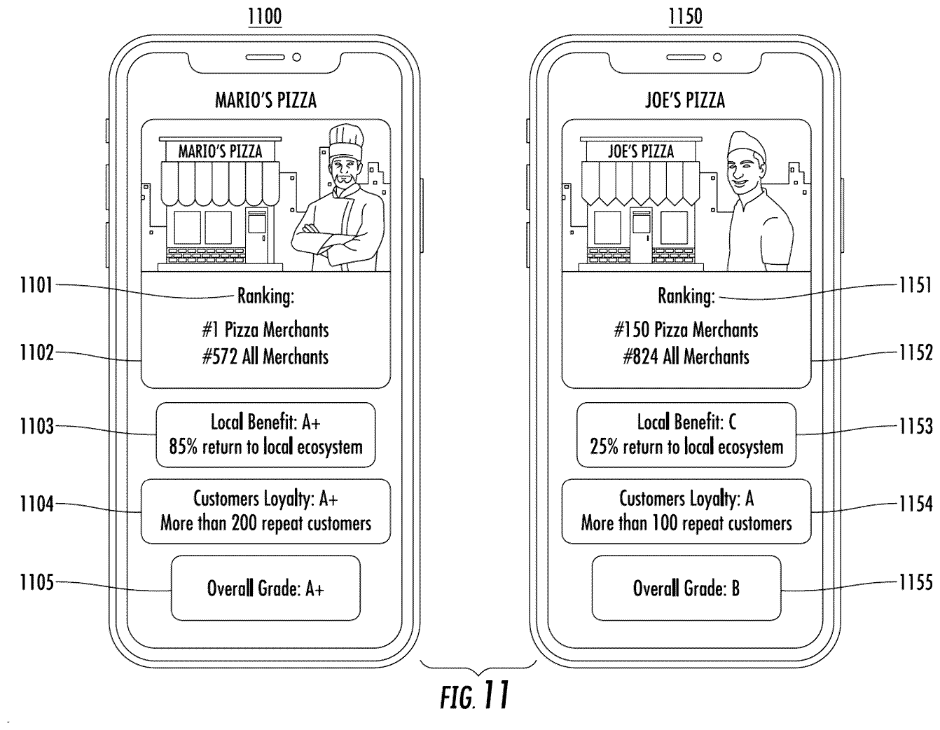

FIG. 11 illustrates two examples of user pages showing profiles 1100 and 1150 that include the rankings 1101 and 1151, which can be updated as described before in this disclosure. The rankings are provided in the form of badges 1102 and 1152. In the example of FIG. 11, the badges 1102 and 1152 each include two different rankings, one among pizza merchants and one among all merchants in the platform. This is an example of the different groups that can be defined within the network topology based on a shared characteristic. In this example, all pizza merchants can be part of a same group in the topology, and the ranking can be updated based on the edges and interactions among such group. In this way, a user using the platform to obtain information such as the rankings illustrated in FIG. 11 can be provided with the option of filtering specific characteristics and therefore defining groups in the topology to obtain a dedicated ranking specific to their needs.

The profiles 1100 and 1150 can be profiles surfaced to an external agent when a user a searching for information in the platform. Profile 1100 is a Mario's Pizza profile and profile 1150 is a Joe's Pizza profile. Those profiles can be returned as a result of a search for a user that is interested in a Pizza place nearby. Those two examples are provided for explanatory purposes. The real number of profiles returned for a given search can be more than two. From the list of profiles returned, and the information contained therein, for example in badges 1102 and 1152, the user can make a reasonable decision by inspecting the rankings 1101 and 1151 and understanding that Mario is overall a better option than Joe. Because the ranking is determined based on factors such as the content quality metric and the network topology, a simple inspection to the number can give the user a prompt conclusion as to the impact of interacting with one or the other. Because the user searching for information can be a user of the platform and therefor be associated with a node in the network topology as well, the ranking provided may be personalized by considering the user's own interactions, content quality metric associated with user, edges in the network topology associated with the user, etc.

The examples of FIG. 11 illustrate additional information that can also be provided in a user profile, for example in the form of badges, so that the user can better understand the behavior of the business searched in regard to specific aspects. Badges 1103 and 1153 include a local benefit grade. This grade can be based, for example, on an amount of money or resources that return to the local ecosystem once injected on that business. Badges 1104 and 1154 include a customer loyalty grade, which can be based on a number of repeat customers that a given business possess, which can be a direct indication of the customer's satisfaction with the business. Badges 1105 and 1155 include an overall grade for the business, which can be based on the previous aspects as set in the other badges. These and other data can be surfaced to external agents from the data stored in the commercial data platform of the present invention.

In specific embodiments of the invention, the system is programmed to obtain voice samples from the voice call between the dialer device and the receiver device, process the voice samples to obtain a search cue, and using the search cue, obtain one or more interaction data from the database, analyze the one or more interaction data to obtain a response data, and surface the response data to the dialer device and/or the receiver device. In specific embodiments of the invention, the system can surface the response data using voice communication. In specific embodiments of the invention, the system can surface the response data using a format such that the response data is displayable on the dialer device or the receiver device. In specific embodiments of the invention, the system can surface response data before a voice call, during a voice call, or after a voice call.

As disclosed above, the system of specific embodiments of the invention can harvest, and store, in the database of the platform, a wide variety of interaction data or derivatives thereof in association with the dialer identifier and/or receiver identifier. The interaction data or derivatives thereof can include not only commercial and social information as disclosed above, but also professional information as the system can also be used for remote work and other work collaborations such as audio and/or video conference calls or meetings regarding work related matters. Thus, the interaction data or derivatives thereof can include not only dialer profile, receiver profile, and business profile, as disclosed above, but also work profile and work-related ranking and badges. For example, work profile can include a person's resume, how long the person has been affiliated with his/her current occupation or entity, how long he/she has been working on a project or in a specific field, etc. Badges can include a score generated to reflect how well a person works with others, how responsive they are, how many professional awards they received, how much business they brought to the work entity, etc. For example, if the dialer/receiver identifier is associated a person who is an attorney, badges can include a score generated to reflect how many hours he/she billed thus far this year or over past several years, how many cases he/she won at trial, how many new clients he/she brought to his/her law firm. As another example, if dialer/receiver identifier is associated a person who is an airline pilot, badges can include a score generated to reflect how many miles he/she have flown thus far, how many flight errors he/she committed over the last ten years, etc.

In specific embodiments of the invention, the system can surface a response data to one of a dialer device and a receiver device based on the context and content of the speech on a voice call initiated between the dialer device and the receiver device. The system can obtain a voice sample from the voice call, process the voice sample to obtain a search cue, obtain one or more interaction data from the system's database using the search cue, obtain a response data from the one or more interaction data, and surface the response data to one of the dialer device and the receiver device. The system can surface the response data during the voice call or after the voice call. A response data can be an interaction data obtained from the database. A response data can be derived from the one or more interaction data so obtained.

Depending upon the context and content of the speech on the voice call, the response data can include commercial, social, and/or professional information. For example, when Jill, a user of the dialer device, initiates a voice call to Mario's Pizza, the user of the receiver device, to order a pizza, and during the call, Jill asks, “What sides do you have?”, a response data can be a list of sides Jill previously ordered from Mario's Pizza or a menu of the sides Mario's Pizza offers. As another example, if Mario's Pizza asks Jill, “How many times have you ordered pizzas from us?”, the response data can be the number of times Jill ordered pizzas from Mario's Pizza. As yet another example, if Jill is a sales agent, who works from home, places a voice call to Mark, her supervisor, who is the user of the receiver device, and Mark says, “Let's discuss your sales data from last month,” a response data can be the total number of products Jill sold last month or the dollar amount of the sales Jill made last month. If Jill and Mark are discussing Jill's performance data, and Jill says, “For the past five years, I have been consistently ranked among the top ten sales agents,” a response data can be Jill's professional ranking and/or badging information.

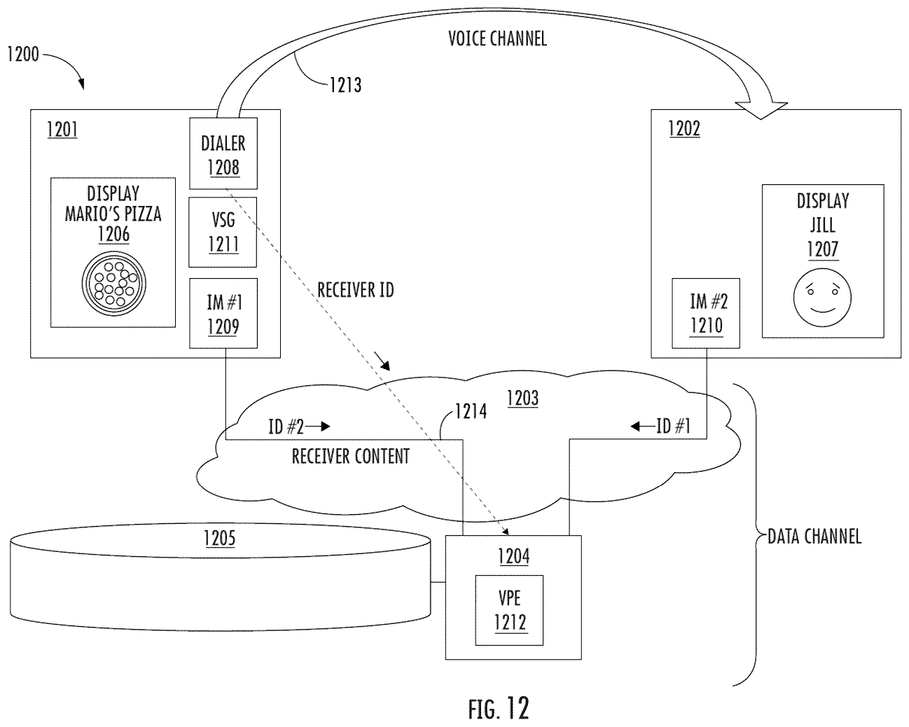

FIG. 12 illustrates one embodiment of the invention wherein the system 1200 is programmed to surface a response data to a dialer device or a receiver device based on the context and content of a voice sample obtained from a voice call between the dialer device and the receiver device. FIG. 12 shows several features that are similar to corresponding features depicted in FIG. 1 discussed above. These are: dialer device 1201, receiver device 1202, Internet 1203, server 1204, database 1205, dialer device display 1206, receiver device display 1207, dialer 1208, dialer or first interaction manager (IM #1) 1209, and receiver or second interaction manager (IM #2) 1210. FIG. 12 illustrates additional features that cooperatively facilitate obtaining a voice sample from the voice call and processing the voice sample to obtain a response data. These additional features include: a voice sample generator (VSG) 1211, and a voice processing engine (VPE) 1212. As discussed previously, the voice channel 1213 can be a voice connection over a traditional circuit-switched network or a VoIP connection over a packet-switched network, such as Internet 1203. Database 1205 can be accessed via the server 1204. The data channel 1214 can be over a packet-switched network (e.g., Internet 1203) and can include server 1204 and database 1205 administrated by the platform. In specific embodiments of the invention, the data channel can include dialer interaction manager 1209, receiver interaction manager 1210, and server 1204. Thus, in such embodiments, a data channel can exist among the dialer device, the receiver device, and the server. However, in specific embodiments of the invention wherein the user of the receiver device is not a user of the platform, a data channel can exist between the dialer device and the server, but a data channel between the receiver device and the server may not exist.

In the embodiment of the invention illustrated in FIG. 12, the dialer device 1201 includes the voice sample generator 1211, whereas the server 1204 includes the voice processing engine 1212. In such an embodiment, the data channel facilitates a two-way communication between the dialer device and the server for transmitting voice samples from the dialer device to the server and surfacing a response data from the server to the dialer device. In another embodiment of the invention, the server includes both the voice sample generator and the voice processing engine. In such an embodiment, the dialer of the dialer device can initiate a three-way voice call, for example, over VoIP, among the dialer device, the receiver device the server, and the server can obtain voice samples from the VoIP voice call and surface, using the data channel, a response data to one of the dialer device and the receiver device. In yet another embodiment of the invention, the dialer device can include both the voice sample generator and the voice processing engine, and the dialer device can access, over the data channel and via the server, the database to search for, and obtain interaction data stored in the database, in turn, to obtain a response data.

In reference to FIG. 12, voice sample generator 1211 can obtain a voice sample (for example, in .wav, .mp3, .aif, etc. file formats) from the voice call, which is then sent to the server for processing and analyses. The voice sample generator can be an application. The voice sample generator application can include the dialer device's dialer application (e.g., of dialer 1208) or be a part of the dialer 1208. The voice sample generator application can operate in cooperation with various hardware and software of the dialer device. In the embodiment illustrated in FIG. 12, a built-in dialer of the dialer device can provide digitized audio of the voice call, and the voice sample generator, in turn, can obtain voice sample from the digitized audio. Alternatively, in cooperation with various hardware and software components of the dialer device, such as the dialer device's APIs, operating system, microphone, speaker, digital signal processor, analog-to-digital converter etc., the voice sample generator can generate digitized voice call from analog audio of the voice call and obtain a voice sample therefrom.

In specific embodiments of the invention where the server includes the voice sample generator, the dialer of the dialer device can initiate a three-way voice call, over VoIP, among the dialer device, the receiver device, and server. In such embodiments, the server's voice sample generator can capture the digitized voice call from the VoIP packets and obtain voice samples from the digitized voice call. Alternatively, the dialer of the dialer device can initiate a three-way voice call, over VoIP, among the dialer device, the receiver device, and a communication server, and the communication server can capture the digitized voice call from the VoIP packets and in turn, supply the digitized voice call to the server's voice sample generator. The communication server can be communicatively coupled to the server or can be a part of the server.

Voice samples can be of a fixed duration such as 30 seconds, 1 minute, 2 minutes, etc. The voice sample generator can obtain back-to-back voice samples of the fixed duration from the voice call throughout the duration of the voice call. Thus, the voice samples are obtained continuously and are streamed to the voice processing engine continuously. In FIG. 12, once the voice sample generator 1211 obtains a voice sample from the voice call, the dialer interaction manager (IM #1) 1209 can transmit, over the data channel, the voice sample to the server where it is processed by the voice processing engine 1212.

The voice processing engine 1212 is a software program. It can include natural language processing (NLP) and natural language understanding (NLU) programs to understand the nature of the speech or the context of the conversation captured in the voice sample. NLP is a subfield of conversational artificial intelligence and can analyze natural or human language data, and NLU, in turn, is a subfield of natural language processing. The voice processing engine 1212 can include a speech-to-text API such as Google Speech, Houndify, IBM Speech to Text, etc. to convert human voice on the voice sample into text that a machine can understand. The voice processing engine 1212 can include an intelligent search engine.

The voice processing engine can process the voice sample to obtain a search cue. Processing can include speech to text conversion, tokenization, normalization, and sematic analysis, etc. In operation, the voice processing engine 1212 converts the audio of the voice sample into text using a speech-to-text API. At this point, the text represents unstructured speech data. The NLP and NLU programs can further process the text and convert it into structured data. The voice processing engine can process more than one voice sample at the same time. This can be beneficial in two respects. First, as disclosed above, the voice sample generator obtains voice samples of a fixed duration; that is, the voice call is split up in real time into multiple voice samples. It may be the case that in one or more samples, at the beginning or end of the fixed duration, a word is chopped off in that a part of the word is captured in one voice sample, and the remaining part of the word is captured in the adjacent voice sample. Processing a voice sample together with its adjacent voice samples provides the complete word, which is otherwise split into two voice samples. Second, Processing the neighboring voice samples also provides a more complete speech context from which the NLP and NLU programs can better understand the meaning and intent of the speech captured in the voice sample.

The NLP and NLU programs can use tokenization to break up a textual sentence into smaller chunks and normalization to strip away unnecessary punctuation, expand contractions, and so forth. The NLP and NLU programs can use semantic analysis to determine what the sentence actually means and the intent of the sentence. For example, if the voice sample contains Jill's question, “What kind of sides do you have?”, the voice processing engine 1212, using the NLP and NLU modules, and using the receiver identifier and interaction data such as the receiver's profile (e.g., Mario's Pizza is a pizza restaurant) obtained from the database 1205, can understand that the word “side” in the question refers not to a “side” of a road, but to side food items offered by Mario's Pizza. Based on that understanding, the voice processing engine 1212 can obtain one or more search cues, such as “menu,” “side orders”, etc.

Using the search cue(s), the voice processing engine 1212 can search for relevant interaction data in association with the dialer identifier, or the receiver identifier, or both, stored in the database. Based on the search using the search cue(s), the voice processing engine 1212 can obtain one or more interaction data that are related to, for example, a question asked in the voice sample, a topic or subject matter of a sentence in the voice sample, a key word used in voice sample etc. Where more than one interaction data, i.e., a set of interaction data, are obtained from the search, the voice processing engine 1212, using, for example, the NLP program, can analyze the set of interaction data to obtain a response data which, for example, best answers a question or is most relevant to the topic of the sentence in the voice sample or the key word used in the sentence. In the example above with Jill's question (“What kind of sides do you have?”), the set of interaction data may include, for example, all the side items Mario's Pizza offers that are listed on its menu, new side items that are not yet listed on the menu, as well as the side items Jill previously ordered from Mario's Pizza. The voice processing engine 1212 can analyze, using the NLP program, the one or more interaction data and formulate a response data that best answers Jill's question-which, in this case, is a list of all the sides Mario's Pizza currently offers (comprising both the side items that are listed on the menu and the new side items). The server can, in turn, surface the response data to Jill's dialer device and/or to the receive device of Mario's Pizza.

The response data can be an interaction data itself. For example, if Jill had asked, “How late is your restaurant open, today?”, the response data can be the latest time Mario's Pizza is open on that day, and such data could be a part of the business profile data stored in the database in association with the receiver identifier of Mario's Pizza's receiver device. The response data can also be derived from the one or more interaction data obtained as illustrated above in response to Jill's question, “What kind of sides do you have?”

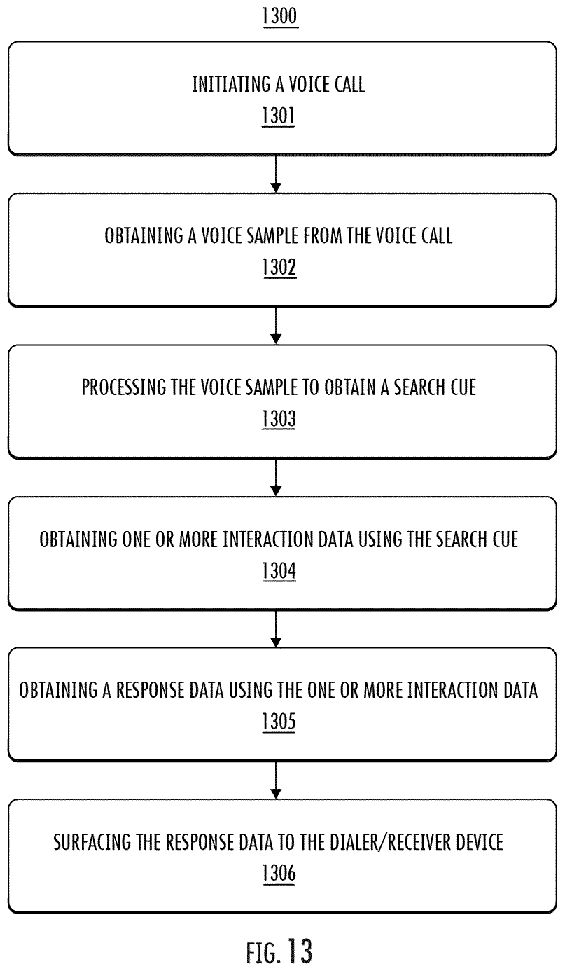

FIG. 13 illustrates a flowchart 1300 for a method for surfacing a response data to a dialer device or a receiver device based on the context and content of a voice sample obtained from a voice call between the dialer device and the receiver device in accordance with specific embodiments of the invention disclosed herein. The method can operate, for example, on the system of specific embodiments of the invention illustrated in FIG. 12. Flowchart 1300 begins at a step 1301 of initiating, using the dialer of the dialer device, a voice call, over a voice channel, with the receiver device using the receiver identifier. Flowchart 1300 continues with a step 1302 of obtaining a voice sample from the voice call. Step 1302 can be performed by the voice sample generator 1211 in FIG. 12. The voice sample is then provided to the voice processing engine 1212 for processing. Flowchart 1300 continues with a step 1303 of processing the voice sample to obtain a search cue, followed by a step 1304 of obtaining one or more interaction data from the database using the search cue, and further followed by a step of 1305 of obtaining a response data from the one or more interactive data. Steps 1303, 1304, and 1305 can be performed by the voice processing engine 1212 in FIG. 12. As explained above, the response data can be an interaction data obtained, and the response data can be derived from the one or more interaction data obtained. Flowchart 1300 ends with step 1306 of surfacing the response data to one of the dialer device and the receiver device. The surfacing of the response data can occur during a voice call or after a voice call.

In specific embodiments of the invention, the receiver device can be a chatbot device, i.e., a chatbot receiver device, that uses a chatbot application such as Google LaMDA powered chatbots, Amazon Alexa, Apple Siri, Samsung Bixby, Microsoft Cortana, Google Assistant, and a number of customized chat bots provided by different enterprises for commercial, social, or professional interactions. The chatbot receiver device can be a personal computer, a server, or a platform specific terminal. In such embodiments, the voice channel between a dialer device and the chatbot receiver device can be established over a packet-switched network using the dialer of the dialer device. A voice sample generator, such as the voice sample generator 1211 in FIG. 12, can obtain voice samples from the voice call, and the voice samples can be transmitted to the server over a data channel between the dialer device and the server. A voice processing engine, such as voice processing engine 1212 in FIG. 12, can process, using NLP and NLU software modules as explained above, the voice samples to understand what questions were asked by the dialer device user and what audio responses were presented by the chatbot receiver device during the voice call. Based on that determination, the voice processing engine can obtain one or more response data from the chatbot receiver device's responses in the voice call, and the server 1204 can store the one or more response data in the database in association with the dialer identifier and/or the chatbot receiver's receiver identifier. In specific embodiments of the invention, the server is programmed to store, in the database, during the voice call, the voice samples obtained, and after the conclusion of the voice call, the voice processing engine can process the stored voice samples to obtain the one or more response data for storing in the database as one or more interaction data in association with the dialer identifier and/or the chatbot receiver device's receiver identifier. In other embodiments of the invention, the voice processing engine can process, in real time, the voice samples to obtain the response data for storing in the database. In this way, the platform of specific embodiments of the invention can harvest a wide range of interaction data from a large number of chatbot service providers and augment the platform's store of data.

In certain jurisdictions, surreptitious recordings of the voice of a human participant, as opposed to a chatbot receiver device or another machine, at the other end of the voice call may implicate legal and privacy issues. For that reason, in specific embodiments of the invention, as a default option, the voice sample generator, for example, included in the dialer device, can obtain voice samples from the portion of the voice call that captures only the voice of the user of the dialer device. In specific embodiments of the invention, the call screen of the dialer device can include a feature, such as an on-screen button, for the dialer device user to optionally activate the voice sample generator to additionally obtain voice samples from the portion of the voice call that captures the voice of the user of the receiver device. When the voice sample generator is so activated, the dialer device can transmit a notification to the receiver device notifying that voice samples from the receiver device user's voice are being obtained for further processing by the system. Upon receiving such a notification, the receiver device user may wish to continue with the voice call as is, terminate the voice call, or request the dialer device user to deactivate recording of his/her voice. Upon such a request, the dialer device user can, by using the same or a different on-screen button, deactivate the voice sample generator from obtaining voice samples from the portion of the voice call that captures the receiver device user's voice and upon said deactivation, the dialer device can transmit a notification to the receiver device notifying that samples of the receiver device user's voice are no longer obtained for further processing.

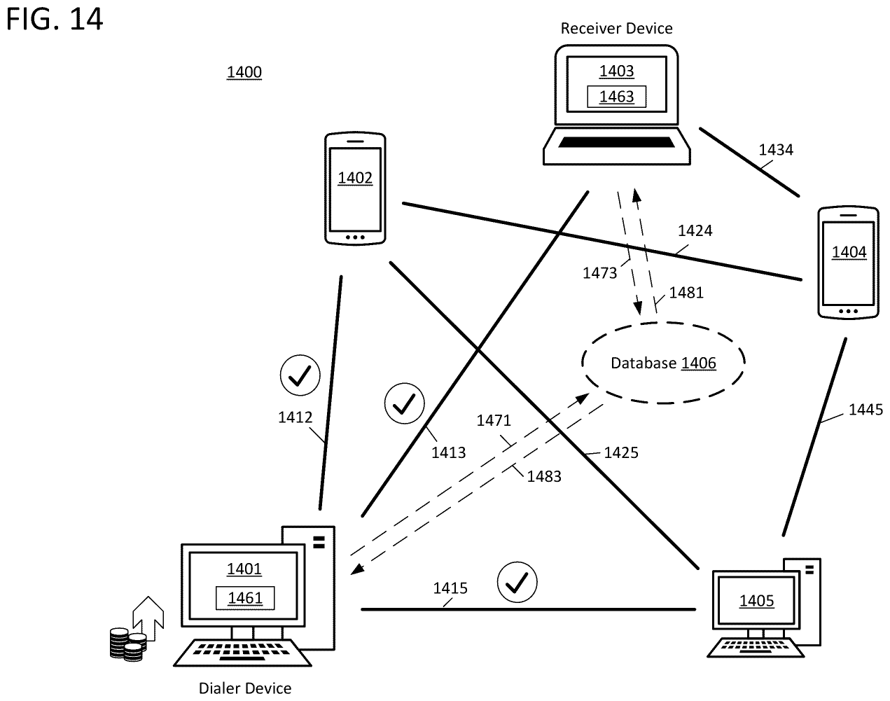

FIG. 14 illustrates an example of system 1400 (a decentralized system) of a plurality of peer nodes running (e.g., using, performing) a distributed algorithm in accordance with specific embodiments of the invention disclosed herein. System 1400 includes peer nodes 1401, 1402, 1403, 1404, and 1405 with various connections between them. For example, peer node 1401 is connected with peer node 1402 via connection 1412, with peer node 1403 via connection 1413, and with peer node 1405 via connection 1415. Peer node 1402 is connected with peer node 1404 via connection 1424 and with peer node 1405 via connection 1425. Peer node 1404 is connected with peer node 1403 via connection 1434 and with peer node 1405 via connection 1445. Although five peer nodes and seven connections are shown, system 1400 is exemplary only and any number of peer nodes with any number of connections in any arrangement may be possible. Database 1406 may be stored across the plurality of peer nodes 1401 through 1405. System 1400 may be able to implement various embodiments (e.g., methods, processes, functions, etc.) described herein using various components (e.g., hardware, software, etc.) described herein.

The plurality of peer nodes may include a peer node 1403 may be a receiver node (e.g., corresponding to a receiver device with a receiver identifier) and peer node 1401 may be a dialer node (e.g., corresponding to a dialer device with a dialer identifier). Each peer node 1401 through 1405 may operate as both a client and a server for other peer nodes 1401 through 1405. Dialer node 1401 may be programmed to initiate a call on a voice channel between dialer node 1401 (e.g., the dialer device) and receiver node 1403 (e.g., the receiver device). The dialer device may include (e.g., store) interaction manager 1461, which may be programmed to transmit (e.g., without using the voice channel) a set of interaction data 1471 to database 1406 during the call. The receiver device may include (e.g., store) interaction manager 1463, which may be programmed to distribute (e.g., without using the voice channel) a set of interaction data 1473 to database 1406 during the call. System 1400 may be programmed to store data from both interaction data 1471 and interaction data 1473 in database 1406 in association with both the receiver identifier (e.g., node 1403) and the dialer identifier (e.g., node 1401).

System 1400 may be programmed to obtain receiver content data 1483 from database 1406 using the receiver identifier. System 1400 may be programmed to distribute receiver content data 1483 to the dialer device. Receiver content data 1483 may be distributed to the dialer device using different combinations of nodes 1401 through 1405. For example, a portion of database 1406 storing receiver content data 1483 may be located at node 1402. In this case, receiver content data 1483 may be sent to the dialer device directly from node 1402 (e.g., via connection 1412) or may be sent to the dialer device through other nodes (e.g., a combination of nodes 1403, 1404, and 1405). In another example, a portion of database 1406 storing receiver content data 1483 may be located at node 1401, such that receiver content data 1483 is not transferred through any node. As another example, portions of receiver content data 1483 may be stored in database 1406 at multiple nodes 1401 through 1405. In this case, receiver content data 1483 may be sent to the dialer device from and through a combination of nodes 1402, 1403, 1404, and 1405.

System 1400 may be programmed to obtain dialer content data 1481 from database 1406. System 1400 may be programmed to distribute the dialer content data 1481 to the receiver device. Dialer content data 1481 may be distributed to the receiver device using different combinations of nodes 1401 through 1405. For example, a portion of database 1406 storing dialer content data 1481 may be located at node 1404. In this case, dialer content data 1481 may be sent to the receiver device directly from node 1404 (e.g., via connection 1434) or may be sent to the receiver device through other nodes (e.g., a combination of nodes 1401, 1402, and 1405). In another example, a portion of database 1406 storing dialer content data 1481 may be located at node 1403, such that dialer content data 1481 is not transferred through any node. As another example, portions of dialer content data 1481 may be stored in database 1406 at multiple nodes 1401 through 1405. In this case, dialer content data 1481 may be sent to the receiver device from and through a combination of nodes 1401, 1402, 1404, and 1405.

In specific embodiments, system 1400 may perform a sentiment analysis on a peer node in the plurality of peer nodes to determine a value score of the peer node. For example, system 1400 may perform a sentiment analysis (e.g., via a sentiment analysis system) on peer node 1401. The sentiment analysis may be based on a variety of factors, such as a quantity of transactions made by peer node 1401, types of transactions made by peer node 1401, timeliness of payments made by peer node 1401, how much peer node 1401 supports the local economy, a quantity of likes associated with (e.g., awarded to) peer node 1401, reviews associated with peer node 1401, ratings associated with peer node 1401, or a combination thereof. These factors may be different for peer nodes in different situations. For example, if node 1401 acts as a customer (e.g., in a transaction), then the likes, reviews, and ratings may correspond to a quantity of likes, reviews, and ratings that the customer has contributed to a platform. If node 1401 acts as a business (e.g., in a transaction), then the likes, reviews, and ratings may correspond to a quality of likes, reviews, and ratings that the business has received from users on a platform. In specific embodiments, system 1400 may include a limit (e.g., a maximum or cap) on value scores.

A node with a high value score, based on the sentiment analysis may be provided with a bias towards getting rewards for helping to run the distributed algorithm. For example, node 1401 may participate in three transactions, one with node 1402 via connection 1412, one with node 1403 via connection 1413, and one with node 1405 via connection 1415. These transactions may be considered “good” (e.g., help the local economy, refer to timely payments, successfully help run the distributed algorithm, etc.). As part of participating in “good” transactions, peer node 1401 may receive rewards such as platform currency. In this way, system 1400 may benefit users and communities.

In specific embodiments, a user may disable their account and their peer node may be removed from the system. For example, a user of peer node 1405 may disable their account and remove peer node 1405 from system 1400. In this case, the system of peer nodes 1401, 1402, 1403, and 1404 may rewrite one or more (e.g., all) of the blocks in a blockchain so that the blocks are still valid (e.g., able to function) without the data from peer node 1405 being present anymore (e.g., being erased, deleted). That is, the blockchain may be able to function without the user data associated with peer node 1405. By being able to erase their data off the platform, users are able to exercise individual sovereignty over their data.

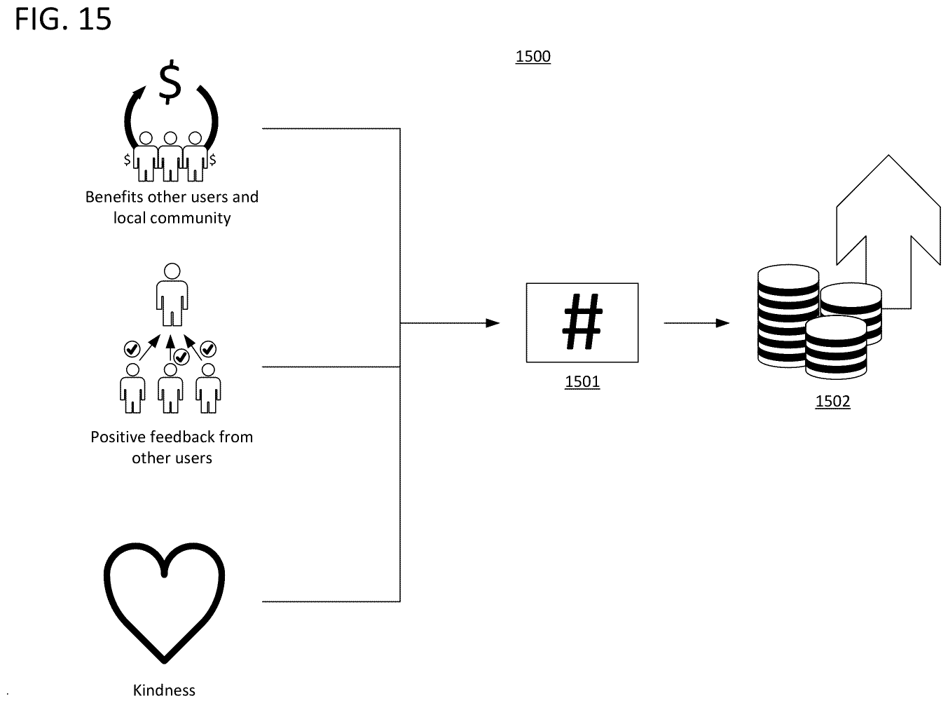

FIG. 15 illustrates an example of a peer node receiving rewards 1502 based on sentiment analysis 1500 in accordance with specific embodiments of the invention disclosed herein. Sentiment analysis 1500 may determine value score 1501 for the peer node and the peer node may receive rewards 1502 (e.g., platform currency) based on value score 1501. The peer node may be part of a decentralized system (e.g., system 1400) that incorporates biasing so that “good users” of the system are provided with a bias towards getting rewards 1502 for helping to run the distributed algorithm. Good users may be determined by sentiment analysis 1500 and a “goodness” of a user may be measured by value score 1501. Value score 1501 may be used to bias transactions for the system.

A good user may be a user that helps run the distributed algorithm. A good user may be a user that spends money in a way that benefits users of the system (e.g., other users of the platform), that spends money in a way that benefits the local economy of the user, that gets positive feedback from other users, that is kind, etc. Kindness may be determined based on sentiment analyzers (or a sentiment analysis system) analyzing interaction data of the user. Rewards 1502 for being a good user may include a currency of the platform. The currency of the platform may be a cryptocurrency.

Sentiment analysis 1500 may be based on a variety of factors, such as a quantity of transactions made by the peer node, types of transactions made by the peer node, timeliness of payments made by the peer node, how much the peer node supports the local economy, a quantity of likes associated with the peer node, reviews associated with the peer node, and ratings associated with the peer node, or a combination thereof. These factors may be different or have different weight for peer nodes in different situations.

For example, if a peer node corresponds to a customer account, then the likes, reviews, and ratings may correspond to a quantity of likes, reviews, and ratings that the customer has contributed to a platform. If the peer node corresponds to a business account, then the likes, reviews, and ratings may correspond to a quality of likes, reviews, and ratings that the business has received from users on a platform.

In specific embodiments, the system may access external data from an external platform. The external data may be used as part of sentiment analysis 1500. For example, in order to calculate how a user has supported the local economy, the system may access city or county economic reports, business websites, user accounts at businesses, etc. Sentiment analysis 1500 may analyze job creations, business growth, quantity of local purchases vs chain store purchases, dollars spent on local purchases, dollars donated through participation in charitable sales promotions, etc. using external data and data internal to the system (e.g., platform) to calculate the impact of a specific user. In specific embodiments, the system may also use external data and internal data to calculate an impact of all the users within the system individually and collectively.

Value score 1501 may be used to bias transactions for the system. A node with a higher value score may be considered a more trustworthy node. Accordingly, the node may be given an advantage in the process of generating new tokens or rewards within the decentralized network. Value score 1501 may act as a weight such that the peer node is given a bias for the algorithm (e.g., a proof of weight algorithm) to make mining tokens from (or validating) the blockchain easier for that peer node. For example, a trusted node (e.g., a good user) may be able to mine tokens more easily, faster, or more profitably than other nodes. The trusted node may have a higher chance of successfully creating new tokens or earning mining rewards (e.g., platform currency). The trusted node may have a lower mining difficulty or workload, may have faster access to transaction data or lower latency, may be positioned closer to other trusted or influential nodes, may be selected more frequently as a validator, may have access to newly mined blocks before other nodes have access to them, etc.

The platform currency may be distributed among a plurality of peer nodes. That is, many nodes in the system may have various amounts of platform currency. In specific embodiments, value score 1501 may be less than a maximum value score. The maximum value score may be used to prevent a single user from becoming too powerful (e.g., too biased) in the system. In specific embodiments, there may also be a maximum quantity of platform currency a user may accumulate. The maximum value score and the maximum quantity of platform currency may be fixed amounts or may change based on the peer-to-peer network. For example, the maximum value score and the maximum quantity of platform currency may be based on a relationship between the user node and other nodes (e.g., the node with the highest value score, the node with the lowest quantity of platform currency, the node with the next-highest quantity of platform currency to the user node). The platform currency may be cryptocurrency.

In specific embodiments, a user may see an indication of how much platform currency they have accumulated or earned. For example, the user may ask a chatbot how much platform currency he or she has. The chatbot may output, in response, a message on the user's device that includes a quantity of platform currency associated with the user (e.g., the user's identifier). In specific embodiments, the user may also access (e.g., the chatbot may also output) when portions of the platform currency expire, how portions of the platform currency were gained, and suggestions for how to gain more platform currency. The user may be able to spend platform currency on deals from businesses on the platform, platform user interface customizations, additional platform functions, etc. The platform currency may be cryptocurrency.

The chatbot may help users organize and use their data in ways that increase the individual sovereignty of users. For example, the chatbot described herein may efficiently deal with large quantities of data to provide users with a common language based interface to harvest, manipulate, and monetize their own data without costly resources. Users of a distributed algorithm in a peer-to-peer network may be rewarded for helping run the distributed algorithm, spending money in a way that benefits the users of the platform and their local economies, and getting positive feedback from other users. The rewards may include platform-centric currency and receiving a positive bias in verifying the portions of the algorithm performed on the user's device. In this way, the distributed algorithm may benefit users and communities.

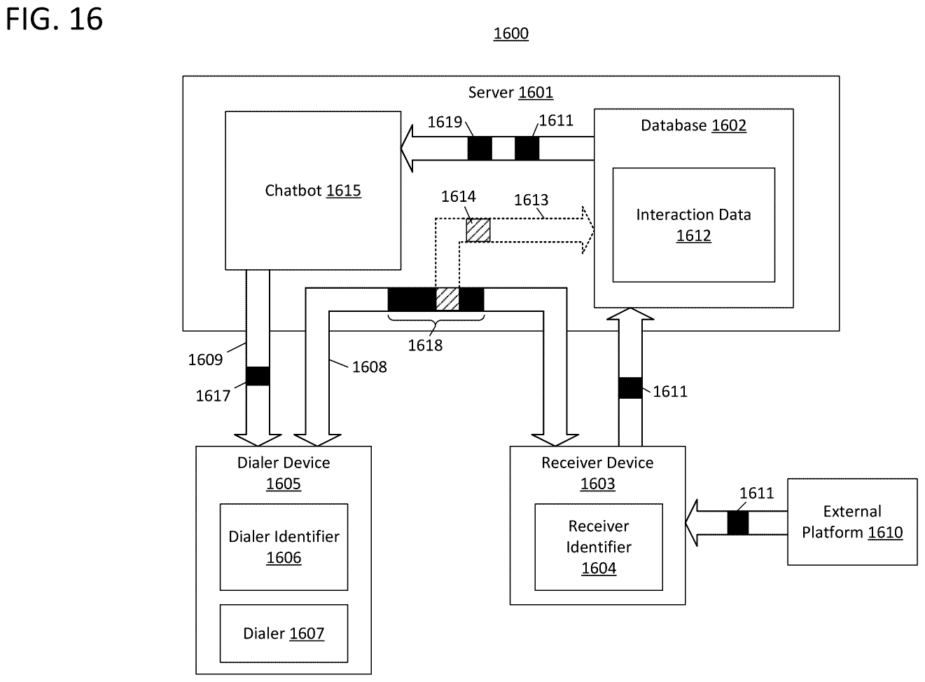

FIG. 16 illustrates an example of system 1600 using chatbot 1615 to output message 1617 based on response data 1619 and external data 1611 from external platform 1610 in accordance with specific embodiments of the invention disclosed herein. System 1600 may include server 1601, database 1602, receiver device 1603 with receiver identifier 1604, dialer device 1605 with dialer identifier 1606, dialer 1607, voice channel 1608, and data channel 1609 connecting dialer device 1605 and server 1601. Although a single dialer device and a single receiver device are shown, any number of dialer devices and receiver devices may be part of system 1600. In specific embodiments, instead of using server 1601, a system similar to system 1600 may use a distributed algorithm (e.g., a peer-to-peer network) in which each peer node may operate as both a client and a server for other peer nodes.

Dialer 1607 may be programmed to initiate voice call 1618, over voice channel 1608, with receiver device 1603 and using receiver identifier 1604. For example, dialer 1607 may prepare receiver identifier 1604 for transmission to a network. Dialer device 1605 may send a signal to server 1601. The signal may contain receiver identifier 1604 and information about dialer device 1605 (e.g., dialer identifier 1606). In specific embodiments, dialer device 1605 may authenticate with a voice over internet protocol (VoIP) service provider (e.g., using credentials stored in dialer device 1605 such as dialer identifier 1606). A voice call setup request may be sent to receiver device 1603 (e.g., receiver device 1603 may ring). A user of receiver device 1603 may accept the voice call request. Both dialer device 1605 and receiver device 1613 may establish an audio path using voice channel 1608 (e.g., using data packets). In specific embodiments, the user of receiver device 1603 may be unavailable or otherwise not respond to the voice call request or decline the voice call request. In these embodiments, an artificial intelligence associated with dialer identifier 1606 may accept the voice call request. For example, a chatbot or an AI avatar may respond to a user using dialer device 1605. The visual of the AI avatar may be based on the user of receiver device 1603.

Server 1601 may be programmed to store, in database 1602, interaction data 1612 in association with either the receiver identifier 1604, the dialer identifier 1606, or both. Interaction data 1612 may be stored in tables. The tables can include a user identity table, a user relationship table, a content table, an interaction type table, and an interaction fact table. Tables can be interrelated to provide a complete record of all interactions occurring using system 1600. Interaction data 1612 may include information based on receiver identifier 1604; for example, a type of business, business hours, menu, provided services, business address, dietary and allergy options, reservation or appointment set up, etc. Interaction data 1612 may also include voice information, for example a question asked in the voice call, a topic or subject matter of a sentence in the voice call, a key word used in voice call, etc. Interaction data 1612 may include payment of currency. Interaction data 1612 (or derivatives thereof) can include commercial information, social information, and professional information; for example, dialer profile, receiver profile, business profile, and work profile (e.g., work-related ranking and badges, a person's resume, how long the person has been affiliated with his/her current occupation or entity, how long he/she has been working on a project or in a specific field, etc.).

Receiver device 1603 may be programmed to access external data 1611 from external platform 1610. External data 1611 may include information related to receiver identifier 1604. External platform 1610 may include third-party review platforms, social media, calendars, maps, work management websites, etc. External data 1611 may include information such as reviews, social media posts made by receiver identifier 1604, social media posts made about receiver identifier 1604, holidays, locations, salaries, badges, work hours, scheduled leave, etc. Receiver device 1603 may establish a network connection with external platform 1610 (e.g., internet, local connection, wired, wireless). In specific embodiments, receiver device 1603 may connect to a specific internet protocol (IP) address or uniform resource locator (URL) to reach a server hosting external platform 1610. In specific embodiments, receiver device 1603 may authenticate or verify itself to external platform 1610. Receiver device 1603 may request external data 1611 from external platform 1610. External platform 1610 may retrieve data 1611 and send it to receiver device 1603. Receiver device 1603 may store external data 1611 in memory. In specific embodiments, receiver device 1603 may parse or interpret external data 1611 (e.g., change the format of external data 1611). In specific embodiments, security measures such as encryption and decryption may be used as part of the transmission of external data 1611. In specific embodiments, receiver device 1603 may send external data 1611 to server 1601.

System 1600 may obtain voice sample 1614 from voice call 1618. A voice sample generator (VSG) and a voice processing engine (VPE) may cooperatively facilitate obtaining a voice sample 1614 from voice call 1618. Voice channel 1608 can be a voice connection over a traditional circuit-switched network or a VoIP connection over a packet-switched network. The voice processing engine can process voice sample 1614 to obtain a search cue. Processing can include speech to text conversion, tokenization, normalization, and sematic analysis, etc. In specific embodiments, the voice processing engine can process more than one voice sample at the same time. The NLP and NLU programs can use semantic analysis to determine what a sentence actually means and the intent of the sentence. In specific embodiments, voice sample 1614 may be compressed and/or may be divided into packets. In specific embodiments, system 1600 may use various processing techniques such as noise reduction and echo cancellation to improve the quality of voice sample 1614.

System 1600 may process voice sample 1614 to obtain response data 1619. A voice sample generator and a voice processing engine may cooperatively facilitate processing the voice sample 1614 to obtain response data 1619. The voice processing engine can search for relevant interaction data 1612 in association with dialer identifier 1606, receiver identifier 1604, or both, stored in database 1602. Based on the search, the voice processing engine can obtain one or more interaction data 1612 that are related to, for example, a question asked in voice sample 1614, a topic or subject matter of a sentence in voice sample 1614, a key word used in voice sample 1614, etc. The voice processing engine 1212 can analyze, using the NLP program, interaction data 1612 and formulate response data 1619 that best relates to voice sample 1614. System 1600 may store, in database 1602, response data 1619 in association with receiver identifier 1604, dialer identifier 1606, or both. Response data 1619 can be interaction data 1612 or may be derived from interaction data 1612.

Chatbot 1615 may output message 1617 on receiver device 1603. Message 1617 may be audio or may be text. Message 1617 may be based on response data 1619 and data 1611 from external platform 1610. Server 1601 may send message 1617 to dialer device 1605. In specific embodiments, server 1601 may also send message 1617 to receiver device 1603. Message 1617 can be sent during voice call 1618 or after voice call 1618. Any response by dialer device 1605 may be stored by server 1601 as response data or interaction data. In this way, system 1600 may grow database 1602 and may continue learning. For example, after the conclusion of voice call 1618 or during voice call 1618, the voice processing engine can process stored voice samples (e.g., voice sample 1614 and others) to obtain the one or more response data for storing in database 1602 as one or more interaction data in association with the dialer identifier 1606 and/or receiver identifier 1604. Chatbot 1615 may help users (e.g., a user of dialer device 1605, a user of receiver device 1603) organize and use their data in ways that increase their individual sovereignty. For example, chatbot 1615 may efficiently deal with large quantities of data (e.g., external data 1611, response data 1619, interaction data, etc.). Chatbot 1615 may use this data to provide users with a common language based interface to harvest, manipulate, and monetize their own data without costly resources.

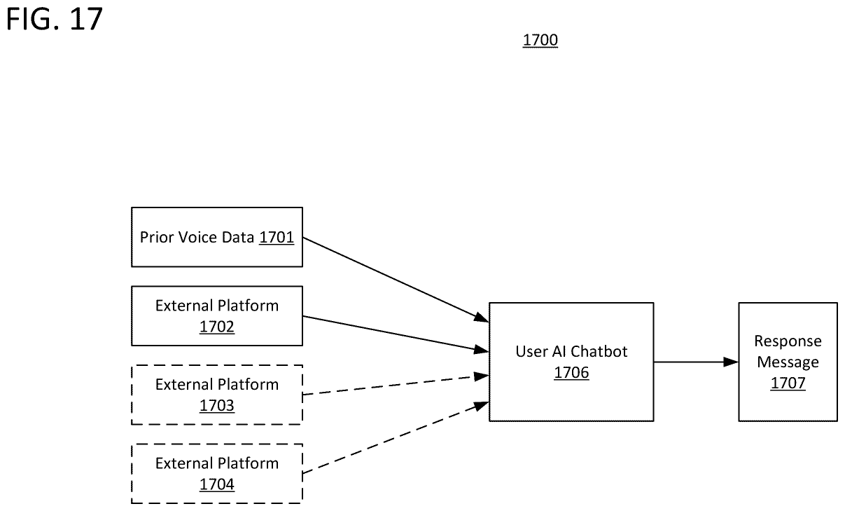

FIG. 17 illustrates system 1700 with chatbot 1706, prior voice data 1701, external platform 1702, and response message 1707 in accordance with specific embodiments of the invention disclosed herein. Chatbot 1706 may be an AI chatbot that is associated with a user (e.g., a customer or a business) and may output messages (e.g., audio, visual) on a device associated with the user. System 1700 optionally includes external platform 1703 and external platform 1704. System 1700 may incorporate aspects of system 1600. Prior voice data 1701 may correspond to voice data from the same platform as chatbot 1706 and response message 1707. Chatbot 1706 may use prior voice data 1701 and data from external platform 1702 to form response message 1707. In specific embodiments, response message 1707 may include information from multiple external platforms (e.g., a combination of external platforms 1702, 1703, and 1704). Although three external platforms are shown, any quantity of external platforms may be part of system 1700.

In specific embodiments, chatbot 1706 may output response message 1707 on the user's device. Response message 1707 may be based on prior voice data 1701 (e.g., a user inquiry, a voice sample) which may be audio or text. Response message 1707 may include a variety of information including a quantity of platform currency associated with the user (e.g., associated with a user identifier), whether the platform currency expires, when the platform currency expires, how the platform currency was earned, suggestions for how to gain more platform currency, suggested uses (e.g., purchases, etc.) for the platform currency, and more. Response message 1707 may be based on data from one or more external platforms 1702, 1703, and 1704 in addition to prior voice data 1701.

In specific embodiments, system 1700 (e.g., chatbot 1706) may process external data from external platform 1702 (e.g., and other external platforms 1703 and 1704). System 1700 may process the external data into a structured format. System 1700 may retrieve relevant external data from external platform 1702. System 1700 may retrieve relevant response data from an internal platform memory. The response data may be from prior voice data 1701. Identifying and retrieving relevant external data and relevant response data may be based on one or more keywords, embeddings, indexing techniques, search cues, etc. System 1700 may interpret response data using a machine learning model. System 1700 may relate the response data to the external data using the machine learning model and based on interpreting the response data. System 1700 may predict (e.g., using the machine learning model) a sequence of words likely to follow the response data. Message 1707 may be based on the predicted sequence of words. Chatbot 1706 may include various modules such as a cost accounting module, a pricing module, a sales forecasting module, a sentiment analysis module (e.g., sentiment analysis system), etc. Chatbot 1706 may provide warnings, suggestions, or simulations associated with running a business. Key metrics may be organized in a dashboard.

In specific embodiments, chatbot 1706 may be able to read external data from external platforms 1702, 1703, and 1704. Chatbot 1706 may compile (e.g., keep track of) information from these platforms 1702, 1703, and 1704 and may allow the user to access information from the external platforms 1702, 1703, and 1704 in one place (e.g., in a single application). Chatbot 1706 may message the user about the deals based on a user inquiry or may have a dedicated portion of system 1700 (e.g., a specific tab or page of an application) showing deals for one or more businesses. In either case, the information may be provided via response message 1707. If deals for multiple businesses are shown on a single page, then deals may be sorted by business, by type of deal (buy-one-get-one, 20% off, punch cards, store points, gift cards, etc.), or by a quality of the deal (e.g., overall calculated customer cost savings, percentage saved for a given purchase, etc.).

In specific embodiments, external platform 1702 may be a business website for Mario's Pizza. Chatbot 1706 can show information from the business website, for example, alerting the user (e.g., customer) about current or future deals. Chatbot 1706 may, for example, review information on external platform 1702 and message the user based on that information. Information may include notifications that Mario's Pizza has a Memorial Day deal, that Mario's Pizza is running a charitable sales promotion for a local elementary school, that Mario's Pizza is currently offering a coupon for 20% off medium pizzas, that Black Friday deals begin Thursday at 9:00 pm, that Mario's Pizza is catering at a public city event, that Mario's Pizza is locally owned and operated, and similar information. Chatbot 1706 may provide the information via response message 1707.

In specific embodiments, external platform 1702 may refer to an account that a user has with a business, for example a customer account with Mario's Pizza. In this example, chatbot 1706 may inform the user that he or she has twenty Mario's Pizza points that are expiring in the next month, that the user has eighty Mario's Pizza points total, that the user is one large pizza purchase away from a free pizza (e.g., a punch card), that the user has twenty dollars of an unused Mario's Pizza gift card, and various other account-specific promotions, offers, or rewards. Chatbot 1706 may provide the information via response message 1707.

In specific embodiments, external platform 1702 may be a third-party review platform. Chatbot 1706 may show information from the third-party review platform in message 1707, for example, showing the user reviews for Mario's Pizza from Yelp (e.g., external platform 1702), TripAdvisor (e.g., external platform 1703), Facebook (e.g., external platform 1704), Uber Eats (e.g., an additional external platform not shown in FIG. 17), etc. Chatbot 1706 may sort reviews based on relevance or another factor. For example, a user can input (e.g., via prior voice data 1701) a preferred third-party review platform and chatbot 1706 may then prioritize those reviews. Chatbot 1706 may sort reviews based on a specific item that the user has selected (e.g., via prior voice data 1701). For example, if the user has selected a Caesar Salad from Mario's Pizza menu, then chatbot 1706 may seek reviews from external platforms 1702, 1703, and 1704 mentioning Mario Pizza's Caesar Salad or Mario Pizza's salad options generally. Chatbot 1706 may provide the information via response message 1707.

Additionally or alternatively, chatbot 1706 may sort reviews based on a type of item across multiple businesses. For example, if the user indicates he or she wants a pepperoni pizza, chatbot 1706 may compile information from external platforms 1702, 1703, and 1704 about pepperoni pizzas at restaurants within a geographical range of the user. The geographical range may be set or variable, and the geographical location of the user may be measured (e.g., via GPS) or input by the user (e.g., typed into system 1700). Chatbot 1706 may output reviews for pepperoni pizzas from multiple restaurants (e.g., Mario's Pizza, Joe's Pizza, etc.). Reviews may be sorted by proximity to the user's location, by relevance of review, by rating of review, price of pizza, etc. In specific embodiments, chatbot 1706 may combine data from multiple sources to output response message 1707. For example, chatbot 1706 may combine review information from a third-party review platform (e.g., external platform 1702) and pricing from a business website (e.g., external platform 1703). Chatbot 1706 may provide the information via response message 1707.

In specific embodiments, external platform 1702 may be a report such as official city government economic report. For example, chatbot 1706 may process data from external platform 1702 to inform the user of city economic performance, growth rate, inflation, labor market trends, business start-up rates, small business support, business closures, business expansions, and the like. Chatbot 1706 may also assist the user in interpreting information based on external platform 1702. For example, chatbot 1706 may identify which economic sector a specific business corresponds to and may identify which businesses are registered as sole proprietorships, partnerships, corporations, franchises, limited liability companies (LLCs), or Doing Business As (DBAs). Chatbot 1706 may provide the information via response message 1707.

Chatbot 1706 may use information from one or more external platforms 1702, 1703, and 1704 to compile information about a business. For example, chatbot 1706 may determine one or more scores for the business such as scores related to the local economy. For example, chatbot 1706 may determine a local economy booster score, local job creations score, local supplier score, review rating, fair wage score, health score, etc. The review rating may be calculated from reviews about the business across various external platforms. The health score may be calculated based on a history of health inspections or a most recent health inspection. Various scores may be combined into an overall score or rating for the business.

Chatbot 1706 may use information from one or more external platforms 1702, 1703, and 1704 as well as user transactions to compile information about the user (e.g., a customer). User transactions may refer to transactions associated with the user identifier (e.g., a dialer identifier). For example, chatbot 1706 may determine one or more scores for the user such as scores related to the impact the user has had on the local economy or other factors. For example, chatbot 1706 may determine a local economy booster score, local shopping score, review rating, tipping score, etc. The review rating may be calculated from a quantity or quality of reviews written by the user across various external platforms or likes accumulated by these reviews. External platforms 1702, 1703, and 1704 may include credit card statements, third-party review websites, social media, etc. Various scores may be combined into an overall score or rating for the user. System 1700 may distribute a platform currency to a user account of the platform of system 1700 (e.g., an account associated with the dialer identifier) based at least in part on the one or more scores related to the local economy, the combined score, and/or a different metric.

Chatbot 1706 may include specialized functions and response messages for business accounts. The artificial intelligence system of chatbot 1706 may be programmed to perform income projections, income targets, profit scenarios, cost benefit relationships, and performance metrics. Chatbot 1706 may access external platforms 1702, 1703, and 1704 which may include platforms that store documents such as income statements, budgets, sales reports, inventory reports, client reports, employee performance reports, production reports, supply chain reports, maintenance reports, quality control reports, marketing reports, customer feedback, social media analytics, training and development reports, employee feedback, risk assessments, business forecasts, project status reports, tax reports, etc. Chatbot 1706 may compile or determine its own reports (e.g., income projections, income targets, profit scenarios, cost benefit relationships, and performance metrics) and may report on factors or patterns periodically (e.g., daily, weekly, monthly, yearly, etc.) or upon request. For example, chatbot 1706 may output the income projections, the income targets, and the performance metrics on the business's (e.g., receiver) device.

Chatbot 1706 may assist in business planning. For example, chatbot 1706 may perform profit scenarios, cost benefit relationships, determine optimal promotions, etc. Chatbot 1706 may have knowledge of the costs of supplies for a business and may optimize promotions based on these costs. For example, Mario may input ingredient amounts and ingredient costs for making a large pepperoni pizza at Mario's Pizza into chatbot 1706. Additionally or alternatively, chatbot 1706 may know approximate ingredient amounts and ingredient costs based on data from one or more external platforms 1702, 1703, and 1704 (e.g., supermarket websites, recipe blogs). Chatbot 1706 may determine a set of ingredient costs corresponding to one or more potential transactions, which may include hypothetical promotions (coupons, discounts, etc.). The ingredient costs and hypothetical promotions may be input to the artificial intelligence system of chatbot 1706 to determine a profit margin and/or bottom line made on each of the one or more potential transactions. Chatbot 1706 may also input a value score of a specific customer such that profit margins concerning the one or more potential transactions are specific to that customer. In this way, promotions may be specialized and may account for long-term customer relationships. Based on the profits of various potential transactions, chatbot 1706 may output response message 1707 to Mario, suggesting one or more promotions. In specific embodiments, chatbot 1706 may also include the profit margin for the specific promotions (e.g., the specific potential transactions). Chatbot 1706 may also calculate a potential platform currency earning that the customer would make if he or she completed the transaction and may output this information to the customer.

In specific embodiments, response message 1707 may be a recommended price for a product. Chatbot 1706 may suggest pricing for goods and services. For example, a business may be associated with (e.g., sell, offer) a set of products (where products may include services). Chatbot 1706 may recommend pricing for these products. To make the recommendations, chatbot 1706 may access information from external platforms 1702, 1703, and 1704 as well as internal information such as prior voice data 1701. Chatbot 1706 may consider factors such as ingredient costs, employee wages, cost of living of the city of the business, competitor pricing, etc. to recommend product pricing.

In specific embodiments, response message 1707 may indicate a radicalizing pattern within interaction data (e.g., prior voice data 1701) and external from external platforms 1702, 1703, and 1704. In specific embodiments, chatbot 1706 may determine whether data that a user interacts with is radicalizing. For example, chatbot 1706 may analyze interaction data and external data and identify a pattern using the data and may perform a sentiment analysis to determine whether the pattern is radicalizing. Chatbot 1706 may then output message 1707 (e.g., on a receiver device) based on the determination. In specific embodiments, chatbot 1706 may perform the sentiment analysis automatically (e.g., periodically, based on a user pattern, a change in a user pattern, etc.) and may output message 1707 if chatbot 1706 determines that the pattern is radicalizing. In specific embodiments, chatbot 1706 may perform the sentiment analysis manually (e.g., based on a user input, etc.) such that message 1707 may indicate that the pattern is radicalizing or that the pattern is not radicalizing. In specific embodiments, there may be a range of radical sentiment such that chatbot 1706 may assign a radicalizing score to the pattern rather than a simple yes/No.

In specific embodiments, response message 1707 may indicate an interest pattern within interaction data (e.g., prior voice data 1701) and external data from external platforms 1702, 1703, and 1704. In specific embodiments, chatbot 1706 may determine whether data that a user interacts with is similar to data that a second user interacts with. The second user may be identified by chatbot 1706 using his or her own identifier. Chatbot 1706 may analyze interaction data and external data and identify a pattern using the data. The pattern may refer to a user interest. Chatbot 1706 may perform a sentiment analysis to determine whether the pattern is similar to the data pattern of the second user. The second user may be a contact (e.g., friend, coworker) of the user. Response message 1707 may indicate, on the device of the first user, that his or her data pattern is similar to that of a second user. For example, response message 1707 may indicate that the user and a contact of the user both interact with a certain business or system (e.g., they both frequent Matty's Embroidery Shoppe) and suggest that the user reaches out to (e.g., reconnects with) his or her contact.

In specific embodiments, chatbot 1706 may include an avatar and response message 1707 may be output such that the avatar appears to be communicating response message 1707. For example, if response message 1707 is audio, then the avatar may be displayed a device with the avatar's mouth moving with the audio. The avatar may be specific to a business (e.g., a type of information within response message 1707, a receiver identifier, a dialer identifier). For example, if a customer calls a business, but a representative of the business does not answer, then the call may be answered by AI chatbot 1706 using an avatar. The avatar may be specific to the business (e.g., the receiver identifier) and may be output (e.g., displayed) on the customer device (e.g., dialer device). The business-specific avatar may have the likeness (e.g., visual likeness, auditory likeness) of an owner or representative of the business. For example, Mario or a family member of Mario may be used as a model for AI chatbot 1706.

In specific embodiments, chatbot 1706 may be trained to act like or represent a specific user (e.g., a customer or a business owner). A business may be associated with more than one chatbot or avatar. In specific embodiments, each user (e.g. a customer or a business) may be able to chat with another user's chatbot. For example, an AI chatbot may be trained on a first user's data. The first's user data may include data from internal databases and external databases and may include information about the first user's interactions with other users and with AI (e.g., the first user's AI chatbot or another AI chatbot) as well as user transactions. This data may also include interactions between the first user's AI chatbot and a second user and interactions between the first user's AI chatbot and another chatbot. AI chatbots (e.g., chatbot 1706) may learn with iterative loops. The AI chatbot trained on the first user's data may represent the first user in an interaction or transaction with a second user.

Chatbots may participate in interactions between users. In specific embodiments, a chatbot may output a message to multiple users (e.g., on a receiver device and on a dialer device). In specific embodiments, a conversation between two users may also include a first chatbot trained on the first user's data and a second chatbot trained on the second user's data, such that there may effectively be four participants in the conversation. Conversations may be multimodal. Each chatbot may output visual content (e.g., text, images, documents) and/or audio content (e.g., sound) on the devices. Interactions (including transactions) with the chatbots may be in real time. For example, the AI chatbots may output screen contents from previous conversations (e.g., between the same two users, between the first user and a different user) and projected helpful suggestions. In specific embodiments, more than two users may be part of the conversation. Each user may have an AI chatbot trained on his/her data which may also be part of the conversation.

AI chatbot 1706 may use deep learning and may be trained on current and past data (e.g., interactions with users and chatbots, transactions, etc.). AI chatbot 1706 may use loop learning and be trained iteratively. AI chatbot 1706 may learn from user responses (e.g., response to AI chatbot 1706 suggestions, etc.). Information from AI chatbot 1706 may be output on screen or in a voice mode and AI chatbot 1706 may learn from text, selected, or voice response. For example, AI chatbot 1706 may output (e.g., pull from a database) a document relevant to a discussion between users. AI chatbot 1706 may analyze and learn from user reactions (e.g., voice data, time with the document on the screen, etc.) to the document. The document may be output to multiple devices. In specific embodiments, the document may be output in different formats or versions to different devices (e.g., based on user preference). User preference for format or version of a document may be input by the user or may be learned by AI chatbot 1706. As AI chatbot 1706 learns, it may store (e.g., adds, accumulates) information about specific users (e.g., in a database). This information may be used in future interactions and transactions. A user may be associated with one or more specific databases or AI chatbots. An AI chatbot specific to a user (e.g., trained to act as that user would act) may represent the user. For example, the AI chatbot may be able to handle various queries and customer service needs as the business owner would himself or herself. In specific embodiments, the AI chatbot may handle business tasks. For example, the AI chatbot may monitor stock, monitor vendor supply, track shipping times, track current and projected demand, etc. to suggest that the business stock a specific item from a specific vendor. In specific embodiments, the AI chatbot may be able to handle business tasks as the business owner would have handled them himself or herself.

In specific embodiments, AI chatbot 1706 may seamlessly integrate external platforms 1702, 1703, and 1704. For example, various external platforms may accept integrations of other technology (e.g., corresponding to different companies, etc.) and may add their application programming interface (API) to the system (e.g., system 1700). As various technologies and platforms integrate, the system may develop a more powerful and more helpful AI system with greater and deeper collaborations. AI chatbot 1706 may assist in improving AI systems of other platforms and AI systems of other platforms may assist in improving AI chatbot 1706. For example, AI chatbot 1706 and external platforms may share data. Various AI system (e.g., from partnered businesses) may train using a shared database and may add to the shared database. AI systems may be added to or introduced to the shared database (e.g., if a business is added to the partnership). For example, various businesses (e.g., AI blockchain startups, crypto spaces startups, etc.) may share data to train separate AI systems or to train a single AI system applicable to each business of the various businesses.

Chatbot 1706 may help users (e.g., customers, businesses) organize and use their data in ways that increase their individual sovereignty. For example, chatbot 1706 may efficiently deal with large quantities of data (e.g., external data from external platforms 1702, 1703, and 1704, prior voice data 1701, etc.). Chatbot 1706 may use this data to provide users with a common language based interface to harvest, manipulate, and monetize their own data without costly resources.

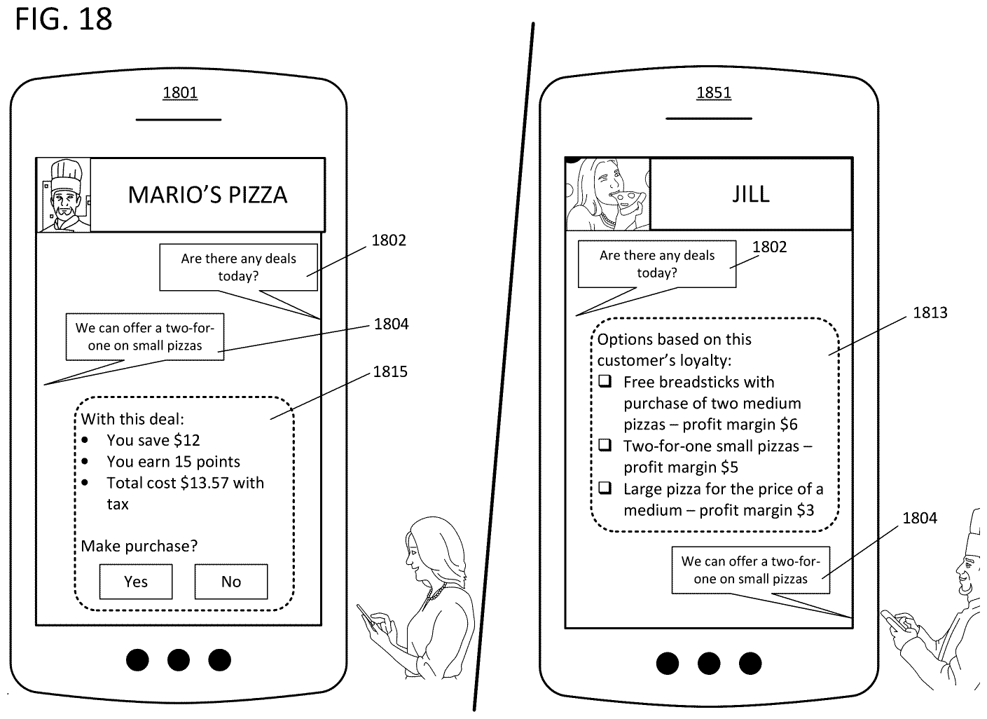

FIG. 18 illustrates an example of devices 1801 and 1851 displaying information, during a chat or voice call, in accordance with specific embodiments of the present invention. Some information is displayed via a chatbot. In the example of FIG. 18, Jill, using device 1801, initiates an interaction with Mario's Pizza. Device 1801 (Jill's device) acts as a dialer device and device 1851 (Mario's device) acts as a receiver device. A phone number, account information on the platform, or other information may be used as identifiers. For example, Jill's phone number may be a dialer identifier and Mario's phone number may be a receiver identifier. The platform used to perform the interaction may use a server or may be a peer-to-peer network. In specific embodiments, device 1801 and device 1851 may be peer nodes.

Jill may use device 1801 to send message 1802 to device 1851. Although shown as a text message, message 1802 may be an audio message and may be part of a voice call. Message 1802 may include an inquiry. For example, message 1802 may read “Are there any deals today?”

An AI chatbot (e.g., similar to chatbot 1615 or chatbot 1706) may read message 1802 and suggest deals for Mario to offer Jill. The AI chatbot may retrieve and interpret data from one or more external platforms. The AI chatbot may have knowledge of costs of supplies for a one or more items in Mario's menu and may optimize promotions based on these costs. In specific embodiments, Mario may input ingredient amounts and ingredient costs for making a large pepperoni pizza, bread sticks, Caesar salad, etc. at Mario's Pizza into chatbot 1706. In specific embodiments, the AI chatbot may know approximate ingredient amounts and ingredient costs based on data from one or more external platforms such as supplier websites, geographic location of Mario's Pizza, common pizza recipes, etc.

The AI chatbot may analyze a set of costs corresponding to one or more potential transactions. The AI chatbot may also analyze a set of hypothetical deals (promotions, coupons, discounts, etc.). General information such as ingredient costs, menu prices, time spent making a menu item, current levels of business (e.g., quantity of items ordered recently), etc. may be used by the AI chatbot to analyze the set of potential transactions and hypothetical deals. Information specific to Jill, such as her tipping habits, customer frequency, value score, store points, order history, etc. may be used by the AI chatbot to analyze the set of potential transactions and hypothetical deals. Based on general information and customer-specific information, the AI chatbot can suggest deals for Mario to offer to Jill. The AI chatbot may suggest deals with the highest profit margin while considering long-term benefits of maintaining Jill as a customer. In this way, deals may be specialized, may account for long-term customer relationships, and may be mutually beneficial. The AI chatbot may display a variety of information as part of message 1813 including bottom line, customer value score, etc. Mario may opt in or opt out of receiving specific information about the offered deals in message 1813.

Based on the profits of various potential transactions and other factors, the AI chatbot may output message 1813 to Mario on device 1851, suggesting some promotions. Message 1813 is output to device 1851 but not to device 1801. That is, the customer may not be able to see the deals the AI chatbot suggests to the business. In the example of FIG. 18, the AI chatbot suggests Option 1 of “Free breadsticks with purchase of two medium pizzas” and indicates this option has a profit margin of $6. The AI chatbot offers Option 2 of “Two-for-one small pizzas” and indicates that this option has a profit margin of $5. The AI chatbot also offers Option 3 of a “Large pizza for the price of a medium” and indicates that this option has a profit margin of $3. The AI chatbot may analyze a variety of types of deals including upsell offers, cross-sell offers, bundle offers, add-on offers, product upgrades, volume discounts, trial offers, reactivation offers, referral offers, etc.

Message 1813 may be clearly marked as an AI chatbot message opposed to a message from device 1801. For example, message 1813 may appear clearly marked within the chat or may appear as a banner above the chat. Message 1813 may include selectable text. That is, Mario may select Option 2 of message 1813 by clicking, tapping, or otherwise selecting the Option 2 text of message 1813.

The selection of Option 2 may send message 1804 from device 1851 to device 1801. In specific embodiments, message 1804 may be customizable. For example, although message 1804 reads “We can offer a two-for-one on small pizzas” in the example of FIG. 18, message 1804 may be edited by Mario to read variations of the selected deal from message 1813. For example, “How about two small pizzas for the price of one?” or “Hello Jill, we would like to offer you a two-for-one deal on small pizzas.” In specific embodiments, Mario may edit messages similar to message 1804 on an individual bases or by changing a default setting. In specific embodiments, message 1804 is written by the AI chatbot and is not editable.

In response to device 1851 sending message 1804, in response to device 1801 receiving message 1804, or as part of determining promotions for message 1813, the AI chatbot may calculate a quantity of platform currency Jill would earn if she completed the offered transaction described in message 1804. The AI chatbot may also determine (e.g. calculate, read) how much money Jill saves with this deal and the total cost of the deal. The AI chatbot may output the customer cost savings and the customer platform currency earnings on device 1801 via message 1815. In specific embodiments, the information provided in message 1815 may be adjusted in settings. For example, the AI chatbot may determine and output additional information in message 1815 such as calories associated with the order, a quantity people the order is expected to feed, etc. Jill may opt in or opt out of receiving specific information about offered deals.

The AI chatbot may suggest pricing for items (e.g., in addition to suggesting deals). For example, a business may be associated with (e.g., sell, offer) a set of products (where products may include services). In specific embodiments, the AI chatbot may recommend pricing for products in the set of products. To make the recommendations, the AI chatbot may access external databases as well as internal information. The AI chatbot may access information such as ingredient costs, employee wages, cost of living, competitor pricing, etc. The platform may identify the business using an identifier such as a receiver identifier.

In specific embodiments, the AI chatbot may compile or determine business reports (e.g., income projections, income targets, profit scenarios, cost benefit relationships, and performance metrics) associated with the business. For example, the AI chatbot may determine reports associated with the identifier (e.g., receiver identifier) of device 1851 (e.g., receiver device) and may output these reports on the business's (e.g., receiver) device 1851.

In specific embodiments, the AI chatbot may determine a radicalizing pattern within interaction data and external data. In specific embodiments, the AI chatbot may determine whether data that a user (e.g., Jill) interacts with is radicalizing. For example, the AI chatbot may analyze interaction data and external data and identify a pattern using the data. The AI chatbot may perform a sentiment analysis to determine whether the pattern may have a radicalizing effect on a user. The AI chatbot may then output a message (e.g., on device 1801) based on the determination. In specific embodiments, the AI chatbot may perform the sentiment analysis automatically (e.g., periodically, based on a user pattern, a change in pattern, etc.) and may output an alert if the AI chatbot determines that the pattern is radicalizing. In specific embodiments, the AI chatbot may perform the sentiment analysis manually (e.g., based on a user input, etc.) such that the AI chatbot may output a message indicating that the pattern is radicalizing or that the pattern is not radicalizing. In specific embodiments, there may be a range of radical sentiment such that the AI chatbot may assign a radicalizing score to the pattern rather than a simple Yes/No.

In specific embodiments, the AI chatbot may determine an interest pattern within interaction data and external data. In specific embodiments, the AI chatbot may determine whether data that a user (e.g., Jill) interacts with similar to data a second user (e.g., a friend named Melody) interacts with. For example, the AI chatbot may analyze interaction data (e.g., prior voice data, internal platform data) and external data and may identify a pattern using the data. The AI chatbot may perform a sentiment analysis to determine whether the pattern is similar to the data pattern of the second user (Melody). The second user may be a contact of the user. The AI chatbot may output a message on device 1801, that Jill's data pattern is similar to that of her friend. For example, the message may indicate that Jill and Melody both interact frequently with a certain business or system (e.g., they both frequent Matty's Embroidery Shoppe) and may suggest that Jill reach out to (e.g., reconnects with) Melody.

FIG. 18 is exemplary only, and the AI chatbot described may perform a variety of functions. For example, device 1801 may send messages containing a wide range of inquiries, such as “Are you open tomorrow at 7 pm?” “How much would it cost to buy pizza for fifteen people?” “How soon could two medium pizzas and a calzone be ready?” “What's the better deal, 10% off a large pizza or $5 off a medium pizza?” Subsequent messages may then be relevant to the inquiry and may be relevant to a specific business. In specific embodiments, the AI chatbot displaying messages on device 1801 and the AI chatbot displaying messages on device 1851 are different AI chatbots. In specific embodiments, they are facets of the same AI chatbot.

In specific embodiments, an AI chatbot may output a message to multiple users (e.g., on a receiver device and on a dialer device). In specific embodiments, an AI chatbot may output a message to only one user (e.g., on a receiver device or on a dialer device). The AI chatbot may help users (e.g., Jill, Mario) organize and use their data in ways that increase their individual sovereignty. For example, the AI chatbot may efficiently deal with large quantities of data (e.g., external data, internal data, etc.). The AI chatbot may use this data to provide users with a common language based interface to harvest, manipulate, and monetize their own data without costly resources.

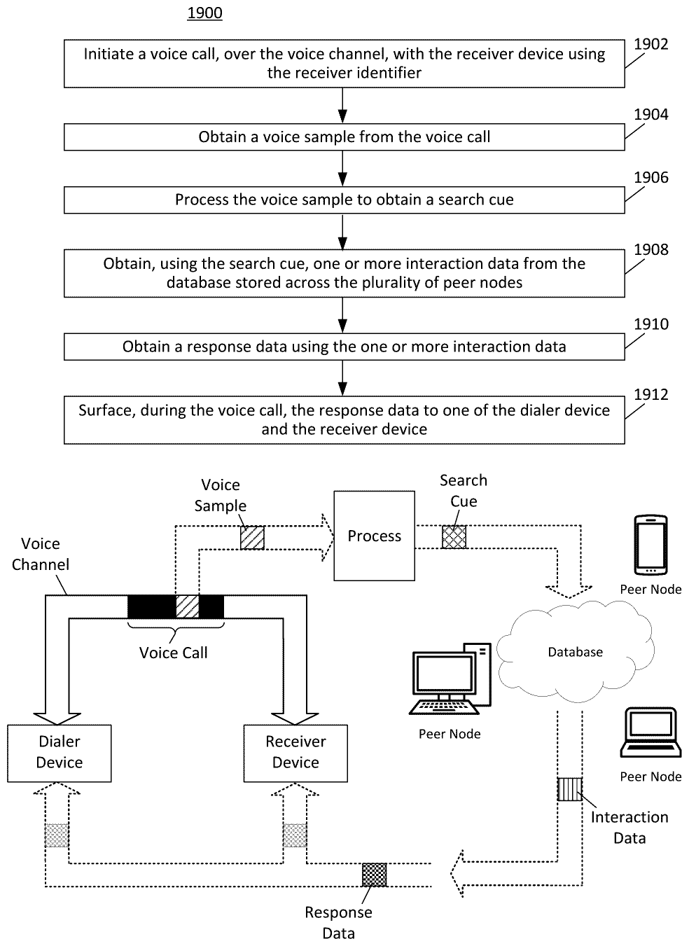

FIG. 19 illustrates an example of method 1900 related to a simultaneous voice and data content driven commercial data platform. Method 1900 may be performed by a system including a plurality of peer nodes, a dialer, and a database. The plurality of peer nodes may include a dialer node on a dialer device with a dialer identifier and a receiver node on a receiver device with a receiver identifier. The dialer may be programmed to initiate a voice call, over a voice channel, with the receiver device using the receiver identifier. The database may store interaction data in association with both the receiver identifier and the dialer identifier. The database may be stored across the plurality of peer nodes. Steps, or portions of steps, of method 1900 may be duplicated, omitted, rearranged, or otherwise deviate from the form shown. Some steps may be performed sequentially while others may be performed in parallel.

At step 1902, a voice call may be initiated over the voice channel. The voice call may be initiated with the receiver device and using the receiver identifier. The voice mall may be initiated by the dialer device.

At step 1904, a voice sample may be obtained from the voice call. The voice sample may be divided into packets. Multiple voice samples may be obtained from a single voice call.

At step 1906, the voice sample be processed to obtain a search cue. The voice sample may be processed using a machine learning model.

At step 1908, one or more interaction data may be obtained from the database stored across the plurality of peer nodes. The one or more instruction data may be obtained using the search cue (e.g., obtained at step 1906).

At step 1910, a response data may be obtained using the one or more interaction data (e.g., obtained at step 1908). In specific embodiments, the response data may be related to external data or other data using the machine learning model and based on interpreting the response data using the machine learning model.

At step 1912, the response data may be surfaced to one of the dialer device and the receiver device. The response data may be surfaced during the voice call. In specific embodiments, the response data may be surfaced to either the dialer device or the receiver device. In specific embodiments, the data may be surface to both the dialer device and the receiver device.

In specific embodiments, a user may disable their account and the corresponding peer node may be removed from the peer-to-peer system. The system of remaining peer nodes may rewrite one or more (e.g., all) of the blocks in a blockchain so that the blocks are still valid (e.g., able to function) without the data from the removed peer node being present anymore (e.g., being erased, deleted). By being able to erase their data off the platform, users are able to exercise individual sovereignty over their data.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be a memory within a personal user device or a network accessible memory. These and other modifications and variations to the present invention may be practiced by those skilled in the art, without departing from the scope of the present invention, which is more particularly set forth in the appended claims.

What is claimed is:

1. A system comprising:
a plurality of peer nodes including a receiver node on a receiver device with a receiver identifier and a dialer node on a dialer device with a dialer identifier, wherein each peer node of the plurality of peer nodes may operate as both a client and a server for other peer nodes of the plurality of peer nodes;
a dialer that is programmed to initiate a call on a voice channel between the dialer device and the receiver device using the receiver identifier;
a database stored across the plurality of peer nodes;
a first interaction manager: (i) stored on the dialer device; and (ii) programmed to transmit, without using the voice channel, a first set of interaction data to the database during the call; and
a second interaction manager: (i) stored on the receiver device; and (ii) programmed to distribute, without using the voice channel, a second set of interaction data to the database during the call;
wherein the plurality of peer nodes is programmed to:
obtain receiver content data from the database using the receiver identifier;
distribute the receiver content data to the dialer device;
obtain dialer content data from the database;
distribute the dialer content data to the receiver device; and
store data from both the first set of interaction data and the second set of interaction data in the database in association with both the receiver identifier and the dialer identifier.

2. The system of claim 1, wherein the plurality of peer nodes is further programmed to:
perform a sentiment analysis on a peer node in the plurality of peer nodes to determine a value score of the peer node.

3. The system of claim 2, wherein:
the sentiment analysis is based at least in part on a quantity of transactions made by the peer node, types of transactions made by the peer node, and a timeliness of payments made by the peer node.

4. The system of claim 2, wherein:
the peer node in the plurality of peer nodes receives a platform currency based at least in part on the value score.

5. The system of claim 2, wherein:
the value score is used to bias transactions for the system.

6. The system of claim 2, wherein:
the value score is less than a maximum value score.

7. The system of claim 1, wherein:
a platform currency is distributed among the plurality of peer nodes; and
the platform currency is a cryptocurrency.

8. The system of claim 1, wherein:
a peer node is removed from the plurality of peer nodes; and
the plurality of peer nodes without the peer node is programmed to rewrite blocks in a blockchain such that the blockchain is able to function without user data associated with the peer node.

9. A system comprising:
a server;
a receiver device with a receiver identifier;
a dialer device with a dialer identifier;
a dialer programmed to initiate a voice call, over a voice channel, with the receiver device using the receiver identifier;
a database; and
a data channel connecting the dialer device and the server;
wherein the server is programmed to store, in the database, interaction data in association with one of the receiver identifier and the dialer identifier;
wherein the receiver device is programmed to access external data from an external platform; and
wherein the system is programmed to:
obtain a voice sample from the voice call;
process the voice sample to obtain a response data from the voice sample;
store, in the database, the response data in association with one of the receiver identifier and the dialer identifier; and
output, by a chatbot and on the receiver device, a message based on the response data and the external data from the external platform.

10. The system of claim 9, further comprising:
an artificial intelligence system programmed to:
determine a profit margin regarding a potential transaction; and
output, by the chatbot and on the receiver device, the profit margin.

11. The system of claim 10, wherein:
the artificial intelligence system is further configured to determine the potential transaction based at least in part on a value score associated with the dialer identifier; and
the chatbot outputs, on the receiver device, a second message including the potential transaction.

12. The system of claim 11, wherein:
the second message includes a customer cost savings associated with the potential transaction and a customer platform currency earnings associated with the potential transaction.

13. The system of claim 9, wherein:
the chatbot includes an avatar specific to the receiver identifier; and
the avatar is output on the dialer device.

14. The system of claim 9, wherein the system is further configured to:
determine one or more scores related to a local economy, the one or more scores being based at least in part on the external data and on transactions associated with the dialer identifier; and
distribute a platform currency to an account associated with the dialer identifier based at least in part on the one or more scores related to the local economy.

15. The system of claim 9, further comprising:
an artificial intelligence system configured to:
determine income projections, income targets, and performance metrics associated with the receiver identifier; and
output the income projections, the income targets, and the performance metrics on the receiver device.

16. The system of claim 9, further comprising:
an artificial intelligence system;
wherein the receiver identifier is associated with a set of products; and
wherein the artificial intelligence system is configured to recommend pricing for the set of products.

17. The system of claim 9, wherein the system is further configured to:
identify a pattern using the external data and the interaction data;
perform a sentiment analysis to determine whether the pattern is radicalizing; and
output a second message on the receiver device based on the determination.

18. The system of claim 9, wherein the system is further configured to:
identify a pattern using the external data from the external platform and the interaction data;
determine that the pattern is similar to a second pattern associated with a third identifier; and
output, on the dialer device, a second message indicating that the pattern is similar to the second pattern.

19. The system of claim 9, wherein the system is further programmed to:
process the external data from the external platform into a structured format;
retrieve relevant external data from the external platform;
interpret the response data using a machine learning model;
relate the response data to the external data using the machine learning model and based at least in part on interpreting the response data; and
predict a sequence of words likely to follow the response data;
wherein the message is based on the prediction.

20. A method, in which each step is conducted by a system comprising a plurality of peer nodes including a dialer node on a dialer device with a dialer identifier and a receiver node on a receiver device with a receiver identifier, a dialer programmed to initiate a voice call, over a voice channel, with the receiver device using the receiver identifier, and a database for storing interaction data in association with both the receiver identifier and the dialer identifier, wherein the database is stored across the plurality of peer nodes, the method comprising:
initiating a voice call, over the voice channel, with the receiver device using the receiver identifier;
obtaining a voice sample from the voice call;
processing the voice sample to obtain a search cue;
obtaining, using the search cue, one or more interaction data from the database stored across the plurality of peer nodes;
obtaining a response data using the one or more interaction data; and
surfacing, during the voice call, the response data to one of the dialer device and the receiver device.
